(19) United States
(12) Patent Application Publication
(10) Pub. No.: US 2025/0110151 A1
(43) Pub. Date: Apr. 3, 2025

(54) CONTROL SYSTEM AND INERTIAL SENSOR

(71) Applicant: Panasonic Intellectual Property Management Co., Ltd., Osaka (JP)

(72) Inventors: Kazufumi NISHIKAWA, Osaka (JP); Yuki MAEGAWA, Fukui (JP)

(73) Assignee: Panasonic Intellectual Property Management Co., Ltd., Osaka (JP)

(21) Appl. No.: 18/832,169

(22) PCT Filed: Jan. 13, 2023
(86) PCT No.: PCT/JP2023/000754

§ 371 Date: Jul. 23, 2024

(30) Foreign Application Priority Data
Jan. 28, 2022 (JP) 2022-012417

(51) Int. Cl. G01P 21/00; G01P 1/00; G01P 3/44

(52) U.S. Cl. CPC G01P 21/00; G01P 1/00; G01P 3/44

(57) ABSTRACT

A control system includes a first inertial sensor and a second inertial sensor. The first inertial sensor includes first to third angular velocity detection elements, first to third acceleration detection elements, and a first control unit. The first control unit calculates a first orientation signal. The second inertial sensor includes fourth to sixth angular velocity detection elements, fourth to sixth acceleration detection elements, and a second control unit. The second control unit calculates a second orientation signal. The first control unit calculates first detection axis information and generates a first reference signal based on at least one signal selected from fourth to sixth angular velocity signals and fourth to sixth acceleration signals. The first control unit generates a first corrected signal by correcting, using the first reference signal, at least one signal selected from first to third angular velocity signals and first to third acceleration signals.

### TECHNICAL FIELD

The present disclosure generally relates to a control system and an inertial sensor and more particularly relates to a control system including a plurality of inertial sensors and an inertial sensor mounted on a moving part.

### BACKGROUND ART

An inertial sensor has been used in the art to control either a construction machine or a work robot. For example, Patent Literature 1 discloses a hydraulic excavator in which the inertial sensor is mounted on each of a boom, an arm, and a bucket each serving as a moving part.

Nevertheless, the orientation detection accuracy of each of those moving parts depends on the detection accuracy of the inertial sensor mounted on that moving part.

### CITATION LIST

### Patent Literature

Patent Literature 1: JP 2020-33747 A

### SUMMARY OF INVENTION

An object of the present disclosure is to improve the orientation detection accuracy of a moving part in a control system which uses a plurality of inertial sensors and in each of the inertial sensors.

A control system according to an aspect of the present disclosure includes a first inertial sensor, a second inertial sensor, a first signal path, and a second signal path. The first inertial sensor is disposed in a first moving part. The second inertial sensor is disposed in a second moving part which is arranged to be ready to be actuated with respect to the first moving part. The first signal path connects the first inertial sensor to an external system. The second signal path connects the second inertial sensor to the first inertial sensor. The first inertial sensor includes a first angular velocity detection element, a second angular velocity detection element, a third angular velocity detection element, a first acceleration detection element, a second acceleration detection element, a third acceleration detection element, and a first control unit. The first angular velocity detection element detects angular velocity around a first detection axis to output a first angular velocity signal. The second angular velocity detection element detects angular velocity around a second detection axis to output a second angular velocity signal. The third angular velocity detection element detects angular velocity around a third detection axis to output a third angular velocity signal. The first acceleration detection element detects acceleration in a direction along the first detection axis to output a first acceleration signal. The second acceleration detection element detects acceleration in a direction along the second detection axis to output a second acceleration signal. The third acceleration detection element detects acceleration in a direction along the third detection axis to output a third acceleration signal. The first control unit calculates a first orientation signal based on the first angular velocity signal, the second angular velocity signal, the third angular velocity signal, the first acceleration signal, the second acceleration signal, and the third acceleration signal. The first detection axis, the second detection axis, and the third detection axis are perpendicular to each other. The second inertial sensor includes a fourth angular velocity detection element, a fifth angular velocity detection element, a sixth angular velocity detection element, a fourth acceleration detection element, a fifth acceleration detection element, a sixth acceleration detection element, and a second control unit. The fourth angular velocity detection element detects angular velocity around a fourth detection axis to output a fourth angular velocity signal. The fifth angular velocity detection element detects angular velocity around a fifth detection axis to output a fifth angular velocity signal. The sixth angular velocity detection element detects angular velocity around a sixth detection axis to output a sixth angular velocity signal. The fourth acceleration detection element detects acceleration in a direction along the fourth detection axis to output a fourth acceleration signal. The fifth acceleration detection element detects acceleration in a direction along the fifth detection axis to output a fifth acceleration signal. The sixth acceleration detection element detects acceleration in a direction along the sixth detection axis to output a sixth acceleration signal. The second control unit calculates a second orientation signal based on the fourth angular velocity signal, the fifth angular velocity signal, the sixth angular velocity signal, the fourth acceleration signal, the fifth acceleration signal, and the sixth acceleration signal. The fourth detection axis, the fifth detection axis, and the sixth detection axis are perpendicular to each other. The first control unit calculates first detection axis information based on the first orientation signal and the second orientation signal. The first detection axis information indicates a relationship between the first detection axis, the second detection axis, and the third detection axis and the fourth detection axis, the fifth detection axis, and the sixth detection axis. The first control unit further generates a first reference signal in accordance with the first detection axis information and based on at least one signal selected from the group consisting of the fourth angular velocity signal, the fifth angular velocity signal, the sixth angular velocity signal, the fourth acceleration signal, the fifth acceleration signal, and the sixth acceleration signal. The first control unit further generates a first corrected signal by correcting, using the first reference signal, at least one signal selected from the group consisting of the first angular velocity signal, the second angular velocity signal, the third angular velocity signal, the first acceleration signal, the second acceleration signal, and the third acceleration signal. The first control unit further outputs the first corrected signal to the external system.

An inertial sensor according to another aspect of the present disclosure is disposed in a moving part. The inertial sensor includes a first angular velocity detection element, a second angular velocity detection element, a third angular velocity detection element, a first acceleration detection element, a second acceleration detection element, a third acceleration detection element, and a control unit. The first angular velocity detection element detects angular velocity around a first detection axis to output a first angular velocity signal. The second angular velocity detection element detects angular velocity around a second detection axis to output a second angular velocity signal. The third angular velocity detection element detects angular velocity around a third detection axis to output a third angular velocity signal. The first acceleration detection element detects acceleration in a direction along the first detection axis to output a first acceleration signal. The second acceleration detection element detects acceleration in a direction along the second detection axis to output a second acceleration signal. The third acceleration detection element detects acceleration in a direction along the third detection axis to output a third acceleration signal. The control unit calculates a first orientation signal based on the first angular velocity signal, the second angular velocity signal, the third angular velocity signal, the first acceleration signal, the second acceleration signal, and the third acceleration signal. The first detection axis, the second detection axis, and the third detection axis are perpendicular to each other. The control unit acquires, from a second inertial sensor, a fourth angular velocity signal, a fifth angular velocity signal, a sixth angular velocity signal, a fourth acceleration signal, a fifth acceleration signal, a sixth acceleration signal, and a second orientation signal. The second inertial sensor is different from a first inertial sensor serving as the inertial sensor. The second inertial sensor is disposed in a second moving part which is arranged to be ready to be actuated with respect to a first moving part serving as the moving part. The fourth angular velocity signal represents angular velocity around a fourth detection axis. The fifth angular velocity signal represents angular velocity around a fifth detection axis perpendicular to the fourth detection axis. The sixth angular velocity signal represents angular velocity around a sixth detection axis perpendicular to the fourth detection axis and the fifth detection axis. The fourth acceleration signal represents acceleration in a direction along the fourth detection axis. The fifth acceleration signal represents acceleration in a direction along the fifth detection axis. The sixth acceleration signal represents acceleration in a direction along the sixth detection axis. The second orientation signal represents an orientation of the second inertial sensor. The control unit further calculates, based on the first orientation signal and the second orientation signal, detection axis information. The detection axis information indicates a relationship between the first detection axis, the second detection axis, and the third detection axis and the fourth detection axis, the fifth detection axis, and the sixth detection axis. The control unit further generates a reference signal in accordance with the detection axis information and based on at least one signal selected from the group consisting of the fourth angular velocity signal, the fifth angular velocity signal, the sixth angular velocity signal, the fourth acceleration signal, the fifth acceleration signal, and the sixth acceleration signal. The control unit further generates a corrected signal by correcting, using the reference signal, at least one signal selected from the group consisting of the first angular velocity signal, the second angular velocity signal, the third angular velocity signal, the first acceleration signal, the second acceleration signal, and the third acceleration signal. The control unit outputs the corrected signal.

### BRIEF DESCRIPTION OF DRAWINGS

FIG. 1 is a block diagram illustrating a logical configuration for a control system according to a first embodiment;

FIG. 2 is a schematic representation generally illustrating a control target to which the control system according to the first embodiment is mounted:

FIG. 3 is a block diagram illustrating a logical configuration for a first sensor included in the control system according to the first embodiment:

FIG. 4 is a block diagram illustrating a logical configuration for a second sensor included in the control system according to the first embodiment:

FIG. 5 is a flowchart showing the procedure of operation of a control unit for the first sensor included in the control system according to the first embodiment:

FIG. 6 is a flowchart showing the procedure of operation of a control unit for the second sensor included in the control system according to the first embodiment:

FIG. 7 is a block diagram illustrating a logical configuration for a control system according to a second embodiment:

FIG. 8 is a block diagram illustrating a logical configuration for a first sensor included in the control system according to the second embodiment:

FIG. 9 is a block diagram illustrating a logical configuration for a second sensor included in the control system according to the second embodiment:

FIG. 10 is a flowchart showing the procedure of operation of a control unit for the first sensor included in the control system according to the second embodiment:

FIG. 11 is a flowchart showing the procedure of operation of a control unit for the second sensor included in the control system according to the second embodiment:

FIG. 12 is a block diagram illustrating a logical configuration for a control system according to a third embodiment; and

FIG. 13 is a table showing exemplary weighing coefficients for use in respective sensors of the control system at the time of correction.

### DESCRIPTION OF EMBODIMENTS

### First Embodiment

A control system 1 according to the present disclosure will now be described with reference to the accompanying drawings.

### (1) Control System

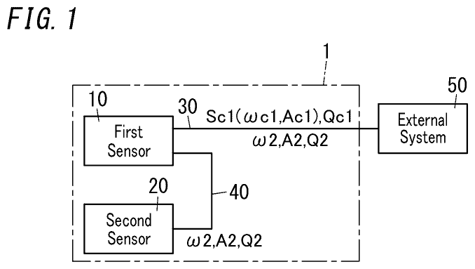

FIG. 1 is a block diagram illustrating a logical configuration for a control system 1 according to a first embodiment. The control system 1 according to the first embodiment includes a first sensor 10, a second sensor 20, a first signal path 30, and a second signal path 40. In this control system 1, one terminal of the first signal path 30 is connected to an external system 50.

Each of the first sensor 10 and the second sensor 20 is a hexaxial inertial sensor for measuring angular velocity around each of three detection axes which are perpendicular to each other and acceleration along each of the three detection axes. The first sensor 10 also has the function of correcting, based on the angular velocity and acceleration provided by the second sensor 20, the angular velocity and acceleration provided by the first sensor 10 itself as will be described in detail later.

The first signal path 30 is a communication route between the first sensor 10 and the external system 50. The first signal path 30 may be, for example, a linear bus compliant with the Controller Area Network (CAN) standard. The first sensor 10 outputs, through the first signal path 30, the corrected angular velocity and acceleration to the external system 50. In addition, the first sensor 10 also outputs, through the first signal path 30, the angular velocity and acceleration provided by the second sensor 20.

The second signal path 40 is a communication route between the first sensor 10 and the second sensor 20. The second signal path 40 may be, for example, a linear bus compliant with the CAN standard. The second sensor 20 outputs the angular velocity and acceleration to the first sensor 10 through the second signal path 40.

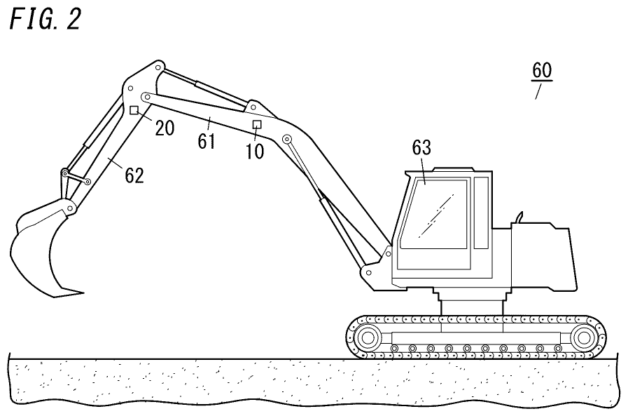

The external system 50 receives, from the control system 1, a signal representing the angular velocity and acceleration output by the first sensor 10 and a signal representing the angular velocity and acceleration output by the second sensor 20. The external system 50 is an operation control system for controlling the operation of a control target 60 (refer to FIG. 2) on which the control system 1 is mounted. The external system 50 may be, for example, an electronic control unit (ECU). The external system 50 receives, through the first signal path 30, the signal representing the angular velocity and acceleration from each of the first sensor 10 and the second sensor 20 as described above.

The control system 1 is mounted on the control target 60 with moving parts as shown in FIG. 2. The control target 60 includes a first moving part 61, a second moving part 62, and a body 63. The first moving part 61 is connected to the body 63 to be ready to be actuated with respect to the body 63. The second moving part 62 is connected to the first moving part 61 to be ready to be actuated with respect to the first moving part 61. The first sensor 10 is mounted on the first moving part 61. The second sensor 20 is mounted on the second moving part 62. The body 63 includes the external system 50. In the example illustrated in FIG. 2, the control target 60 is a hydraulic excavator. The body 63 is its vehicle body. The first moving part 61 is its boom. The second moving part 62 is its arm.

### (2) Angular Velocity Detection Elements and Acceleration Detection Elements of Inertial Sensor

### (2.1) First Sensor

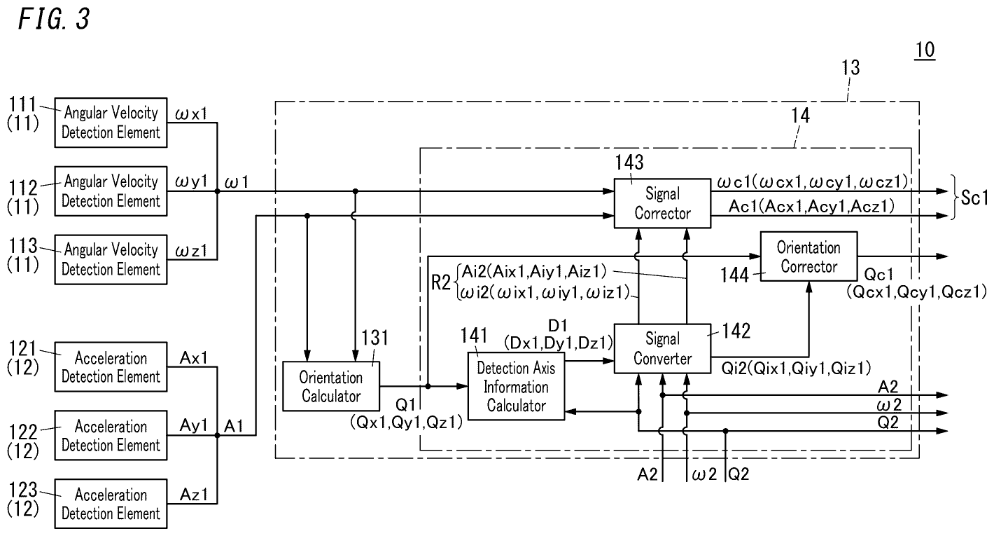

FIG. 3 is a block diagram illustrating a logical configuration for the first sensor 10 according to the first embodiment. The first sensor 10 includes three angular velocity detection elements 11 (111-113), three acceleration detection elements 12 (121-123), and a control unit 13.

### (2.1.1) Angular Velocity Detection Elements

The angular velocity detection elements 11 are uniaxial gyrosensors. Each of the angular velocity detection elements 11 detects angular velocity around a detection axis. Each of the angular velocity detection elements 11 may be, for example, a so-called “microelectromechanical systems (MEMS) gyrosensor.” Each of the angular velocity detection elements 11 may include, for example, a vibrating electrode and a detecting electrode. The vibrating electrode vibrates in a first direction perpendicular to the detection axis. The detecting electrode detects, using capacitance, the movement of the vibrating electrode in a second direction which is perpendicular to both the detection axis and the first direction. Note that each of the angular velocity detection elements 11 does not have to have such a structure but may also have any arbitrary structure as long as the angular velocity detection element 11 may detect angular velocity around the detection axis.

Each of the angular velocity detection elements 11 outputs an angular velocity signal representing angular velocity around the detection axis to the control unit 13. The angular velocity signal may be output as, for example, a voltage value. The absolute value of the angular velocity signal is the absolute value of the amplitude of the angular velocity signal and indicates the magnitude of the angular velocity. Also, the sign of the angular velocity signal indicates the polarity of the angular velocity signal and indicates the direction of rotation.

The first sensor 10 includes, as the three angular velocity detection elements 11, an angular velocity detection element 111, an angular velocity detection element 112, and an angular velocity detection element 113. These angular velocity detection elements 111-113 have respective detection axes extending in three different directions that are perpendicular to each other. In the following description, the detection axes of the angular velocity detection elements 111, 112, 113 will be hereinafter referred to as an “x1 axis,” a “y1 axis,” and a “z1 axis,” respectively. The y1 axis is perpendicular to the x1 axis. The z1 axis is perpendicular to not only the x1 axis but also the y1 axis as well.

In the following description, the angular velocity signals output by the angular velocity detection elements 111-113 will be hereinafter referred to as an “x1-axis angular velocity signal ωx1”, a “y1-axis angular velocity signal ωy1,” and a “z1-axis angular velocity signal ωz1,” respectively. Also, an angular velocity signal as a three-dimensional vector including, as respective components thereof, the x1-axis angular velocity signal ωx1, the y1-axis angular velocity signal ωy1, and the z1-axis angular velocity signal ωz1 will be hereinafter referred to as a “first angular velocity signal ω1.”

### (2.1.2) Acceleration Detection Elements

The acceleration detection elements 12 are uniaxial acceleration sensors. Each of these acceleration detection elements 12 detects acceleration along its corresponding detection axis. Each acceleration detection element 12 may be, for example, a capacitive MEMS sensor. The acceleration detection element 12 may include, for example, a pair of fixed electrodes, a moving electrode, a spindle, and an elastic member. The pair of fixed electrodes face each other in the direction in which the detection axis extends. The moving electrode is located between the fixed electrodes. The spindle is connected to the moving electrode. The elastic member supports the moving electrode in the direction in which the detection axis extends. Note that the acceleration detection elements 12 do not have to have such a structure but may also have any arbitrary structure as long as the acceleration detection elements 12 may detect acceleration along their detection axis.

Each of the acceleration detection elements 12 outputs an acceleration signal representing acceleration along its corresponding detection axis to the control unit 13. The acceleration signal may be output as, for example, a voltage value. The absolute value of the acceleration signal is the absolute value of the amplitude of the acceleration signal and indicates the magnitude of the acceleration. Also, the sign of the acceleration signal indicates the polarity of the acceleration signal and the direction in which the acceleration is applied.

The first sensor 10 includes, as the three acceleration detection elements 12, an acceleration detection element 121, an acceleration detection element 122, and an acceleration detection element 123. The detection axis of the acceleration detection element 121 is parallel to the x1 axis. The detection axis of the acceleration detection element 122 is parallel to the y1 axis. The detection axis of the acceleration detection element 123 is parallel to the z1 axis. That is to say, these acceleration detection elements 121-123 have respective detection axes extending in three different directions that are perpendicular to each other.

In the following description, the acceleration signals output by the acceleration detection elements 121-123 will be hereinafter referred to as an “x1-axis acceleration signal Ax1,” a “y1-axis acceleration signal Ay1,” and a “z1-axis acceleration signal Az1,” respectively. Also, an acceleration signal as a three-dimensional vector including, as respective components thereof, the x1-axis acceleration signal Ax1, the y1-axis acceleration signal Ay1, and the z1-axis acceleration signal Az1 will be hereinafter referred to as a “first acceleration signal A1.”

### (2.2) Second Sensor

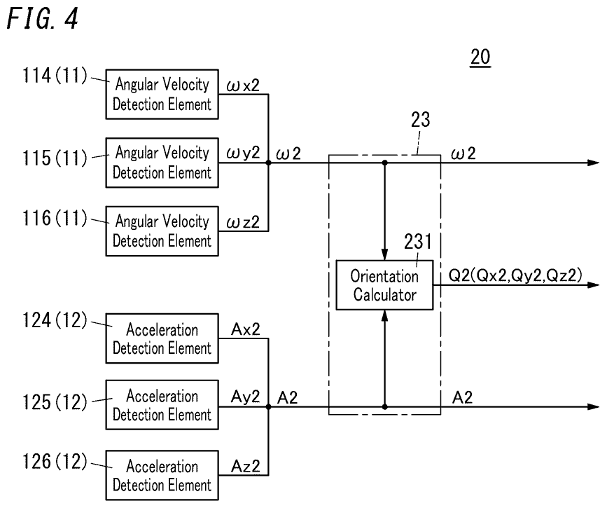

FIG. 4 is a block diagram illustrating a logical configuration for the second sensor 20 according to the first embodiment. The second sensor 20 includes three angular velocity detection elements 11 (114-116), three acceleration detection elements 12 (124-126), and a control unit 23.

### (2.2.1) Angular Velocity Detection Elements

Each of the angular velocity detection elements 11 detects angular velocity around a detection axis as described above. Each of the angular velocity detection elements 11 outputs an angular velocity signal representing angular velocity around the detection axis to the control unit 23. The angular velocity signal may be output as, for example, a voltage value. The absolute value of the angular velocity signal is the absolute value of the amplitude of the angular velocity signal and indicates the magnitude of the angular velocity. Also, the sign of the angular velocity signal indicates the polarity of the angular velocity signal and indicates the direction of rotation.

The second sensor 20 includes, as the three angular velocity detection elements 11, an angular velocity detection element 114, an angular velocity detection element 115, and an angular velocity detection element 116. These angular velocity detection elements 114-116 have respective detection axes extending in three different directions that are perpendicular to each other. In the following description, the detection axes of the angular velocity detection elements 114, 115, 116 will be hereinafter referred to as an “x2 axis,” a “y2 axis,” and a “z2 axis,” respectively. The y2 axis is perpendicular to the x2 axis. The z2 axis is perpendicular to not only the x2 axis but also the y2 axis as well.

In the following description, the angular velocity signals output by the angular velocity detection elements 114-116 will be hereinafter referred to as an “x2-axis angular velocity signal ωx2,” a “y2-axis angular velocity signal ωy2,” and a “z2-axis angular velocity signal ωz2,” respectively. Also, an angular velocity signal as a three-dimensional vector including, as respective components thereof, the x2-axis angular velocity signal ωx2, the y2-axis angular velocity signal ωy2, and the z2-axis angular velocity signal ωz2 will be hereinafter referred to as a “second angular velocity signal ω2.”

### (2.2.2) Acceleration Detection Elements

Each of the acceleration detection elements 12 detects acceleration along its corresponding detection axis as described above. Each of the acceleration detection elements 12 outputs an acceleration signal representing acceleration along its detection axis to the control unit 23. The acceleration signal may be output as, for example, a voltage value. The absolute value of the acceleration signal is the absolute value of the amplitude of the acceleration signal and indicates the magnitude of the acceleration. Also, the sign of the acceleration signal indicates the polarity of the acceleration signal and indicates the direction in which the acceleration is applied.

The second sensor 20 includes, as the three acceleration detection elements 12, an acceleration detection element 124, an acceleration detection element 125, and an acceleration detection element 126. The detection axis of the acceleration detection element 124 is parallel to the x2 axis. The detection axis of the acceleration detection element 125 is parallel to the y2 axis. The detection axis of the acceleration detection element 126 is parallel to the z2 axis. That is to say, these acceleration detection elements 124-126 have respective detection axes extending in three different directions that are perpendicular to each other.

In the following description, the acceleration signals output by the acceleration detection elements 124-126 will be hereinafter referred to as an “x2-axis acceleration signal Ax2,” a “y2-axis acceleration signal Ay2,” and a “z2-axis acceleration signal Az2,” respectively. Also, an acceleration signal as a three-dimensional vector including, as respective components thereof, the x2-axis acceleration signal Ax2, the y2-axis acceleration signal Ay2, and the z2-axis acceleration signal Az2 will be hereinafter referred to as a “second acceleration signal A2.”

### (3) Control Unit

### (3.1) Overview of Control Unit

As shown in FIG. 3, the control unit 13 of the first sensor 10 acquires the x1-axis angular velocity signal ωx1, the y1-axis angular velocity signal ωy1, and the z1-axis angular velocity signal ωz1 from the angular velocity detection elements 111-113, respectively. In addition, the control unit 13 also acquires the x1-axis acceleration signal Ax1, the y1-axis acceleration signal Ay1, and the z1-axis acceleration signal Az1 from the acceleration detection elements 121-123, respectively. Then, the control unit 13 calculates, based on the x1-axis angular velocity signal ωx1, the y1-axis angular velocity signal ωy1, the z1-axis angular velocity signal ωz1, the x1-axis acceleration signal Ax1, the y1-axis acceleration signal Ay1, and the z1-axis acceleration signal Az1, an orientation signal Q1 representing the orientation of the first sensor 10.

On the other hand, as shown in FIG. 4, the control unit 23 of the second sensor 20 acquires the x2-axis angular velocity signal ωx2, the y2-axis angular velocity signal ωy2, and the z2-axis angular velocity signal ωz2 from the angular velocity detection elements 114-116, respectively. In addition, the control unit 23 also acquires the x2-axis acceleration signal Ax2, the y2-axis acceleration signal Ay2, and the z2-axis acceleration signal Az2 from the acceleration detection elements 124-126, respectively. Then, the control unit 23 calculates, based on the x2-axis angular velocity signal ωx2, the y2-axis angular velocity signal ωy2, the z2-axis angular velocity signal ωz2, the x2-axis acceleration signal Ax2, the y2-axis acceleration signal Ay2, and the z2-axis acceleration signal Az2, an orientation signal Q2 representing the orientation of the second sensor 20.

As shown in FIGS. 1 and 3, the control unit 13 further acquires the second angular velocity signal ω2, the second acceleration signal A2, and the orientation signal Q2 from the control unit 23. Then, the control unit 13 calculates, based on the orientation signal Q1 and the orientation signal Q2, detection axis information D1 indicating a relationship between the combination of three axes, namely, the x2, y2, and z2 axes, and the combination of three axes, namely, the x1, y1, and z1 axes. The control unit 13 generates a reference signal R2 by performing, in accordance with the detection axis information D1, coordinate transformation to transform the second angular velocity signal ω2 and the second acceleration signal A2 into a coordinate system based on the x1, y1, and z1 axes. Then, the control unit 13 corrects, based on the reference signal R2, the x1-axis angular velocity signal ωx1, the y-axis angular velocity signal ωy1, the z1-axis angular velocity signal ωz1, the x1-axis acceleration signal Ax1, the y1-axis acceleration signal Ay1, and the z1-axis acceleration signal Az1, thereby generating a corrected signal Sc1. In addition, the control unit 13 generates a reference orientation signal Qi2 by performing, in accordance with the detection axis information D1, coordinate transformation to transform the orientation signal Q2 into a coordinate system based on the x1, y1, and z1 axes. The control unit 13 corrects the orientation signal Q1 based on the reference orientation signal Qi2 to generate a corrected orientation signal Qc1.

The control unit 13 outputs the corrected signal Sc1 thus generated to the external system 50 through the first signal path 30. The control unit 23 outputs the second angular velocity signal ω2, the second acceleration signal A2, and the orientation signal Q2 through the second signal path 40. The control unit 13 receives the second angular velocity signal ω2, the second acceleration signal A2, and the orientation signal Q2 through the second signal path 40 and outputs the second angular velocity signal ω2, the second acceleration signal A2, and the orientation signal Q2 to the external system 50 through the first signal path 30.

The control unit 13 includes an orientation calculator 131 as shown in FIG. 3. Likewise, the control unit 23 also includes an orientation calculator 231 as shown in FIG. 4. The control unit 13 further includes a signal corrector 14 as shown in FIG. 3. The signal corrector 14 includes a detection axis information calculator 141, a signal converter 142, a signal corrector 143, and an orientation corrector 144.

The control unit 13 may be, for example, a single application specific integrated circuit (ASIC). The control unit 23 may be, for example, a single ASIC. Note that the control unit 13, 23 does not have to be a single ASIC but may also be a circuit including one or more ICs or a microcomputer as well.

### (3.2) Orientation Calculator

The orientation calculator 131 of the first sensor 10 predicts the orientation of the first sensor 10 based on the first angular velocity signal ω1 and the first acceleration signal A1 as shown in FIG. 3. The orientation calculator 131 outputs the orientation signal Q1 representing the orientation of the first sensor 10.

The orientation calculator 131 may predict the orientation of the first sensor 10 using, for example, an extended Kalman filter. The orientation calculator 131 predicts the current state by applying the previously estimated state and the state equation to the state space model, for example. Then, the orientation calculator 131 estimates the current state of the first sensor 10 by performing update processing based on the difference between the predicted angular velocity and acceleration and the first angular velocity signal ω1 and the first acceleration signal A1. The current orientation of the first sensor 10 is represented by the orientation signal Q1. The orientation signal Q1 may be, for example, a quaternion.

Note that the orientation calculator 131 does not have to calculate the orientation of the first sensor 10 using the extended Kalman filter. Alternatively, the orientation calculator 131 may also calculate the orientation using an unscented Kalman filter (UKF), a complementary filter, or a Madgwick filter, for example.

The orientation calculator 231 of the second sensor 20 predicts the orientation of the second sensor 20 based on the second angular velocity signal ω2 and the second acceleration signal A2 as shown in FIG. 4. The orientation calculator 231 outputs the orientation signal Q2 representing the orientation of the second sensor 20. The orientation signal Q2 may be a quaternion, for example.

### (3.3) Signal Corrector

As shown in FIG. 3, the signal corrector 14 of the first sensor 10 acquires the second angular velocity signal ω2, the second acceleration signal A2, and the orientation signal Q2 from the second sensor 20 and corrects the first angular velocity signal ω1, the first acceleration signal A1, and the orientation signal Q1 based on the second angular velocity signal ω2, the second acceleration signal A2, and the orientation signal Q2.

As shown in FIG. 3, the signal corrector 14 includes a detection axis information calculator 141, a signal converter 142, a signal corrector 143, and an orientation corrector 144.

### (3.3.1) Detection Axis Information Calculator

The detection axis information calculator 141 calculates, based on the orientation signal Q1 and the orientation signal Q2, detection axis information indicating a relationship between the combinations of the three axes, namely, the x2, y2, and z2 axes, and the combination of the three axes, namely, the x1, y1, and z1 axes.

The detection axis information calculator 141 determines, based on the magnitude of the second angular velocity signal ω2, for example, whether the second sensor 20 is moving relative to the first sensor 10. Then, the detection axis information calculator 141 transforms the orientation signal Q1, for example, into a combination of a yaw Qz1 as a rotational angle around the z1 axis, a pitch Qy1 as a rotational angle around the y1 axis, and a roll Qx1 as a rotational angle around the x1 axis. In the same way, the detection axis information calculator 141 also transforms the orientation signal Q2, for example, into a combination of a yaw Qz2 as a rotational angle around the z2 axis, a pitch Qy2 as a rotational angle around the y2 axis, and a roll Qx2 as a rotational angle around the x2 axis. Unless the second sensor 20 is moving relative to the first sensor 10, the angular velocity and acceleration applied to the second sensor 20 have the same direction and magnitude as the angular velocity and acceleration applied to the first sensor 10. In that case, the detection axis information D1 is represented by the combination (Dx1, Dy1, Dz1) of a yaw Dz1 given by (Qz1-Qz2), a pitch Dy1 given by (Qy1-Qy2), and a roll Dx1 given by (Qx1-Qx2).

### (3.3.2) Signal Converter

The signal converter 142 converts, in accordance with the detection axis information D1, the second angular velocity signal ω2 and the second acceleration signal A2 into the reference signal R2 expressed by a coordinate system based on the x1, y1, and z1 axes, and outputs the reference signal R2. In addition, the signal converter 142 also converts, in accordance with the detection axis information D1, the orientation signal Q2 into the reference orientation signal Qi2 as an orientation signal expressed by a coordinate system based on the x1, y1, and z1 axes, and outputs the reference orientation signal Qi2.

The signal converter 142 generates, in accordance with the detection axis information D1, a rotation matrix Rx which uses the roll Dx1 as a rotational angle around the x1 axis, a rotation matrix Ry which uses the pitch Dy1 as a rotational angle around the y1 axis, and a rotation matrix Rz which uses the yaw Dz1 as a rotational angle around the z1 axis. An angular velocity component ωi2 which expresses the second angular velocity signal ω2 by the coordinate system based on the x1, y1, and z1 axes is calculated by the following equation:

$$ω i 2 = Rx \times Ry \times Rz \times ω2$$

$$( \begin{matrix}ω ix 1 \\ ω iy 1 \\ ω iz 1\end{matrix} ) = ( \begin{matrix}1 & 0 & 0 \\ 0 & cos Dx 1 & - sin Dx 1 \\ 0 & sin Dx 1 & cos Dx 1\end{matrix} ) ( \begin{matrix}cos Dy 1 & 0 & sin Dy 1 \\ 0 & 1 & 0 \\ - sin Dy 1 & 0 & cos Dy 1\end{matrix} ) ( \begin{matrix}cos Dz 1 & - sin Dz 1 & 0 \\ sin Dz 1 & cos Dz 1 & 0 \\ 0 & 0 & 1\end{matrix} ) ( \begin{matrix}ω x 2 \\ ω y 2 \\ ω z 2\end{matrix} )$$

In this equation, the vector on the left side is the angular velocity component ωi2. On the other hand, the three matrices on the right side are the rotation matrix Rx, the rotation matrix Ry, and the rotation matrix Rz, respectively, from left to right. The vector at the right end of the right side is the second angular velocity signal ω2.

The angular velocity component ωi2 is a three-dimensional vector including, as its respective components, an x1-axis angular velocity component ωix1 around the x1 axis, a y1-axis angular velocity component ωiy1 around the y1 axis, and a z1-axis angular velocity component ωiz1 around the z1 axis.

Meanwhile, an acceleration component Ai2 which expresses the second acceleration signal A2 by the coordinate system based on the x1, y1, and z1 axes is calculated by the following equation:

$$A i 2 = Rx \times Ry \times Rz \times A 2$$

$$( \begin{matrix}Aix 1 \\ Aiy 1 \\ Aiz 1\end{matrix} ) = ( \begin{matrix}1 & 0 & 0 \\ 0 & cos Dx 1 & - sin Dx 1 \\ 0 & sin Dx 1 & cos Dx 1\end{matrix} ) ( \begin{matrix}cos Dy 1 & 0 & sin Dy 1 \\ 0 & 1 & 0 \\ - sin Dy 1 & 0 & cos Dy 1\end{matrix} ) ( \begin{matrix}cos Dz 1 & - sin Dz 1 & 0 \\ sin Dz 1 & cos Dz 1 & 0 \\ 0 & 0 & 1\end{matrix} ) ( \begin{matrix}Ax 2 \\ Ay 2 \\ Az 2\end{matrix} )$$

In this equation, the vector on the left side is the acceleration component Ai2. On the other hand, the three matrices on the right side are the rotation matrix Rx, the rotation matrix Ry, and the rotation matrix Rz, respectively, from left to right. The vector at the right end of the right side is the second acceleration signal A2.

The acceleration component Ai2 is a three-dimensional vector including, as its respective components, an x1-axis acceleration component Aix1 along the x1 axis, a y1-axis acceleration component Aiy1 along the y1 axis, and a z1-axis acceleration component Aiz1 around the z1 axis.

The signal converter 142 outputs the reference signal R2 as a six-dimensional vector including the angular velocity component ωi2 and the acceleration component Ai2.

In addition, the signal converter 142 converts the orientation signal Q2 into a combination of a yaw Qz2 as a rotational angle around the z2 axis, a pitch Qy2 as a rotational angle around the y2 axis, and a roll Qx2 as a rotational angle around the x2 axis. Then, the signal converter 142 adds the yaw Dz1 of the detection axis information D1 to the yaw Qz2 to generate a yaw component Qiz1. In the same way, the signal converter 142 adds the pitch Dy1 of the detection axis information D1 to the pitch Qy2 to generate a pitch component Qiy1. In the same way, the signal converter 142 adds the roll Dx1 of the detection axis information D1 to the roll Qx2 to generate a roll component Qix1. The signal converter 142 outputs, as the reference orientation signal Qi2, the orientation expressed by the combination (Qix1, Qiy1, Qiz1) of the yaw component Qiz1, the pitch component Qiy1, and the roll component Qix1.

### (3.3.3) Signal Corrector

The signal corrector 143 corrects, based on the reference signal R2, the first angular velocity signal ω1 and the first acceleration signal A1 to output a corrected signal Sc1.

The signal corrector 143 corrects the x1-axis angular velocity signal ωx1 with the x1-axis angular velocity component ωix1 to generate an x1-axis angular velocity correction signal ωcx1. For example, the signal corrector 143 may output, as the x1-axis angular velocity correction signal ωcx1, the arithmetic mean of the x1-axis angular velocity signal ωx1 and the x1-axis angular velocity component ωix1. Alternatively, the signal corrector 143 may output, as the x1-axis angular velocity correction signal ωcx1, the weighted average of the x1-axis angular velocity signal ωx1 and the x1-axis angular velocity component ωix1, for example. The signal corrector 143 outputs, as the x1-axis angular velocity correction signal ωcx1, the sum of a×ωx1 and b×ωix using weighing coefficients a and b which satisfy all of a+b=1, 0≤a≤1, and 0≤b≤1.

In the same way, the signal corrector 143 corrects the y1-axis angular velocity signal ωy1 with the y1-axis angular velocity component ωiy1 to generate a y1-axis angular velocity correction signal ωcy1. In the same way, the signal corrector 143 corrects the z1-axis angular velocity signal ωz1 with the z1-axis angular velocity component ωiz1 to generate a z1-axis angular velocity correction signal ωcz1.

In the same way, the signal corrector 143 corrects the x1-axis acceleration signal Ax1 with the x1-axis acceleration component Aix1 to generate an x1-axis acceleration correction signal Acx1. In the same way, the signal corrector 143 corrects the y1-axis acceleration signal Ay1 with the y1-axis acceleration component Aiy1 to generate a y1-axis acceleration correction signal Acy1. In the same way, the signal corrector 143 corrects the z1-axis acceleration signal Az1 with the z1-axis acceleration component Aiz1 to generate a z1-axis acceleration correction signal Acz1.

The signal corrector 143 outputs, as the corrected signal Sc1, a six-dimensional vector including an angular velocity correction signal ωc1 as a three-dimensional vector and an acceleration correction signal Ac1 as a three-dimensional vector. The angular velocity correction signal ωc1 consists of, as its components, an x1-axis angular velocity correction signal ωcx1, a y1-axis angular velocity correction signal ωcy1, and a z1-axis angular velocity correction signal ωcz1. The acceleration correction signal Ac1 consists of, as its components, an x1-axis acceleration correction signal Acx1, a y1-axis acceleration correction signal Acy1, and a z1-axis acceleration correction signal Acz1.

### (3.3.4) Orientation Corrector

The orientation corrector 144 corrects, based on the reference orientation signal Qi2, the orientation signal Q1 to output a corrected orientation signal Qc1.

The orientation corrector 144 converts the orientation signal Q1 into a combination of a yaw Qz1 as a rotational angle around the z1 axis, a pitch Qy1 as a rotational angle around the y1 axis, and a roll Qx1 as a rotational angle around the x1 axis. The orientation corrector 144 may correct the yaw Qz1 with the yaw component Qiz1, for example, to generate a corrected yaw Qcz1. The orientation corrector 144 may output, as the corrected yaw Qcz1, the arithmetic mean of the yaw Qz1 and the yaw component Qiz1. Alternatively, the orientation corrector 144 may output, as the corrected yaw Qcz1, the weighted average of the yaw Qz1 and the yaw component Qiz1, for example. The orientation corrector 144 outputs, as the corrected yaw Qcz1, the sum of c×Qz1 and d×Qiz1 using weighing coefficients c and d which satisfy all of c+d=1, 0≤c≤1, and 0≤d≤1.

In the same way, the orientation corrector 144 corrects the pitch Qy1 with the pitch component Qiy1, for example, to generate a corrected pitch Qcy1. In the same way, the orientation corrector 144 corrects the roll Qx1 with the roll component Qix1, for example, to generate a corrected roll Qcx1.

The orientation corrector 144 outputs, as the corrected orientation signal Qc1, the orientation represented by the corrected yaw Qcz1, the corrected pitch Qcy1, and the corrected roll Qcx1.

### (4) Operation

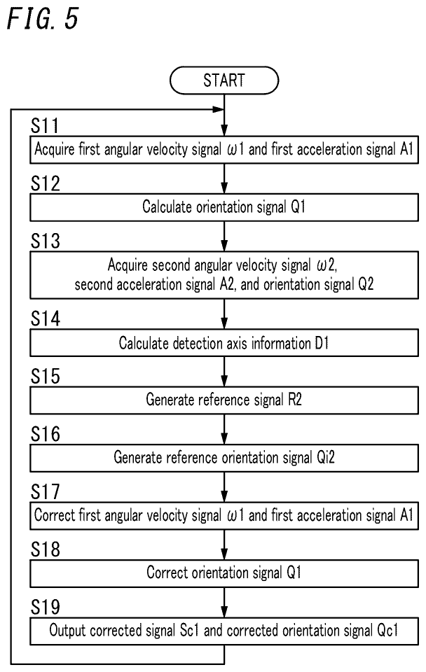

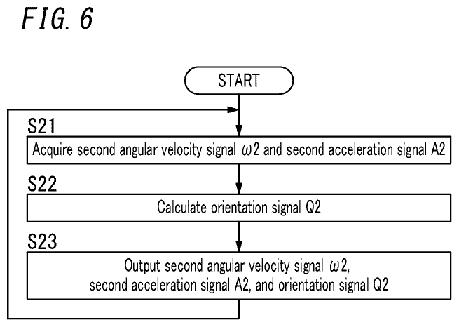

FIG. 5 is a flowchart showing the procedure of operation of the control unit 13 for the first sensor 10 according to the first embodiment. FIG. 6 is a flowchart showing the procedure of operation of the control unit 23 for the second sensor 20 according to the first embodiment.

The operation of the control unit 13 is partially the same as the operation of the control unit 23. Thus, the operation of the control unit 13 will be described after the operation of the control unit 23 has been described.

### (4.1) Operation of Control Unit of Second Sensor

As shown in FIG. 6, the control unit 23 of the second sensor 20 acquires the second angular velocity signal ω2 and the second acceleration signal A2 (in Step S21). The control unit 23 acquires the x2-axis angular velocity signal ωx2, the y2-axis angular velocity signal ωy2, and the z2-axis angular velocity signal ωz2 from the angular velocity detection elements 114-116, respectively, at regular intervals, for example. In the same way, the control unit 23 acquires the x2-axis acceleration signal Ax2, the y2-axis acceleration signal Ay2, and the z2-axis acceleration signal Az2 from the acceleration detection elements 124-126, respectively, at regular intervals, for example. The regular interval may be, for example, 3 ms.

Next, the control unit 23 calculates the orientation signal Q2 (in Step S22). The orientation calculator 231 of the control unit 23 predicts the orientation of the second sensor 20 based on the x2-axis angular velocity signal ωx2, the y2-axis angular velocity signal ωy2, the z2-axis angular velocity signal ωz2, the x2-axis acceleration signal Ax2, the y2-axis acceleration signal Ay2, and the z2-axis acceleration signal Az2 that have been acquired in Step S21. The orientation calculator 231 outputs, as the orientation signal Q2, a quaternion representing the orientation of the second sensor 20.

Subsequently, the control unit 23 outputs the second angular velocity signal ω2, the second acceleration signal A2, and the orientation signal Q2 (in Step S23). The control unit 23 outputs the second angular velocity signal ω2 and second acceleration signal A2 acquired in Step S21 and the orientation signal Q2 generated in Step S22 to the second signal path 40. The second angular velocity signal ω2, the second acceleration signal A2, and the orientation signal Q2 are output to the first sensor 10, and to the external system 50 via the first sensor 10, and the first signal path 30.

After having performed Step S23, the control unit 23 returns to Step S21 to perform Steps S21-S23 all over again when a predetermined interval passes since Step S21 has been performed last time. That is to say, the control unit 23 performs the series of Steps S21-S23 repeatedly at regular intervals.

### (4.2) Operation of Control Unit of First Sensor

As shown in FIG. 5, the control unit 13 of the first sensor 10 acquires the first angular velocity signal ω1 and the first acceleration signal A1 (in Step S11). The control unit 13 acquires the x1-axis angular velocity signal ωx1, the y1-axis angular velocity signal ωy1, and the z1-axis angular velocity signal ωz2 from the angular velocity detection elements 111-113, respectively, at regular intervals, for example. In the same way, the control unit 13 acquires the x1-axis acceleration signal Ax1, the y1-axis acceleration signal Ay1, and the z1-axis acceleration signal Az1 from the acceleration detection elements 121-123, respectively, at regular intervals, for example. The regular interval may be, for example, 3 ms.

Next, the control unit 13 calculates the orientation signal Q1 (in Step S12). The orientation calculator 131 of the control unit 13 predicts the orientation of the first sensor 10 based on the x1-axis angular velocity signal ωx1, the y1-axis angular velocity signal ωy1, the z1-axis angular velocity signal ωz1, the x1-axis acceleration signal Ax1, the y1-axis acceleration signal Ay1, and the z1-axis acceleration signal Az1 that have been acquired in Step S11. The orientation calculator 131 outputs, as the orientation signal Q1, a quaternion representing the orientation of the first sensor 10.

Subsequently, the control unit 13 acquires the second angular velocity signal ω2, the second acceleration signal A2, and the orientation signal Q2 (in Step S13). Specifically, the control unit 13 acquires, through the second signal path 40, the second angular velocity signal ω2, the second acceleration signal A2, and the orientation signal Q2 that have been provided by the control unit 23 of the second sensor 20 in Step S23.

Thereafter, the control unit 13 calculates detection axis information (in Step S14). The detection axis information calculator 141 of the control unit 13 calculates, based on the orientation signal Q1 and the orientation signal Q2, detection axis information D1 indicating a relationship between the combination of the three axes, namely, the x2, y2, and z2 axes, and the combination of the three axes, namely, the x1, y1, and z1 axes.

The detection axis information calculator 141 determines, based on the second angular velocity signal ω2 and the second acceleration signal A2, whether the second sensor 20 is moving relative to the first sensor 10. Unless the second sensor 20 is moving relative to the first sensor 10, the detection axis information calculator 141 calculates a correlation between the combination of the three axes, namely, the x1, y1, and z1 axes, and the combination of the three axes, namely, the x2, y2, and z2 axes. According to the correlation thus calculated between the combination of the three axes, namely, the x1, y1, and z axes, and the combination of the three axes, namely, the x2, y2, and z2 axes, the direction of the acceleration which may be calculated based on the orientation signal Q1 agrees with the direction of the acceleration which may be calculated based on the orientation signal Q2.

Subsequently, the control unit 13 generates a reference signal R2 (in Step S15). The signal converter 142 of the control unit 13 converts, in accordance with the detection axis information D1, the second angular velocity signal ω2 and the second acceleration signal A2 into an angular velocity component ωi2 and an acceleration component Ai2 expressed by a coordinate system based on the x1, y1, and z1 axes. Then, the signal converter 142 outputs a reference signal R2 including the angular velocity component ωi2 and the acceleration component Ai2.

Next, the control unit 13 generates a reference orientation signal Qi2 (in Step S16). Specifically, the signal converter 142 of the control unit 13 converts, in accordance with the detection axis information D1, the orientation signal Q2 into the reference orientation signal Qi2 expressed by the coordinate system based on the x1, y1, and z1 axes.

Then, the control unit 13 corrects, using the reference signal R2, the first angular velocity signal ω1 and the first acceleration signal A1 (in Step S17).

The signal corrector 143 of the control unit 13 outputs, as the x1-axis angular velocity correction signal ωcx1, the arithmetic mean of the x1-axis angular velocity signal ωx1 and the x1-axis angular velocity component ωix1, for example. In the same way, the signal corrector 143 outputs, as the y1-axis angular velocity correction signal ωcy1, the arithmetic mean of the y1-axis angular velocity signal ωy1 and the y1-axis angular velocity component ωiy1, for example. In the same way, the signal corrector 143 outputs, as the z1-axis angular velocity correction signal ωcz1, the arithmetic mean of the z1-axis angular velocity signal ωz1 and the z1-axis angular velocity component ωiz1, for example. In this manner, the angular velocity correction signal ωc1 is generated.

In the same way, the signal corrector 143 of the control unit 13 outputs, as the x1-axis acceleration correction signal Acx1, the arithmetic mean of the x1-axis acceleration signal Ax1 and the x1-axis acceleration component Aix1, for example. In the same way, the signal corrector 143 outputs, as the y1-axis acceleration correction signal Acy1, the arithmetic mean of the y1-axis acceleration signal Ay1 and the y1-axis acceleration component Aiy1, for example. In the same way, the signal corrector 143 outputs, as the z1-axis acceleration correction signal Acz1, the arithmetic mean of the z1-axis acceleration signal Az1 and the z1-axis acceleration component Aiz1, for example. In this manner, the acceleration correction signal Ac1 is generated.

Next, the control unit 13 corrects the orientation signal Q1 using the reference orientation signal Qi2 (in Step S18). Specifically, the orientation corrector 144 of the control unit 13 converts the orientation signal Q1 into a combination of a yaw Qz1 as a rotational angle around the z1 axis, a pitch Qy1 as a rotational angle around the y1 axis, and a roll Qx1 as a rotational angle around the x1 axis. The orientation corrector 144 may output, as a corrected yaw Qcz1, the arithmetic mean of the yaw Qz1 and the yaw component Qiz1, for example. In the same way, the orientation corrector 144 may output, as a corrected pitch Qcy1, the arithmetic mean of the pitch Qy1 and the pitch component Qiy1. for example. In the same way, the orientation corrector 144 may output, as a corrected roll Qcx1, the arithmetic mean of the roll Qx1 and the roll component Qix1, for example. In this manner, the corrected orientation signal Qc1 is generated.

Next, the control unit 13 outputs the corrected signal Sc1 and the corrected orientation signal Qc1 (in Step S19). Specifically, the control unit 13 outputs the corrected signal Sc1 and the corrected orientation signal Qc1 generated in Step S18 to the first signal path 30. The corrected signal Sc1 includes, as its components, the angular velocity correction signal ωc1 and the acceleration correction signal Ac1 that have been generated in Step S17. The corrected signal Sc1 and the corrected orientation signal Qc1 are output to the external system 50 through the first signal path 30.

After having performed Step S18, the control unit 13 returns to Step S11 to perform Steps S11-S18 all over again when a predetermined interval passes since Step S11 has been performed last time. That is to say, the control unit 13 performs the series of Steps S11-S18 repeatedly at regular intervals.

### (5) Advantages

In the control system 1 according to the first embodiment, the first sensor 10 corrects, based on the second angular velocity signal ω2, the second acceleration signal A2, and the orientation signal Q2 provided by the second sensor 20, the first angular velocity signal ω1, the first acceleration signal A1, and the orientation signal Q1. This enables improving the measurement accuracy of the corrected signal Sc1 and the corrected orientation signal Qc1 provided by the first sensor 10.

In addition, in the control system 1 according to the first embodiment, the first sensor 10 generates, based on the orientation signal Q1 and the orientation signal Q2, the reference signal R2 and the reference orientation signal Qi2 from the second angular velocity signal ω2, the second acceleration signal A2, and the orientation signal Q2. That is why the detection axis of the first sensor 10 does not have to be aligned with the detection axis of the second sensor 20. That is to say, this enables improving the measurement accuracy of the corrected signal Sc1 and corrected orientation signal Qc1 provided by the first sensor 10, without depending on the relationship between the first moving part 61 and the second moving part 62, the orientation of the first sensor 10 with respect to the first moving part 61, or the orientation of the second sensor 20 with respect to the second moving part 62.

### (First Variation)

In a control system 1 according to a first variation of the first embodiment, the first sensor 10 corrects some components of the first angular velocity signal ω1 and first acceleration signal A1, which is a difference from the control system 1 according to the first embodiment described above.

In the control system 1 according to the first variation of the first embodiment, the signal corrector 143 in the control unit 13 of the first sensor 10 corrects, based on the reference signal R2, at least one component selected from the group consisting of the three components of the first angular velocity signal ω1 and the three components of the first acceleration signal A1 to output the corrected signal Sc1.

The control unit 13 determines whether or not to make correction to respective components of the first angular velocity signal ω1 and respective components of the first acceleration signal A1, for example. More specifically, the control unit 13 retains data indicating whether or not correction needs to be made with respect to each of the x1-axis angular velocity signal ωx1, the y1-axis angular velocity signal ωy1, the z1-axis angular velocity signal ωz1, the x1-axis acceleration signal Ax1, the y1-axis acceleration signal Ay1, and the z1-axis acceleration signal Az1. The data indicating whether or not correction needs to be made may be received, for example, from the external system 50 through the first signal path 30. For example, if the second moving part 62 is rotatable around the y1 axis with respect to the first moving part 61, making no correction to the y1-axis angular velocity signal ωy1 may prevent the movement of the second moving part 62 with respect to the first moving part 61 from affecting the y1-axis angular velocity correction signal ωcy1.

The signal corrector 143 according to the first variation of the first embodiment corrects, based on the reference signal R2, only target components of the first angular velocity signal ω1 and the first acceleration signal A1 as in the first embodiment described above. On the other hand, the signal corrector 143 according to the first variation of the first embodiment outputs non-target components of the first angular velocity signal ω1 and the first acceleration signal A1 as they are as components of the corrected signal Sc1 without correcting the values of the components of the first angular velocity signal ω1 or the first acceleration signal A1.

For example, a situation where the x1-axis angular velocity signal ωx1, the y1-axis angular velocity signal ωy1, and the z-axis acceleration signal Az1 are to be corrected but the z1-axis angular velocity signal ωz1, the x1-axis acceleration signal Ax1, and the y1-axis acceleration signal Ay1 are not to be corrected will be described. In that case, the signal corrector 143 corrects the x1-axis angular velocity signal ωx1 with the x1-axis angular velocity component ωix1 to generate an x1-axis angular velocity correction signal ωcx1. In the same way, the signal corrector 143 corrects the y1-axis angular velocity signal ωy1 with the y1-axis angular velocity component ωiy1 to generate a y1-axis angular velocity correction signal ωcy1. On the other hand, the signal corrector 143 outputs the z1-axis angular velocity signal ωz1 as it is as a z1-axis angular velocity correction signal ωcz1. Meanwhile, the signal corrector 143 corrects the z1-axis acceleration signal Az1 with the z-axis acceleration component Aiz1 to generate a z1-axis acceleration correction signal Acz1. On the other hand, the signal corrector 143 outputs the x1-axis acceleration signal Ax1 as it is as an x1-axis acceleration correction signal Acx1. Also, the signal corrector 143 outputs the y1-axis acceleration signal Ay1 as it is as a y1-axis acceleration correction signal Acy1.

In the control system 1 according to the first variation of the first embodiment, the first sensor 10 corrects, based on the second angular velocity signal ω2, the second acceleration signal A2, and the orientation signal Q2 provided by the second sensor 20, the first angular velocity signal ω1, the first acceleration signal A1, and the orientation signal Q1. This enables improving the measurement accuracy of the corrected signal Sc1 and the corrected orientation signal Qc1 provided by the first sensor 10.

In addition, in the control system 1 according to the first variation of the first embodiment, the first sensor 10 corrects only some components of the first angular velocity signal ω1 and the first acceleration signal A1 without correcting the other components thereof. This enables making no correction to the other components, which would be difficult to improve their accuracy by correction due to the shape of the control target 60 or the positional relationship between the first sensor 10 and the second sensor 20, of the first angular velocity signal ω1 and the first acceleration signal A1 but outputting the result of measurement of the angular velocity detection elements 11 or acceleration detection elements 12 included in the first sensor 10.

### (Second Variation)

In the control system 1 according to a second variation of the first embodiment, the first sensor 10 changes the weight to be added, on a component-by-component basis, while correcting the first angular velocity signal ω1, the first acceleration signal A1, and the orientation signal Q1, which is a difference from the control system 1 according to the first embodiment described above.

The control system 1 according to the second variation of the first embodiment changes, at the time of correction, the weighing coefficient for at least one component selected from the group consisting of the three components of the first angular velocity signal ω1, the three components of the first acceleration signal A1, and the three components of the orientation signal Q1.

Meanwhile, the control unit 13 makes the weighing coefficient at the time of correction unchanged with respect to each of the x1-axis angular velocity signal ωx1, the y1-axis angular velocity signal ωy1, the z-axis angular velocity signal ωz1, the x1-axis acceleration signal Ax1, the y1-axis acceleration signal Ay1, the z1-axis acceleration signal Az1, the yaw Qz1, the pitch Qy1, and the roll Qx1, for example. The weighing coefficients may be received, for example, from the external system 50 through the first signal path 30. Optionally, the control unit 13 may retain multiple lists of combinations of weighing coefficients and may receive, from the external system 50, information indicating the list of combination of weighing coefficients to use for correction, for example.

The signal corrector 143 according to the second variation of the first embodiment generates the corrected signal Sc1 in the following manner. In the following description, a weighing coefficient for the x1-axis angular velocity signal ωx1 will be hereinafter referred to as “W1,” a weighing coefficient for the y1-axis angular velocity signal ωy1 will be hereinafter referred to as “W2,” a weighing coefficient for the z1-axis angular velocity signal z1 will be hereinafter referred to as “W3,” a weighing coefficient for the x1-axis acceleration signal Ax1 will be hereinafter referred to as “W4,” a weighing coefficient for the y1-axis acceleration signal Ay1 will be hereinafter referred to as “W5,” and a weighing coefficient for the z1-axis acceleration signal Az1 will be hereinafter referred to as “W6.” Each of the weighing coefficients W1-W6 is a value equal to or greater than 0 and equal to or less than 1.

The signal corrector 143 adds together the product of the value of the x1-axis angular velocity signal ωx1 and W1 and the product of the value of the x1-axis angular velocity component ωix1 and (1−W1) to generate an x1-axis angular velocity correction signal ωcx1. That is to say, the x1-axis angular velocity correction signal ωcx1 is a weighted average of the x1-axis angular velocity signal ωx1 and the x1-axis angular velocity component ωix1 calculated by using W1 as a weighing coefficient for the x1-axis angular velocity signal ωx1 and (1−W1) as a weighing coefficient for the x1-axis angular velocity component ωix1. In other words, the weighing coefficient for the x1-axis angular velocity signal ωx1 is a value indicating how many times as large as the x1-axis angular velocity signal ωx1 the value added is when the corrected signal Sc1 is generated.

In the same way, the signal corrector 143 adds together the product of the value of the y1-axis angular velocity signal ωy1 and W2 and the product of the value of the y1-axis angular velocity component ωiy1 and (1−W2) to generate a y1-axis angular velocity correction signal ωcy1. In the same way, the signal corrector 143 adds together the product of the value of the z1-axis angular velocity signal ωz1 and W3 and the product of the value of the z1-axis angular velocity component ωiz1 and (1−W3) to generate a z1-axis angular velocity correction signal ωcz1.

In the same way, the signal corrector 143 adds together the product of the value of the x1-axis acceleration signal Ax1 and W4 and the product of the value of the x1-axis acceleration component Aix1 and (1−W4) to generate an x1-axis acceleration correction signal Acx1. In the same way, the signal corrector 143 adds together the product of the value of the y1-axis acceleration signal Ay1 and W5 and the product of the value of the y1-axis acceleration component Aiy1 and (1−W5) to generate a y1-axis acceleration correction signal Acy1. In the same way, the signal corrector 143 adds together the product of the value of the z1-axis acceleration signal Az1 and W6 and the product of the value of the z1-axis acceleration component Aiz1 and (1−W6) to generate a z1-axis acceleration correction signal Acz1.

Also, the orientation corrector 144 according to the second variation of the first embodiment generates the corrected orientation signal Qc1 in the following manner. In the following description, a weighing coefficient for the yaw Qz1 will be hereinafter referred to as “W7,” a weighing coefficient for the pitch Qy1 will be hereinafter referred to as “W8,” and a weighing coefficient for the roll Qx1 will be hereinafter referred to as “W9.” Each of these weighing coefficients W7-W9 is a value equal to or greater than 0 and equal to or less than 1.

The orientation corrector 144 adds together the product of the value of the yaw Qz1 and W7 and the product of the value of the yaw component Qiz1 and (1−W7) to generate a corrected yaw Qcz1. That is to say, the corrected yaw Qcz1 is a weighted average of the yaw Qz1 and the yaw component Qiz1 calculated by using W7 as a weighing coefficient for the yaw Qz1 and (1−W7) as a weighing coefficient for the yaw component Qiz1.

In the same way, the orientation corrector 144 adds together the product of the value of the pitch Qy1 and W8 and the product of the value of the pitch component Qiy1 and (1−W8) to generate a corrected pitch Qcy1. In the same way, the orientation corrector 144 adds together the product of the value of the roll Qx1 and W9 and the product of the value of the roll component Qix1 and (1−W9) to generate a corrected roll Qcx1.

Note that each of these weighing coefficients W1-W9 may be an arbitrary value equal to or greater than 0 and equal to or less than 1. For example, all of these weighing coefficients W1-W9 may be the same as each other or different from each other, whichever is appropriate. Alternatively, in the weighing coefficients W1-W9, any one of the weighing coefficients W1-W6 may be different from another one of the other weighing coefficients W1-W6. Still alternatively, in the weighing coefficients W1-W9, any one of the weighing coefficients W1-W3 may be different from another one of the other weighing coefficients W1-W3. Yet alternatively, in the weighing coefficients W1-W9, any one of the weighing coefficients W4-W6 may be different from another one of the other weighing coefficients W4-W6. Yet alternatively, in the weighing coefficients W1-W9, any one of the weighing coefficients W7-W9 may be different from another one of the other weighing coefficients W7-W9.

Note that if not all of the weighing coefficients W1-W9 are the same as each other, a particular weighing coefficient is different from at least one of the other eight weighing coefficients. That is to say, if the weighing coefficient W1 is the same as any of the other weighing coefficients W2-W9, then the weighing coefficients W1-W9 are all the same as each other. On the other hand, if not all of the weighing coefficients W1-W9 are the same as each other, then the weighing coefficient W1 is different from at least one of the other weighing coefficients W2-W9.

Note that with respect to each of the weighing coefficients W1-W9, if the weighing coefficient is 1, then the weighing coefficient for a component included in either the reference signal R2 or the reference orientation signal Qi2 becomes equal to 0. That is to say, if the weighing coefficient is 1, then the components included in the first angular velocity signal ω1, the first acceleration signal A1, or the orientation signal Q1, as well as the non-target components for correction according to the first variation of the first embodiment, are output without being corrected. Also, with respect to each of the weighing coefficients W1-W9, if the weighing coefficient is 0, then the weighing coefficient for a component included in either the reference signal R2 or the reference orientation signal Qi2 becomes equal to 1. That is to say, if the weighing coefficient is 0, then the components included in the first angular velocity signal ω1, the first acceleration signal A1, or the orientation signal Q1 are not used but only the components included in either the reference signal R2 or the reference orientation signal Qi2 are output.

In the control system 1 according to the second variation of the first embodiment, the first sensor 10 also corrects, based on the second angular velocity signal ω2, the second acceleration signal A2, and the orientation signal Q2 provided by the second sensor 20, the first angular velocity signal ω1, the first acceleration signal A1, and the orientation signal Q1. This enables improving the measurement accuracy of the corrected signal Sc1 and the corrected orientation signal Qc1 provided by the first sensor 10.

Furthermore, in the control system 1 according to the second variation of the first embodiment, the first sensor 10 corrects each of the nine components included in the first angular velocity signal ω1, the first acceleration signal A1, and the orientation signal Q1 by calculating a weighted average using a weighing coefficient. This allows the correction to be made adaptively to the relationship between the first moving part 61 and the second moving part 62 and the relationship between the first sensor 10 and the second sensor 20.

### Second Embodiment

In a control system 1a according to a second embodiment, the second sensor 20a has the function of correcting, based on the angular velocity and acceleration provided by the first sensor 10a, the angular velocity and acceleration to be provided by the second sensor 20a itself, which is a difference from the control system 1 according to the first embodiment described above.

### (1) Control System

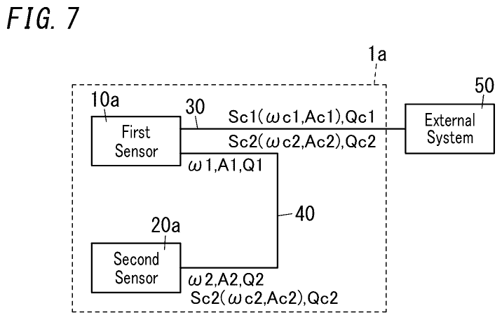

FIG. 7 is a block diagram illustrating a logical configuration for the control system 1a according to a second embodiment. The control system 1a according to the second embodiment includes a first sensor 10a, a second sensor 20a, the first signal path 30, and the second signal path 40. In this control system 1a, one terminal of the first signal path 30 is connected to the external system 50.

Each of the first sensor 10a and the second sensor 20a is a hexaxial inertial sensor for measuring angular velocity around each of three detection axes which are perpendicular to each other and acceleration along each of the three detection axes. The first sensor 10a and the second sensor 20a each has the function of correcting the angular velocity and acceleration as will be described in detail later.

The first signal path 30 is a communication route between the first sensor 10a and the external system 50. The first signal path 30 may be, for example, a linear bus compliant with the CAN standard. The first sensor 10a outputs, through the first signal path 30, the corrected angular velocity and acceleration to the external system 50. In addition, the first sensor 10a also outputs, through the first signal path 30, the corrected angular velocity and acceleration provided by the second sensor 20a.

The second signal path 40 is a communication route between the first sensor 10a and the second sensor 20a. The second signal path 40 may be, for example, a linear bus compliant with the CAN standard. The second sensor 20a outputs the angular velocity and acceleration that have not been corrected yet and the corrected angular velocity and corrected acceleration to the first sensor 10a through the second signal path 40. In addition, the first sensor 10a outputs, through the second signal path 40, the angular velocity and acceleration that have not been corrected yet.

The external system 50 receives, from the control system 1, the corrected angular velocity and acceleration provided by the first sensor 10a and the corrected angular velocity and acceleration provided by the second sensor 20a. The external system 50 is an operation control system for controlling the operation of the control target 60 to which the control system 1 is mounted.

### (2) Configurations for First Sensor and Second Sensor

### (2.1) First Sensor

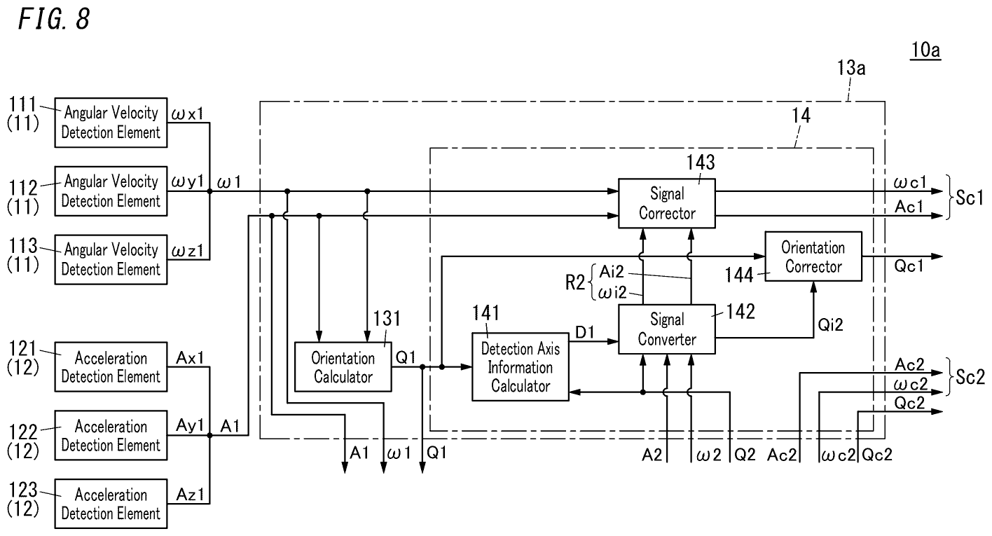

FIG. 8 is a block diagram illustrating a logical configuration for the first sensor 10a according to the second embodiment. In FIG. 8, any constituent element, having the same function as a counterpart shown in FIG. 1, will be designated by the same reference numeral as that counterpart's, and a detailed description thereof will be omitted herein.

As shown in FIG. 8, the first sensor 10a includes three angular velocity detection elements 11 (111-113), three acceleration detection elements 12 (121-123), and a control unit 13a. The control unit 13a includes an orientation calculator 131 and a signal corrector 14. The signal corrector 14 includes a detection axis information calculator 141, a signal converter 142, a signal corrector 143, and an orientation corrector 144.

The functions of the control unit 13a are different from those of the control unit 13 in the following respects. Specifically, the control unit 13a outputs the first angular velocity signal ω1, the first acceleration signal A1, and the orientation signal Q1 to the second sensor 20a through the second signal path 40. In addition, the control unit 13a receives a corrected signal Sc2 and a corrected orientation signal Qc2 through the second signal path 40. Furthermore, the control unit 13a outputs, instead of the second angular velocity signal ω2, the second acceleration signal A2, and the orientation signal Q2, the corrected signal Sc2 and the corrected orientation signal Qc2 to the external system 50 through the first signal path 30.

### (2.2) Second Sensor

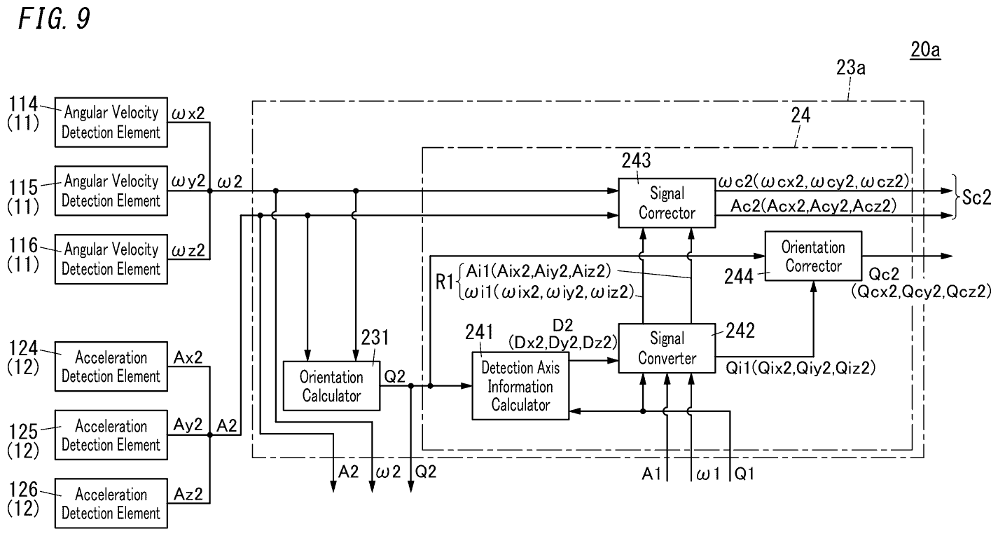

FIG. 9 is a block diagram illustrating a logical configuration for the second sensor 20a according to the second embodiment. In FIG. 9, any constituent element, having the same function as a counterpart shown in FIGS. 1, 2, and 8, will be designated by the same reference numeral as that counterpart's, and a detailed description thereof will be omitted herein.

As shown in FIG. 9, the second sensor 20a includes three angular velocity detection elements 11 (114-116), three acceleration detection elements 12 (124-126), and a control unit 23a. The control unit 23a includes an orientation calculator 231 and a signal corrector 24. The signal corrector 24 includes a detection axis information calculator 241, a signal converter 242, a signal corrector 243, and an orientation corrector 244.

The functions of the control unit 23a are different from the functions of the control unit 23 in the following respects. Specifically, the control unit 23a acquires, through the second signal path 40, the first angular velocity signal ω1, the first acceleration signal A1, and the orientation signal Q1 from the first sensor 10a. Then, the control unit 23a calculates, based on the orientation signal Q2 and the orientation signal Q1, detection axis information D2 indicating a relationship between the combination of the three axes, namely, x1, y1, and z1 axes and the combination of the three axes, namely, the x2, y2, and z2 axes. The control unit 23a generates a reference signal R1 by performing, in accordance with the detection axis information D2, coordinate transformation to transform the first angular velocity signal ω1 and the first acceleration signal A1 into a coordinate system based on the x2, y2, and z2 axes. Then, the control unit 23a corrects, based on the reference signal R1, the x2-axis angular velocity signal ωx2, the y2-axis angular velocity signal ωy2, the z2-axis angular velocity signal ωz2, the x2-axis acceleration signal Ax2, the y2-axis acceleration signal Ay2, and the z2-axis acceleration signal Az2, thereby generating a corrected signal Sc2. In addition, the control unit 23a generates a reference orientation signal Qi1 by performing, in accordance with the detection axis information D2, coordinate transformation to transform the orientation signal Q1 into a coordinate system based on the x2, y2, and z2 axes. The control unit 23a corrects the orientation signal Q2 based on the reference orientation signal Qi1 to generate a corrected orientation signal Qc2. In addition, the control unit 23a outputs the corrected signal Sc2 and the corrected orientation signal Qc2 to the first sensor 10a through the second signal path 40.

The following description will be focused on the detection axis information calculator 241, the signal converter 242, the signal corrector 243, and the orientation corrector 244 belonging to the control unit 23a which are not included in the control unit 23.

### (2.2.1) Detection Axis Information Calculator

The detection axis information calculator 241 calculates, based on the orientation signal Q2 and the orientation signal Q1, detection axis information indicating a relationship between the combinations of the three axes, namely, the x1, y1, and z1 axes, and the combination of the three axes, namely, the x2, y2, and z2 axes.

The detection axis information calculator 241 determines, based on the magnitude of the second angular velocity signal ω2, for example, whether the second sensor 20a is moving relative to the first sensor 10a. Then, the detection axis information calculator 241 transforms the orientation signal Q2, for example, into a combination of a yaw Qz2 as a rotational angle around the z2 axis, a pitch Qy2 as a rotational angle around the y2 axis, and a roll Qx2 as a rotational angle around the x2 axis. In the same way, the detection axis information calculator 241 also transforms the orientation signal Q1, for example, into a combination of a yaw Qz1 as a rotational angle around the z1 axis, a pitch Qy1 as a rotational angle around the y1 axis, and a roll Qx1 as a rotational angle around the x1 axis. Unless the second sensor 20a is moving relative to the first sensor 10a, the angular velocity and acceleration applied to the second sensor 20a have the same direction and magnitude as the angular velocity and acceleration applied to the first sensor 10a. In that case, the detection axis information D2 is represented by the combination (Dx2, Dy2, Dz2) of a yaw Dz2 given by (Qz2-Qz1), a pitch Dy2 given by (Qy2-Qy1), and a roll Dx2 given by (Qx2-Qx1).

### (2.2.2) Signal Converter

The signal converter 242 converts, in accordance with the detection axis information D2, the first angular velocity signal ω1 and the first acceleration signal A1 into the reference signal R1 expressed by a coordinate system based on the x2, y2, and z2 axes, and outputs the reference signal R1. In addition, the signal converter 242 also converts, in accordance with the detection axis information D2, the orientation signal Q1 into the reference orientation signal Qi1 as an orientation signal expressed by a coordinate system based on the x2, y2, and z2 axes, and outputs the reference orientation signal Qi1.

The signal converter 242 generates, in accordance with the detection axis information D2, a rotation matrix Rx2 which uses the roll Dx2 as a rotational angle around the x2 axis, a rotation matrix Ry2 which uses the pitch Dy2 as a rotational angle around the y2 axis, and a rotation matrix Rz2 which uses the yaw Dz2 as a rotational angle around the z2 axis. An angular velocity component ωi1 which expresses the first angular velocity signal ω1 by the coordinate system based on the x2, y2, and z2 axes is calculated by the following equation:

$$ω i 1 = Rx 2 \times Ry 2 \times Rz 2 \times ω1$$

$$( \begin{matrix}ω ix 2 \\ ω iy 2 \\ ω iz 2\end{matrix} ) = ( \begin{matrix}1 & 0 & 0 \\ 0 & cos Dx 2 & - sin Dx 2 \\ 0 & sin Dx 2 & cos Dx 2\end{matrix} ) ( \begin{matrix}cos Dy 2 & 0 & sin Dy 2 \\ 0 & 1 & 0 \\ - sin Dy 2 & 0 & cos Dy 2\end{matrix} ) ( \begin{matrix}cos Dz 2 & - sin Dz 2 & 0 \\ sin Dz 2 & cos Dz 2 & 0 \\ 0 & 0 & 1\end{matrix} ) ( \begin{matrix}ω x 1 \\ ω y 1 \\ ω z 1\end{matrix} )$$

In this equation, the vector on the left side is the angular velocity component ωi1. On the other hand, the three matrices on the right side are the rotation matrix Rx2, the rotation matrix Ry2, and the rotation matrix Rz2, respectively, from left to right. The vector at the right end of the right side is the first angular velocity signal ω1.

The angular velocity component ωi1 is a three-dimensional vector including, as its respective components, an x2-axis angular velocity component ωix2 around the x2 axis, a y2-axis angular velocity component ωiy2 around the y2 axis, and a z2-axis angular velocity component ωiz2 around the z2 axis.

Meanwhile, an acceleration component Ai1 which expresses the first acceleration signal A1 by the coordinate system based on the x2, y2, and z2 axes is calculated by the following equation:

$$A i 1 = Rx 2 \times Ry 2 \times Rz 2 \times A 1$$

$$( \begin{matrix}Aix 2 \\ Aiy 2 \\ Aiz 2\end{matrix} ) = ( \begin{matrix}1 & 0 & 0 \\ 0 & cos Dx 2 & - sin Dx 2 \\ 0 & sin Dx 2 & cos Dx 2\end{matrix} ) ( \begin{matrix}cos Dy 2 & 0 & sin Dy 2 \\ 0 & 1 & 0 \\ - sin Dy 2 & 0 & cos Dy 2\end{matrix} ) ( \begin{matrix}cos Dz 2 & - sin Dz 2 & 0 \\ sin Dz 2 & cos Dz 2 & 0 \\ 0 & 0 & 1\end{matrix} ) ( \begin{matrix}Ax 1 \\ Ay 1 \\ Az 1\end{matrix} )$$

In this equation, the vector on the left side is the acceleration component Ai1. On the other hand, the three matrices on the right side are the rotation matrix Rx2, the rotation matrix Ry2, and the rotation matrix Rz2, respectively, from left to right. The vector at the right end of the right side is the first acceleration signal A1.

The acceleration component Ai1 is a three-dimensional vector including, as its respective components, an x2-axis acceleration component Aix2 along the x2 axis, a y2-axis acceleration component Aiy2 along the y2 axis, and a z2-axis acceleration component Aiz2 around the z2 axis.

The signal converter 242 outputs the reference signal R1 as a six-dimensional vector including the angular velocity component ωi1 and the acceleration component Ai1.

In addition, the signal converter 242 converts the orientation signal Q1 into a combination of a yaw Qz1 as a rotational angle around the z1 axis, a pitch Qy1 as a rotational angle around the y1 axis, and a roll Qx1 as a rotational angle around the x1 axis. Then, the signal converter 142 adds the yaw Dz2 of the detection axis information D2 to the yaw Qz1 to generate a yaw component Qiz2. In the same way, the signal converter 242 adds the pitch Dy2 of the detection axis information D2 to the pitch Qy1 to generate a pitch component Qiy2. In the same way, the signal converter 242 adds the roll Dx2 of the detection axis information D2 to the roll Qx1 to generate a roll component Qix2. The signal converter 242 outputs, as the reference orientation signal Qi1, the orientation expressed by the combination (Qix2, Qiy2, Qiz2) of the yaw component Qiz2, the pitch component Qiy2, and the roll component Qix2.

### (2.2.3) Signal Corrector

The signal corrector 243 corrects, based on the reference signal R1, the second angular velocity signal ω2 and the second acceleration signal A2 to output a corrected signal Sc2.

The signal corrector 243 corrects the x2-axis angular velocity signal ωx2 with the x2-axis angular velocity component ωix2 to generate an x2-axis angular velocity correction signal ωcx2. For example, the signal corrector 243 may output, as the x2-axis angular velocity correction signal ωcx2, the arithmetic mean of the x2-axis angular velocity signal ωx2 and the x2-axis angular velocity component ωix2. Alternatively, the signal corrector 243 may output, as the x2-axis angular velocity correction signal ωcx2, the weighted average of the x2-axis angular velocity signal ωx2 and the x2-axis angular velocity component ωix2, for example. In this case, the weight coefficient of the x2-axis angular velocity signal ωx2 and the weight coefficient of the x2-axis angular velocity component ωix2 are each a value equal to or greater than 0 and equal to or less than 1. In addition, the sum of the weight coefficient of the x2-axis angular velocity signal ωx2 and the weight coefficient of the x2-axis angular velocity component ωix2 is 1.

In the same way, the signal corrector 243 corrects the y2-axis angular velocity signal ωy2 with the y2-axis angular velocity component ωiy2 to generate a y2-axis angular velocity correction signal ωcy2. In the same way, the signal corrector 243 corrects the z2-axis angular velocity signal ωz2 with the z2-axis angular velocity component ωiz2 to generate a z2-axis angular velocity correction signal ωcz2.

In the same way, the signal corrector 243 corrects the x2-axis acceleration signal Ax2 with the x2-axis acceleration component Aix2 to generate an x2-axis acceleration correction signal Acx2. In the same way, the signal corrector 243 corrects the y2-axis acceleration signal Ay2 with the y2-axis acceleration component Aiy2 to generate a y2-axis acceleration correction signal Acy2. In the same way, the signal corrector 243 corrects the z2-axis acceleration signal Az2 with the z2-axis acceleration component Aiz2 to generate a z2-axis acceleration correction signal Acz2.

The signal corrector 243 outputs, as the corrected signal Sc2, a six-dimensional vector including an angular velocity correction signal ωc2 as a three-dimensional vector and an acceleration correction signal Ac2 as a three-dimensional vector. The angular velocity correction signal ωc2 consists of, as its components, an x2-axis angular velocity correction signal ωcx2, a y2-axis angular velocity correction signal ωcy2, and a z2-axis angular velocity correction signal ωcz2. The acceleration correction signal Ac2 consists of, as its components, an x2-axis acceleration correction signal Acx2, a y2-axis acceleration correction signal Acy2, and a z2-axis acceleration correction signal Acz2.

### (2.2.4) Orientation Corrector

The orientation corrector 244 corrects, based on the reference orientation signal Qi1, the orientation signal Q2 to output a corrected orientation signal Qc2.

The orientation corrector 244 converts the orientation signal Q2 into a combination of a yaw Qz2 as a rotational angle around the z2 axis, a pitch Qy2 as a rotational angle around the y2 axis, and a roll Qx2 as a rotational angle around the x1 axis. The orientation corrector 244 may correct the yaw Qz2 with the yaw component Qiz2, for example, to generate a corrected yaw Qcz2. The orientation corrector 244 may output, as the corrected yaw Qcz2, the arithmetic mean of the yaw Qz2 and the yaw component Qiz2, for example. Alternatively, the orientation corrector 244 may output, as the corrected yaw Qcz2, the weighted average of the yaw Qz2 and the yaw component Qiz2, for example. In this case, the weight coefficient of the yaw Qz2 and the weight coefficient of the yaw component Qiz2 are each a value equal to or greater than 0 and equal to or less than 1. In addition, the sum of the weight coefficient of the yaw Qz2 and the weight coefficient of the yaw component Qiz2 is 1.

In the same way, the orientation corrector 244 corrects the pitch Qy2 with the pitch component Qiy2, for example, to generate a corrected pitch Qcy2. In the same way, the orientation corrector 244 corrects the roll Qx2 with the roll component Qix2, for example, to generate a corrected roll Qcx2.

The orientation corrector 244 outputs, as the corrected orientation signal Qc2, the orientation represented by the corrected yaw Qcz2, the corrected pitch Qcy2, and the corrected roll Qcx2.

### (3) Operation

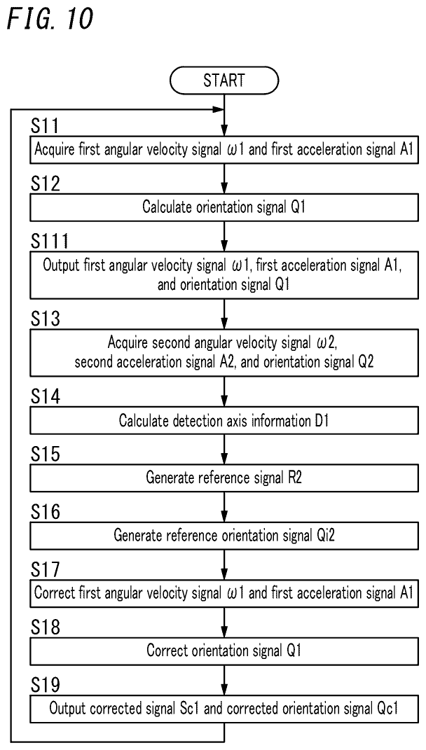

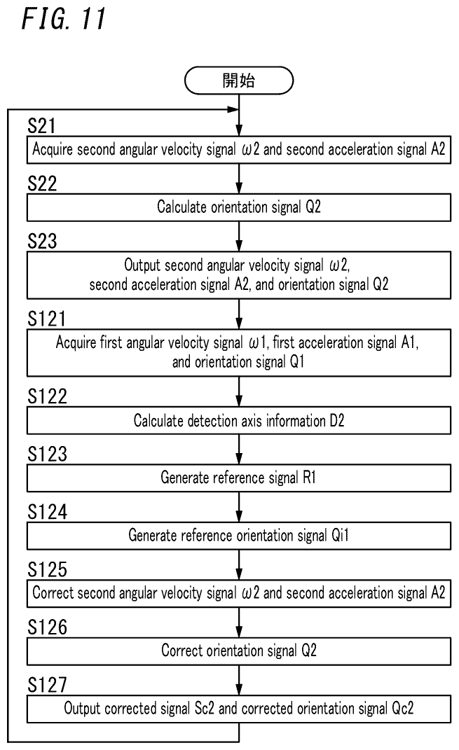

FIG. 10 is a flowchart showing the procedure of operation of the control unit 13a for the first sensor 10a according to the second embodiment. FIG. 11 is a flowchart showing the procedure of operation of the control unit 23a for the second sensor 20a according to the second embodiment. Note that the same process step as a counterpart shown in FIG. 5 or 6 is designated by the same reference sign as that counterpart's and a detailed description thereof will be omitted herein.

### (3.1) Operation of Control Unit of First Sensor

As shown in FIG. 10, the control unit 13a of the first sensor 10a acquires the first angular velocity signal ω1 and the first acceleration signal A1 (in Step S11). The control unit 13a acquires respective components of the first angular velocity signal ω1 and respective components of the first acceleration signal A1 from the angular velocity detection elements 111-113 and the acceleration detection elements 121-123, respectively, at regular intervals, for example. The regular interval may be, for example, 3 ms.

Next, the control unit 13a calculates the orientation signal Q1 (in Step S12). The orientation calculator 131 of the control unit 13a predicts the orientation of the first sensor 10a based on the first angular velocity signal ω1 and the first acceleration signal A1 acquired in Step S11. The orientation calculator 131 outputs, as the orientation signal Q1, a quaternion representing the orientation of the first sensor 10a.

Subsequently, the control unit 13a outputs the first angular velocity signal ω1, the first acceleration signal A1, and the orientation signal Q1 (in Step S111). The control unit 13a outputs the first angular velocity signal ω1, the first acceleration signal A1, and the orientation signal Q1 to the second sensor 20a through the second signal path 40.

Next, the control unit 13a acquires the second angular velocity signal ω2, the second acceleration signal A2, and the orientation signal Q2 (in Step S13). The control unit 13a acquires, through the second signal path 40, the second angular velocity signal ω2, the second acceleration signal A2, and the orientation signal Q2 that the control unit 23a of the second sensor 20a has output in Step S23.

Thereafter, the control unit 13a calculates detection axis information (in Step S14). Specifically, the detection axis information calculator 141 of the control unit 13a calculates, based on the orientation signal Q1 and the orientation signal Q2, detection axis information D1 indicating a relationship between the combination of three axes, namely, the x2, y2, and z2 axes, and the combination of three axes, namely, the x1, y1, and z1 axes.

Subsequently, the control unit 13a generates a reference signal R2 (in Step S15). The signal converter 142 of the control unit 13a transforms, in accordance with the detection axis information D1, the second angular velocity signal ω2 and the second acceleration signal A2 into an angular velocity component ωi2 and an acceleration component Ai2 expressed by a coordinate system based on the x1, y1, and z1 axes. Then, the signal converter 142 outputs the reference signal R2 including the angular velocity component ωi2 and the acceleration component Ai2.

Next, the control unit 13a generates a reference orientation signal Qi2 (in Step S16). The signal converter 142 of the control unit 13a transforms, in accordance with the detection axis information D1, the orientation signal Q2 into a reference orientation signal Qi2 expressed by a coordinate system based on the x1, y1, and z1 axes.

Subsequently, the control unit 13a corrects the first angular velocity signal ω1 and the first acceleration signal A1 using the reference signal R2 (in Step S17).

Next, the control unit 13a corrects the orientation signal Q1 using the reference orientation signal Qi2 (in Step S18).

Next, the control unit 13a outputs the corrected signal Sc1 and the corrected orientation signal Qc1 (in Step S19). Specifically, the control unit 13a outputs the corrected signal Sc1 and the corrected orientation signal Qc1 generated in Step S18 to the first signal path 30. The corrected signal Sc1 includes, as its components, the angular velocity correction signal ωc1 and the acceleration correction signal Ac1 that have been generated in Step S17. The corrected signal Sc1 and the corrected orientation signal Qc1 are output to the external system 50 through the first signal path 30.

After having performed Step S18, the control unit 13a returns to Step S11 to perform Steps S11-S18 all over again when a predetermined interval passes since Step S11 has been performed last time. That is to say, the control unit 13a performs the series of Steps S11-S18 repeatedly at regular intervals.

### (3.2) Operation of Control Unit of Second Sensor

As shown in FIG. 11, the control unit 23a of the second sensor 20a acquires the second angular velocity signal ω2 and the second acceleration signal A2 (in Step S21). The control unit 23a acquires respective components of the second angular velocity signal ω2 and respective components of the second acceleration signal A2 from the angular velocity detection elements 114-116 and the acceleration detection elements 124-126, respectively, at regular intervals, for example. The regular interval may be, for example, 3 ms.

Next, the control unit 23a calculates the orientation signal Q2 (in Step S22). The orientation calculator 231 of the control unit 23a predicts the orientation of the second sensor 20a based on the second angular velocity signal ω2 and the second acceleration signal A2 acquired in Step S21. The orientation calculator 231 outputs, as the orientation signal Q2, a quaternion representing the orientation of the second sensor 20a.

Subsequently, the control unit 23a outputs the second angular velocity signal ω2, the second acceleration signal A2, and the orientation signal Q2 (in Step S23). The control unit 23a outputs the second angular velocity signal ω2, the second acceleration signal A2, and the orientation signal Q2 to the first sensor 10a through the second signal path 40.

Next, the control unit 23a acquires the first angular velocity signal ω1, the first acceleration signal A1, and the orientation signal Q1 (in Step S121). The control unit 23a acquires, through the second signal path 40, the first angular velocity signal ω1, the first acceleration signal A1, and the orientation signal Q1 that the control unit 13a of the first sensor 10a has output in Step S111.

Thereafter, the control unit 23a calculates detection axis information (in Step S122). Specifically, the detection axis information calculator 241 of the control unit 23a calculates, based on the orientation signal Q2 and the orientation signal Q1, detection axis information D2 indicating a relationship between the combination of three axes, namely, the x1, y1, and z1 axes, and the combination of three axes, namely, the x2, y2, and z2 axes.

Subsequently, the control unit 23a generates a reference signal R1 (in Step S123). The signal converter 242 of the control unit 23a transforms, in accordance with the detection axis information D2, the first angular velocity signal ω1 and the first acceleration signal A1 into an angular velocity component ωi1 and an acceleration component Ai1, respectively, expressed by a coordinate system based on the x2, y2, and z2 axes. Then, the signal converter 242 outputs the reference signal R1 including the angular velocity component ωi1 and the acceleration component Ai1.

Next, the control unit 23a generates a reference orientation signal Qi1 (in Step S124). The signal converter 242 of the control unit 23a transforms, in accordance with the detection axis information D2, the orientation signal Q1 into a reference orientation signal Qi1 expressed by a coordinate system based on the x2, y2, and z2 axes.

Subsequently, the control unit 23a corrects the second angular velocity signal ω2 and the second acceleration signal A2 using the reference signal R1 (in Step S125).

Next, the control unit 23a corrects the orientation signal Q2 using the reference orientation signal Qi1 (in Step S126).

Next, the control unit 23a outputs the corrected signal Sc2 and the corrected orientation signal Qc2 (in Step S127). Specifically, the control unit 23a outputs the corrected signal Sc2 and the corrected orientation signal Qc2 generated in Step S126 to the second signal path 40. The corrected signal Sc2 includes, as its components, the angular velocity correction signal c2 and the acceleration correction signal Ac2 that have been generated in Step S125. The corrected signal Sc2 and the corrected orientation signal Qc2 are output to the external system 50 through the first sensor 10a and the first signal path 30.

After having performed Step S127, the control unit 23a returns to Step S21 to perform Steps S21-S127 all over again when a predetermined interval passes since Step S21 has been performed last time. That is to say, the control unit 23a performs the series of Steps S21-S127 repeatedly at regular intervals.

### (4) Advantages

In the control system 1a according to the second embodiment, the first sensor 10a corrects, based on the second angular velocity signal ω2, the second acceleration signal A2, and the orientation signal Q2 provided by the second sensor 20a, the first angular velocity signal ω1, the first acceleration signal A1, and the orientation signal Q1. This enables improving the measurement accuracy of the angular velocity correction signal ωc1, the acceleration correction signal Ac1, and the corrected orientation signal Qc1 provided by the first sensor 10a.

In addition, in the control system 1a according to the second embodiment, the second sensor 20a corrects, based on the first angular velocity signal ω1, the first acceleration signal A1, and the orientation signal Q1 provided by the first sensor 10a, the second angular velocity signal ω2, the second acceleration signal A2, and the orientation signal Q2. This enables improving the measurement accuracy of the angular velocity correction signal ωc2, the acceleration correction signal Ac2, and the corrected orientation signal Qc2 provided by the second sensor 20a.

In addition, in the control system 1a according to the second embodiment, the first sensor 10a generates, based on the orientation signal Q1 and the orientation signal Q2, the reference signal R2 and the reference orientation signal Qi2 from the second angular velocity signal ω2, the second acceleration signal A2, and the orientation signal Q2. In the same way, in the control system 1a according to the second embodiment, the second sensor 20a generates, based on the orientation signal Q2 and the orientation signal Q1, the reference signal R1 and the reference orientation signal Qi1 from the first angular velocity signal ω1, the first acceleration signal A1, and the orientation signal Q1. That is why the detection axis of the first sensor 10a does not have to be aligned with the detection axis of the second sensor 20a. That is to say, this enables improving the measurement accuracy of the first sensor 10a and the second sensor 20a, without depending on the relationship between the first moving part 61 and the second moving part 62, the orientation of the first sensor 10a with respect to the first moving part 61, or the orientation of the second sensor 20a with respect to the second moving part 62.

### (First Variation)

In a control system 1a according to a first variation of the second embodiment, as in the first variation of the first embodiment, the second sensor 20a corrects some components of the second angular velocity signal ω2 and second acceleration signal A2, which is a difference from the control system 1a according to the second embodiment described above.

In the control system 1a according to the first variation of the second embodiment, the signal corrector 243 in the control unit 23a of the second sensor 20a corrects, based on the reference signal R1, at least one component selected from the group consisting of the three components of the second angular velocity signal ω2 and the three components of the second acceleration signal A2 to output the corrected signal Sc2.

The control unit 23a determines whether or not to make correction to respective components of the second angular velocity signal ω2 and respective components of the second acceleration signal A2, for example.

The signal corrector 243 according to the first variation of the second embodiment corrects, based on the reference signal R1, only target components of the second angular velocity signal ω2 and the second acceleration signal A2 as in the second embodiment described above. On the other hand, the signal corrector 243 according to the first variation of the second embodiment outputs non-target components of the second angular velocity signal ω2 and the second acceleration signal A2 as they are as components of the corrected signal Sc2 without correcting the values of those components of the second angular velocity signal ω2 and the second acceleration signal A2. The details have already been described for the first variation of the first embodiment and description thereof will be omitted herein.

In the control system 1a according to the first variation of the second embodiment, the second sensor 20a corrects, based on the first angular velocity signal ω1, the first acceleration signal A1, and the orientation signal Q1 provided by the first sensor 10a, the second angular velocity signal ω2, the second acceleration signal A2, and the orientation signal Q2. This enables improving the measurement accuracy of the corrected signal Sc2 and the corrected orientation signal Qc2 provided by the second sensor 20a.

In addition, in the control system 1a according to the first variation of the second embodiment, the second sensor 20a corrects only some components of the second angular velocity signal ω2 and the second acceleration signal A2 without correcting the other components thereof. This enables making no correction to the other components, which would be difficult to improve their accuracy by correction, of the second angular velocity signal ω2 and the second acceleration signal A2 but outputting the result of measurement of the angular velocity detection elements 11 or acceleration detection elements 12 included in the second sensor 20a.

### (Second Variation)

In the control system 1a according to a second variation of the second embodiment, as in the second variation of the first embodiment, the second sensor 20a changes the weight to be added, on a component-by-component basis, while correcting the second angular velocity signal ω2, the second acceleration signal A2, and the orientation signal Q1, which is a difference from the control system 1a according to the second embodiment described above.

The control system 1a according to the second variation of the second embodiment changes, at the time of correction, the weighing coefficient for at least one component selected from the group consisting of the three components of the second angular velocity signal ω2, the three components of the second acceleration signal A2, and the three components of the orientation signal Q2.

Meanwhile, the control unit 23a makes the weighing coefficient at the time of correction unchanged with respect to each of the x2-axis angular velocity signal ωx2, the y2-axis angular velocity signal ωy2, the z2-axis angular velocity signal ωz2, the x2-axis acceleration signal Ax2, the y2-axis acceleration signal Ay2, the z2-axis acceleration signal Az2, the yaw Qz2, the pitch Qy2, and the roll Qx2, for example.

The signal corrector 243 according to the second variation of the second embodiment generates the corrected signal Sc2 in the following manner. In the following description, a weighing coefficient for the x2-axis angular velocity signal ωx2 will be hereinafter referred to as “Wb1,” a weighing coefficient for the y2-axis angular velocity signal ωy2 will be hereinafter referred to as “Wb2,” a weighing coefficient for the z2-axis angular velocity signal ωz2 will be hereinafter referred to as “Wb3,” a weighing coefficient for the x2-axis acceleration signal Ax2 will be hereinafter referred to as “Wb4,” a weighing coefficient for the y2-axis acceleration signal Ay2 will be hereinafter referred to as “Wb5,” and a weighing coefficient for the z2-axis acceleration signal Az2 will be hereinafter referred to as “Wb6.” Each of the weighing coefficients Wb1-Wb6 is a value equal to or greater than 0 and equal to or less than 1.

The signal corrector 243 adds together the product of the value of the x2-axis angular velocity signal ωx2 and Wb1 and the product of the value of the x2-axis angular velocity component ωix2 and (1−Wb1) to generate an x2-axis angular velocity correction signal ωcx2. In the same way, the signal corrector 243 adds together the product of the value of the y2-axis angular velocity signal ωy2 and Wb2 and the product of the value of the y2-axis angular velocity component ωiy2 and (1−Wb2) to generate a y2-axis angular velocity correction signal ωcy2. In the same way, the signal corrector 243 adds together the product of the value of the z2-axis angular velocity signal ωz2 and Wb3 and the product of the value of the z2-axis angular velocity component ωiz2 and (1−Wb3) to generate a z2-axis angular velocity correction signal ωcz2.

In the same way, the signal corrector 243 adds together the product of the value of the x2-axis acceleration signal Ax2 and Wb4 and the product of the value of the x2-axis acceleration component Aix2 and (1−Wb4) to generate an x2-axis acceleration correction signal Acx2. In the same way, the signal corrector 243 adds together the product of the value of the y2-axis acceleration signal Ay2 and Wb5 and the product of the value of the y2-axis acceleration component Aiy2 and (1−Wb5) to generate a y2-axis acceleration correction signal Acy2. In the same way, the signal corrector 243 adds together the product of the value of the z2-axis acceleration signal Az2 and Wb6 and the product of the value of the z2-axis acceleration component Aiz2 and (1−Wb6) to generate a z2-axis acceleration correction signal Acz2.

Also, the orientation corrector 244 according to the second variation of the second embodiment generates the corrected orientation signal Qc2 in the following manner. In the following description, a weighing coefficient for the yaw Q22 will be hereinafter referred to as “Wb7,” a weighing coefficient for the pitch Qy2 will be hereinafter referred to as “Wb8,” and a weighing coefficient for the roll Qx2 will be hereinafter referred to as “Wb9.” Each of these weighing coefficients Wb7-Wb9 is a value equal to or greater than 0 and equal to or less than 1.

The orientation corrector 244 adds together the product of the value of the yaw Qz2 and Wb7 and the product of the value of the yaw component Qiz2 and (1−Wb7) to generate a corrected yaw Qcz2. In the same way, the orientation corrector 244 adds together the product of the value of the pitch Qy2 and Wb8 and the product of the value of the pitch component Qiy2 and (1−Wb8) to generate a corrected pitch Qcy2. In the same way, the orientation corrector 244 adds together the product of the value of the roll Qx2 and Wb9 and the product of the value of the roll component Qix2 and (1−Wb9) to generate a corrected roll Qcx2.

Note that each of these weighing coefficients Wb1-Wb9 may be an arbitrary value equal to or greater than 0 and equal to or less than 1. For example, all of these weighing coefficients Wb1-Wb9 may be the same as each other or different from each other, whichever is appropriate. Alternatively, in the weighing coefficients Wb1-Wb9, any one of the weighing coefficients Wb1-Wb6 may be different from another one of the other weighing coefficients Wb1-Wb6. Still alternatively, in the weighing coefficients Wb1-Wb9, any one of the weighing coefficients Wb1-Wb3 may be different from another one of the other weighing coefficients Wb1-Wb3. Yet alternatively, in the weighing coefficients Wb1-Wb9, any one of the weighing coefficients Wb4-Wb6 may be different from another one of the other weighing coefficients Wb4-Wb6. Yet alternatively, in the weighing coefficients Wb1-Wb9, any one of the weighing coefficients Wb7-Wb9 may be different from another one of the other weighing coefficients Wb7-Wb9.

Note that if not all of the weighing coefficients Wb1-Wb9 are the same as each other, a particular weighing coefficient is different from at least one of the other eight weighing coefficients. That is to say, if the weighing coefficient Wb1 is the same as any of the other weighing coefficients Wb2-Wb9, then the weighing coefficients Wb1-Wb9 are all the same as each other. On the other hand, if not all of the weighing coefficients Wb1-Wb9 are the same as each other, then the weighing coefficient Wb1 is different from at least one of the other weighing coefficients Wb2-Wb9.

In the control system 1a according to the second variation of the second embodiment, the second sensor 20a also corrects, based on the first angular velocity signal ω1, the first acceleration signal A1, and the orientation signal Q1 provided by the first sensor 10a, the second angular velocity signal ω2, the second acceleration signal A2, and the orientation signal Q2. This enables improving the measurement accuracy of the corrected signal Sc2 and the corrected orientation signal Qc2 provided by the second sensor 20a.

Furthermore, in the control system 1a according to the second variation of the second embodiment, the second sensor 20 corrects each of the nine components included in the second angular velocity signal ω2, the second acceleration signal A2, and the orientation signal Q2 by calculating a weighted average using a weighing coefficient. This allows the correction to be made adaptively to the relationship between the first moving part 61 and the second moving part 62 and the relationship between the first sensor 10 and the second sensor 20.

### Third Embodiment

A control system 1b according to a third embodiment includes three or more inertial sensors, which is a difference from the control system 1 according to the first embodiment described above.

### (1) Control System

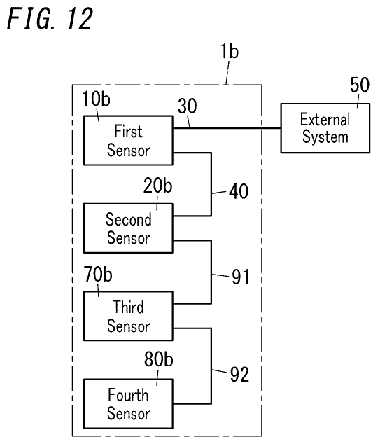

FIG. 12 is a block diagram illustrating a logical configuration for a control system 1b according to the third embodiment. The control system 1b according to the third embodiment includes a first sensor 10b, a second sensor 20b, a third sensor 70b, a fourth sensor 80b, the first signal path 30, the second signal path 40, a third signal path 91, and a fourth signal path 92. In this control system 1b, one terminal of the first signal path 30 is connected to the external system 50.

Each of the first sensor 10b, the second sensor 20b, the third sensor 70b, and the fourth sensor 80b is a hexaxial inertial sensor for measuring angular velocity around each of three detection axes which are perpendicular to each other and acceleration along each of the three detection axes. Each of the first sensor 10b, the second sensor 20b, the third sensor 70b, and the fourth sensor 80b has the function of correcting, based on the angular velocity and acceleration values provided by the other three inertial sensors, the angular velocity and acceleration to be provided by the sensor itself.

The first signal path 30 is a communication route between the first sensor 10b and the external system 50. The first signal path 30 may be, for example, a linear bus compliant with the CAN standard. The first sensor 10b outputs, through the first signal path 30, the corrected angular velocity and acceleration to the external system 50. In addition, the first sensor 10b also outputs, through the first signal path 30, the angular velocity and acceleration provided by each of the second sensor 20b, the third sensor 70b, and the fourth sensor 80b to the external system 50.

The second signal path 40 is a communication route between the first sensor 10b and the second sensor 20b. The second signal path 40 may be, for example, a linear bus compliant with the CAN standard. The first sensor 10b outputs, through the second signal path 40, angular velocity and acceleration that have not been corrected yet to the second sensor 20b, the third sensor 70b, and the fourth sensor 80b. Meanwhile, the second sensor 20b outputs, through the second signal path 40, the angular velocity and acceleration that have not been corrected yet and the corrected angular velocity and acceleration for each of the second sensor 20b, the third sensor 70b, and the fourth sensor 80b, to the first sensor 10b.

The third signal path 91 is a communication route between the second sensor 20b and the third sensor 70b. The third signal path 91 may be, for example, a linear bus compliant with the CAN standard. The second sensor 20b outputs, through the third signal path 91, angular velocity and acceleration that have not been corrected yet for each of the first sensor 10b and the second sensor 20b, to the third sensor 70b and the fourth sensor 80b. Meanwhile, the third sensor 70b outputs, through the third signal path 91, the angular velocity and acceleration that have not been corrected yet and the corrected angular velocity and acceleration for each of the third sensor 70b and the fourth sensor 80b, to the second sensor 20b.

The fourth signal path 92 is a communication route between the third sensor 70b and the fourth sensor 80b. The fourth signal path 92 may be, for example, a linear bus compliant with the CAN standard. The third sensor 70b outputs, through the fourth signal path 92, angular velocity and acceleration that have not been corrected yet for each of the first sensor 10b, the second sensor 20b, and the third sensor 70b, to the fourth sensor 80b. Meanwhile, the fourth sensor 80b outputs, through the fourth signal path 92, the angular velocity and acceleration that have not been corrected yet and the corrected angular velocity and acceleration for the fourth sensor 80b, to the third sensor 70b.

The third sensor 70b is mounted on a third moving part, which may be actuated with respect to the second moving part 62, of the control target 60 (refer to FIG. 2). The fourth sensor 80b is mounted on a fourth moving part, which may be actuated with respect to the third moving part, of the control target 60. For example, if the control target is a hydraulic excavator, the first moving part is its vehicle body, and the second moving part is its boom, then the third moving part is its arm and the fourth moving part is its bucket.

### (2) Inertial Sensor

The first sensor 10b includes angular velocity detection elements 11, of which the detection axes are x1, y1, and z1 axes that are perpendicular to each other, and acceleration detection elements 12, of which the detection axes are x1, y1, and z1 axes. The first sensor 10b generates a first angular velocity signal ω1, including, as its components, an x1-axis angular velocity signal ωx1, a y1-axis angular velocity signal ωy1, and a z1-axis angular velocity signal ωz1. In addition, the first sensor 10b also generates a first acceleration signal A1, including as its components, an x1-axis acceleration signal Ax1, a y1-axis acceleration signal Ay1, and a z1-axis acceleration signal Az1. The first sensor 10b further generates an orientation signal Q1 based on the first angular velocity signal ω1 and the first acceleration signal A1.

The second sensor 20b includes angular velocity detection elements 11, of which the detection axes are x2, y2, and z2 axes that are perpendicular to each other, and acceleration detection elements 12, of which the detection axes are x2, y2, and z2 axes. The second sensor 20b generates a second angular velocity signal ω2, including, as its components, an x2-axis angular velocity signal ωx2, a y2-axis angular velocity signal ωy2, and a z2-axis angular velocity signal ωz2. In addition, the second sensor 20b also generates a second acceleration signal A2, including as its components, an x2-axis acceleration signal Ax2, a y2-axis acceleration signal Ay2, and a z2-axis acceleration signal Az2. The second sensor 20b further generates an orientation signal Q2 based on the second angular velocity signal ω2 and the second acceleration signal A2.

The third sensor 70b includes angular velocity detection elements 11, of which the detection axes are x3, y3, and z3 axes that are perpendicular to each other, and acceleration detection elements 12, of which the detection axes are x3, y3, and z3 axes. The third sensor 70b generates a third angular velocity signal ω3 (not shown), including, as its components, an x3-axis angular velocity signal ωx3, a y3-axis angular velocity signal ωy3, and a z3-axis angular velocity signal ωz3. In addition, the third sensor 70b also generates a third acceleration signal A3 (not shown), including as its components, an x3-axis acceleration signal Ax3, a y3-axis acceleration signal Ay3, and a z3-axis acceleration signal Az3. The third sensor 70b further generates an orientation signal Q3 (not shown) based on the third angular velocity signal ω3 and the third acceleration signal A3.

The fourth sensor 80b includes angular velocity detection elements 11, of which the detection axes are x4, y4, and z4 axes that are perpendicular to each other, and acceleration detection elements 12, of which the detection axes are x4, y4, and z4 axes. The fourth sensor 80b generates a fourth angular velocity signal ω4 (not shown), including, as its components, an x4-axis angular velocity signal ωx4, a y4-axis angular velocity signal ωy4, and a z4-axis angular velocity signal ωz4. In addition, the fourth sensor 80b also generates a fourth acceleration signal A4 (not shown), including as its components, an x4-axis acceleration signal Ax4, a y4-axis acceleration signal Ay4, and a z4-axis acceleration signal Az4. The fourth sensor 80b further generates an orientation signal Q4 (not shown) based on the fourth angular velocity signal ω4 and the fourth acceleration signal A4.

### (3) Correction to Angular Velocity and Acceleration

Next, it will be described how the first sensor 10b, the second sensor 20b, the third sensor 70b, and the fourth sensor 80b (hereinafter collectively referred to as “inertial sensors” if there is no need to distinguish these sensors from each other) make correction to angular velocity and acceleration.

### (3.1) Acquisition of Data and Generation of Reference Signal

Each of these inertial sensors acquires a combination of an angular velocity signal, an acceleration signal, and an orientation signal from each of the other inertial sensors. Then, each inertial sensor generates, based on its own orientation signal and the orientation signals provided by the other inertial sensors, detection axis information indicating a relationship between its own detection axis and the detection axes of the other inertial sensors. Each inertial sensor converts, in accordance with the detection axis information, the angular velocity signals and acceleration signals provided by the other inertial sensors into a reference signal expressed by a coordinate system based on its own detection axis.

Next, the first sensor 10b will be described in further detail.

The first sensor 10b acquires the second angular velocity signal ω2, the second acceleration signal A2, and the orientation signal Q2 from the second sensor 20b. Then, the first sensor 10b calculates detection axis information based on the orientation signal Q1 and the orientation signal Q2 and converts the second angular velocity signal ω2 and the second acceleration signal A2 into a reference signal R12 (not shown) expressed by a coordinate system based on the x1, y1, and z1 axes.

The first sensor 10b acquires the third angular velocity signal ω3, the third acceleration signal A3, and the orientation signal Q3 from the third sensor 70b. Then, the first sensor 10b calculates detection axis information based on the orientation signal Q1 and the orientation signal Q3 and converts the third angular velocity signal ω3 and the third acceleration signal A3 into a reference signal R13 (not shown) expressed by the coordinate system based on the x1, y1, and z1 axes.

The first sensor 10b acquires the fourth angular velocity signal ω4, the fourth acceleration signal A4, and the orientation signal Q4 from the fourth sensor 80b. Then, the first sensor 10b calculates detection axis information based on the orientation signal Q1 and the orientation signal Q4 and converts the fourth angular velocity signal ω4 and the fourth acceleration signal A4 into a reference signal R14 (not shown) expressed by the coordinate system based on the x1, y1, and z1 axes.

The first sensor 10b corrects, based on the reference signals R12, R13, and R14, the respective components of the first angular velocity signal ω1 and the first acceleration signal A1.

The same statement applies to the second sensor 20b, the third sensor 70b, and the fourth sensor 80b as well. The second sensor 20b acquires the first angular velocity signal ω1, the first acceleration signal A1, and the orientation signal Q1 from the first sensor 10b. Then, the second sensor 20b converts the first angular velocity signal ω1 and the first acceleration signal A1 to generate a reference signal. In the same way, the second sensor 20b acquires the third angular velocity signal ω3, the third acceleration signal A3, and the orientation signal Q3 from the third sensor 70b. Then, the second sensor 20b converts the third angular velocity signal ω3 and the third acceleration signal A3 to generate a reference signal. In the same way, the second sensor 20b acquires the fourth angular velocity signal ω4, the fourth acceleration signal A4, and the orientation signal Q4 from the fourth sensor 80b. Then, the second sensor 20b converts the fourth angular velocity signal ω4 and the fourth acceleration signal A4 to generate a reference signal.

In the same way, the third sensor 70b acquires the first angular velocity signal ω1, the first acceleration signal A1, and the orientation signal Q1 from the first sensor 10b. Then, the third sensor 70b converts the first angular velocity signal ω1 and the first acceleration signal A1 to generate a reference signal. In the same way, the third sensor 70b acquires the second angular velocity signal ω2, the second acceleration signal A2, and the orientation signal Q2 from the second sensor 20b. Then, the third sensor 70b converts the second angular velocity signal ω2 and the second acceleration signal A2 to generate a reference signal. In the same way, the third sensor 70b acquires the fourth angular velocity signal ω4, the fourth acceleration signal A4, and the orientation signal Q4 from the fourth sensor 80b. Then, the third sensor 70b converts the fourth angular velocity signal ω4 and the fourth acceleration signal A4 to generate a reference signal.

In the same way, the fourth sensor 80b acquires the first angular velocity signal ω1, the first acceleration signal A1, and the orientation signal Q1 from the first sensor 10b. Then, the fourth sensor 80b converts the first angular velocity signal ω1 and the first acceleration signal A1 to generate a reference signal. In the same way, the fourth sensor 80b acquires the second angular velocity signal ω2, the second acceleration signal A2, and the orientation signal Q2 from the second sensor 20b. Then, the fourth sensor 80b converts the second angular velocity signal ω2 and the second acceleration signal A2 to generate a reference signal. In the same way, the fourth sensor 80b acquires the third angular velocity signal ω3, the third acceleration signal A3, and the orientation signal Q3 from the third sensor 70b. Then, the fourth sensor 80b converts the third angular velocity signal ω3 and the third acceleration signal A3 to generate a reference signal.

### (3.2) Weighting at the Time of Correction

Each of the inertial sensors corrects, using the reference signal based on the angular velocity signal and acceleration signal acquired from each of the other inertial sensors, the angular velocity signals and acceleration signals acquired from its own angular velocity detection elements 11 and acceleration detection elements 12. More specifically, each of the inertial sensors calculates, with respect to each component of the angular velocity signals and acceleration signals, the weighted average of a signal provided by one of its own angular velocity detection elements 11 or acceleration detection elements 12 and a component included in the reference signal based on the angular velocity signal or acceleration signal provided by one of the other inertial sensors.

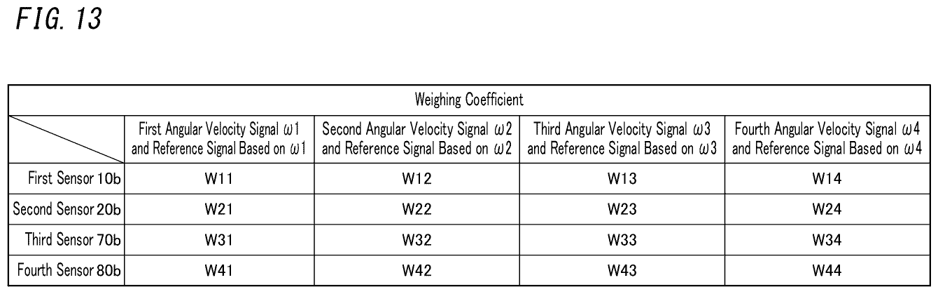

Next, it will be described in detail how the first sensor 10b corrects the x1-axis angular velocity signal. The first sensor 10b calculates an x1-axis angular velocity correction signal ωcx1 as a weighted average of the x1-axis angular velocity signal ωx1, the x1-axis component of the reference signal based on the second angular velocity signal ω2, the x1-axis component of the reference signal based on the third angular velocity signal ω3, and the x1-axis component of the reference signal based on the fourth angular velocity signal ω4. In this case, as shown in FIG. 13, weighing coefficients for the x1-axis angular velocity signal ωx1, the x1-axis component of the reference signal based on the second angular velocity signal ω2, the x1-axis component of the reference signal based on the third angular velocity signal ω3, and the x1-axis component of the reference signal based on the fourth angular velocity signal ω4 will be herein designated by W11, W12, W13, and W14, respectively, where each of these weighing coefficients W11, W12, W13, and W14 is a value equal to or greater than 0 and equal to or less than 1. Also, the sum of these weighing coefficients W11, W12, W13, and W14 is equal to 1.

The first sensor 10b may set the weighing coefficients such that W11≥W12≥W13≥ W14 is satisfied, for example. In that case, if the control target is a hydraulic excavator, the first moving part is its vehicle body, the second moving part is its boom, the third moving part is its arm, and the fourth moving part is its bucket, for example, the closer to the vehicle body one inertial sensor is, the heavier the weight added to the inertial sensor is. This allows a value suitable for controlling the vehicle body to be output.

The second sensor 20b may also correct the x2-axis angular velocity signal in the same way. The second sensor 20b calculates an x2-axis angular velocity correction signal ωcx2 as a weighted average of the x2-axis angular velocity signal ωx2, the x2-axis component of the reference signal based on the first angular velocity signal ω1, the x2-axis component of the reference signal based on the third angular velocity signal ω3, and the x2-axis component of the reference signal based on the fourth angular velocity signal ω4. In this case, as shown in FIG. 13, weighing coefficients for the x2-axis component of the reference signal based on the first angular velocity signal ω1, the x2-axis angular velocity signal ωx2, the x2-axis component of the reference signal based on the third angular velocity signal ω3, and the x2-axis component of the reference signal based on the fourth angular velocity signal ω4 will be herein designated by W21, W22, W23, and W24, respectively, where each of these weighing coefficients W21, W22, W23, and W24 is a value equal to or greater than 0 and equal to or less than 1. Also, the sum of these weighing coefficients W21, W22, W23, and W24 is equal to 1.

The second sensor 20b may set the weighing coefficients such that W22≥W21≥W23≥ W24 is satisfied, for example. In that case, the more distant from the second sensor 20b one inertial sensor is, the lighter the weight added to the inertial sensor is. In other words, the closer to the second sensor 20b one inertial sensor is, the heavier the weight added to the inertial sensor is. Consequently, the error may be reduced. Also, if the control target is a hydraulic excavator, the first moving part is its vehicle body, the second moving part is its boom, the third moving part is its arm, and the fourth moving part is its bucket, for example, the closer to the vehicle body one inertial sensor is, the heavier the weight added to the inertial sensor is. This allows a value suitable for controlling the vehicle body to be output.

The third sensor 70b may also correct the x3-axis angular velocity signal in the same way. The third sensor 70b calculates an x3-axis angular velocity correction signal ωcx3 as a weighted average of the x3-axis angular velocity signal ωx3, the x3-axis component of the reference signal based on the first angular velocity signal ω1, the x3-axis component of the reference signal based on the second angular velocity signal ω2, and the x3-axis component of the reference signal based on the fourth angular velocity signal ω4. In this case, as shown in FIG. 13, weighing coefficients for the x3-axis component of the reference signal based on the first angular velocity signal ω1, the x3-axis component of the reference signal based on the second angular velocity signal ω2, the x3-axis angular velocity signal ωx3, and the x3-axis component of the reference signal based on the fourth angular velocity signal ω4 will be herein designated by W31, W32, W33, and W34, respectively, where each of these weighing coefficients W31, W32, W33, and W34 is a value equal to or greater than 0 and equal to or less than 1. Also, the sum of these weighing coefficients W31, W32, W33, and W34 is equal to 1.

The third sensor 70b may set the weighing coefficients such that W33≥W34≥W32≥W31 is satisfied, for example. In that case, the more distant from the third sensor 70b one inertial sensor is, the lighter the weight added to the inertial sensor is. In other words, the closer to the second sensor 20b one inertial sensor is, the heavier the weight added to the inertial sensor is. Consequently, the error may be reduced. Also, if the control target is a hydraulic excavator, the first moving part is its vehicle body, the second moving part is its boom, the third moving part is its arm, and the fourth moving part is its bucket, for example, the closer to the arm or the bucket one inertial sensor is, the heavier the weight added to the inertial sensor is. This allows a value suitable for controlling the arm or the bucket to be output.

The fourth sensor 80b may also correct the x4-axis angular velocity signal in the same way. The fourth sensor 80b calculates an x4-axis angular velocity correction signal ωcx4 as a weighted average of the x4-axis angular velocity signal ωx4, the x4-axis component of the reference signal based on the first angular velocity signal ω1, the x4-axis component of the reference signal based on the second angular velocity signal ω2, and the x4-axis component of the reference signal based on the third angular velocity signal ω3. In this case, as shown in FIG. 13, weighing coefficients for the x4-axis component of the reference signal based on the first angular velocity signal ω1, the x4-axis component of the reference signal based on the second angular velocity signal ω2, the x4-axis component of the reference signal based on the third angular velocity signal ω3, and the x4-axis angular velocity signal ωx4 will be herein designated by W41, W42, W43, and W44, respectively, where each of these weighing coefficients W41, W42, W43, and W44 is a value equal to or greater than 0 and equal to or less than 1. Also, the sum of these weighing coefficients W41, W42, W43, and W44 is equal to 1.

The fourth sensor 80b may set the weighing coefficients such that W44≥W43≥W42≥ W41 is satisfied, for example. In that case, the more distant from the fourth sensor 80b one inertial sensor is, the lighter the weight added to the inertial sensor is. In other words, the closer to the fourth sensor 80b one inertial sensor is, the heavier the weight added to the inertial sensor is. Consequently, the error may be reduced. Also, if the control target is a hydraulic excavator, the first moving part is its vehicle body, the second moving part is its boom, the third moving part is its arm, and the fourth moving part is its bucket, for example, the closer to the bucket one inertial sensor is, the heavier the weight added to the inertial sensor is. This allows a value suitable for controlling the arm or the bucket to be output.

In the foregoing description, it has been described how the first sensor 10b corrects the x1-axis angular velocity signal, the second sensor 20b corrects the x2-axis angular velocity signal, the third sensor 70b corrects the x3-axis angular velocity signal, and the fourth sensor 80b corrects the x4-axis angular velocity signal. Each of the inertial sensors may correct the angular velocity signal around any of the other axes and the acceleration signal along any of the other axes in the same way as described above. Although FIG. 13 shows weighing coefficients on an inertial sensor basis, a single inertial sensor may also use different weighing coefficients for respective components of the angular velocity signal and acceleration signal. For example, in the first sensor 10b, the weighing coefficient used to correct the x1-axis angular velocity signal ωx1 and the weighing coefficient used to correct the y1-axis angular velocity signal ωy1 may be the same as each other or different from each other, whichever is appropriate.

Optionally, each inertial sensor may also correct its own orientation signal using the orientation signal of any other inertial sensor.

### (3.3) Other Exemplary Weighing Coefficients

In the example described above, the weighing coefficient for each inertial sensor is defined such that its own weighing coefficient is maximum and that the closer to the inertial sensor itself another inertial sensor is, the larger the weighing coefficient for the inertial sensor is (i.e., the more distant from the inertial sensor itself another inertial sensor is, the smaller the weighing coefficient for the inertial sensor is). However, the weighing coefficients for the respective inertial sensors do not have to be defined in this manner but may also be defined in the following manner, for example.

For example, the weighing coefficients may also be set such that the fourth sensor 80b satisfies the inequality W44≥W43≥W42≥W41. In this case, if the control target is a hydraulic excavator, the first moving part is its vehicle body, the second moving part is its boom, the third moving part is its arm, and the fourth moving part is its bucket and the hydraulic excavator is used for leveling the ground, for example, then the weighing coefficients are set to widen the difference between W44 and W41. This causes an increase in the weighing coefficient for the bucket and a decrease in the weighing coefficient for the vehicle body, thus allowing the fine movement of the bucket to be measured accurately. On the other hand, if the hydraulic excavator is used for demolishing a building or crushing stones, for example, then the weighing coefficients are set to narrow the difference between W44 and W41. This narrows the difference between the weighing coefficient for the bucket and the weighing coefficient for the vehicle body. This may reduce, even if impact is applied to the bucket, the effect of the impact on the corrected angular velocity signal and corrected acceleration signal of the fourth sensor 80b.

Optionally, the fourth sensor 80b may change the values of the weighing coefficients W41-W44 according to the intended use of the control target. For example, the fourth sensor 80b may receive, from the external system 50, a signal indicating the intended use of the control target and select a list of weighing coefficients, which is suitable to the intended use, from multiple lists of weighing coefficients stored in advance and apply the list of weighing coefficients thus selected. The external system 50 accepts information, specifying the intended use of the control target, from a user who is operating the control target, for example.

Alternatively, if the control target is a hydraulic excavator, the first moving part is its vehicle body, the second moving part is its boom, the third moving part is its arm, and the fourth moving part is its bucket, for example, each inertial sensor may make correction using the angular velocity signal and acceleration signal provided by another inertial sensor which is located closer to the vehicle body than the inertial sensor itself is. In that case, the first sensor 10b may make no correction, the second sensor 20b may make correction using the angular velocity signal and acceleration signal provided by the first sensor 10b, and the third sensor 70b may make correction using the angular velocity signals and acceleration signals provided by the first sensor 10b and the second sensor 20b, for example. In such a situation, each inertial sensor sets the weighing coefficient at 0 for another inertial sensor located closer to the bucket than the inertial sensor itself is. This may reduce the chances of causing a decline in the accuracy of the inertial sensor located closer to the vehicle body due to the actuation of respective moving parts.

### (4) Advantages

In the control system 1b according to the third embodiment, each of the first sensor 10b, the second sensor 20b, the third sensor 70b, and the fourth sensor 80b corrects, based on the angular velocity signal, the acceleration signal, and the orientation signal provided by any of the other inertial sensors, the angular velocity signal and the acceleration signal. This enables improving the measurement accuracy of the corrected angular velocity signal and corrected acceleration signal provided by each inertial sensor.

In addition, in the control system 1b according to the third embodiment, each inertial sensor makes correction using a weighted average of components of a reference signal based on the angular velocity signals and acceleration signals provided by the other inertial sensors and signals provided by its own angular velocity detection elements 11 and acceleration detection elements 12. Furthermore, each inertial sensor sets the weighing coefficients for respective components of the angular velocity or acceleration and on an inertial sensor basis while adding weights to calculate the weighted average. This allows each inertial sensor to correct the angular velocity signal or the acceleration signal in a mode suitable to either its installation location or usage.

### Other Variations of Embodiments

(1) In the first and second embodiments and their variations described above, the control target is a hydraulic excavator, the first moving part is its boom, and the second moving part is its arm. Also, in the third embodiment described above, the control target is a hydraulic excavator, the first moving part is its vehicle body, the second moving part is its boom, the third moving part is its arm, and the fourth moving part is its bucket. However, these control targets and moving parts are only examples and should not be construed as limiting.

Alternatively, the control target may also be a bulldozer, the first moving part may be its vehicle body, and the second moving part may be its boom, for example. In that case, the first sensor sets the weighing coefficients of angular velocity and acceleration for the first sensor at values larger than the weighing coefficient for the reference signal based on the angular velocity and acceleration of the second sensor. This allows data suitable for controlling the vehicle body to be obtained from the first sensor. In addition, the second sensor sets the weighing coefficients of angular velocity and acceleration for the second sensor at values larger than the weighing coefficient for the reference signal based on the angular velocity and acceleration of the first sensor. This allows data suitable for controlling the boom to be obtained from the second sensor.

Note that the control target does not have to be a construction machine but may also be, for example, the arm of an industrial robot for use in an assembling factory.

(2) In the first and second embodiments and their variations described above, the control system 1 or 1a includes two inertial sensors. The control system 1b according to the third embodiment includes four inertial sensors. However, the number of the inertial sensors provided does not have to be two or four but may also be three or five or more.

(3) In the first to third embodiments and their variations, the signal converter 142 generates the reference signal R1 and the reference orientation signal Qi2. Alternatively, the signal converter 142 may generate only some components of the reference signal R1 and the reference orientation signal Qi2 which are required for the signal corrector 143 and the orientation corrector 144. For example, if the z1-axis acceleration signal is not to be corrected, then the signal converter 142 does not have to include the z1-axis acceleration component Aiz1. Also, if the orientation signal Q1 is not to be corrected, for example, then the signal converter 142 does not have to generate the reference orientation signal Qi2.

(4) In the first and second embodiments and their variations, each of the inertial sensors includes three angular velocity detection elements 11, of which the detection axes are perpendicular to each other, and three acceleration detection elements 12, of which the detection axes are perpendicular to each other. Optionally, the inertial sensor may include not only the three angular velocity detection elements 11, of which the detection axes are perpendicular to each other, but also another angular velocity detection element 11, of which the detection axis is the same as that of any of the three angular velocity detection elements 11. In that case, if the inertial sensor includes two angular velocity detection elements 11 for detecting the angular velocity around the x1 axis, for example, then the inertial sensor calculates the average of the respective outputs of the two angular velocity detection elements 11 for detecting the angular velocity around the x1 axis to acquire the average thus calculated as an angular velocity signal around the x1 axis. Likewise, the inertial sensor may include not only the three acceleration detection elements 12, of which the detection axes are perpendicular to each other, but also another acceleration detection element 12, of which the detection axis is the same as that of any of the three acceleration detection elements 12.

Alternatively, the inertial sensor may include, instead of the three angular velocity detection elements 11, of which the detection axes are perpendicular to each other, a single angular velocity detection element for detecting respective angular velocities around three detection axes that are perpendicular to each other, for example. Note that the above-described combination of the angular velocity detection elements and acceleration detection elements is only an example and should not be construed as limiting. Rather, any other combination of angular velocity detection elements and acceleration detection elements may also be adopted as long as the combination of detection elements may detect angular velocities around three detection axes that are perpendicular to each other and accelerations along the three detection axes.

(5) In the first to third embodiments and their variations described above, the control unit 13, 13a of the first sensor 10, 10a, 10b generates the corrected orientation signal Qc1 by correcting the orientation signal Q1. Alternatively, the first sensor 10, 10a, 10b may output the orientation signal Q1 as it is without correcting the orientation signal Q1. In that case, the control unit 13 does not have to include the orientation corrector 144, for example. In addition, the signal converter 142 does not have to generate the reference orientation signal Qi2.

(6) In the first to third embodiments and their variations, the control system 1 includes the first signal path 30 and the second signal path 40 as linear buses compliant with the CAN standard. Also, the second sensor 20 outputs the second angular velocity signal ω2, the second acceleration signal A2, and the orientation signal Q2 to the external system 50 via the first sensor 10. However, this is only an example and should not be construed as limiting. Alternatively, the second sensor 20 may include, for example, a communications interface which may directly communicate with the external system 50. The first signal path 30 and the second signal path 40 may also be other wired communication signal paths or wireless signal paths, whichever is appropriate.

### (Recapitulation)

A control system (1; 1a; 1b) according to a first aspect includes a first inertial sensor (10; 10a; 10b), a second inertial sensor (20; 20a; 20b), a first signal path (30), and a second signal path (40). The first inertial sensor (10; 10a; 10b) is disposed in a first moving part (61). The second inertial sensor (20; 20a; 20b) is disposed in a second moving part (62). The second moving part (62) is ready to be actuated with respect to the first moving part (61). The first signal path (30) connects the first inertial sensor (10; 10a; 10b) to an external system (50). The second signal path (40) connects the second inertial sensor (20; 20a; 20b) to the first inertial sensor (10; 10a; 10b). The first inertial sensor (10; 10a; 10b) includes a first angular velocity detection element (111), a second angular velocity detection element (112), a third angular velocity detection element (113), a first acceleration detection element (121), a second acceleration detection element (122), a third acceleration detection element (123), and a first control unit (13; 13a). The first angular velocity detection element (111) detects angular velocity around a first detection axis to output a first angular velocity signal (ωx1). The second angular velocity detection element (112) detects angular velocity around a second detection axis to output a second angular velocity signal (ωy1). The third angular velocity detection element (113) detects angular velocity around a third detection axis to output a third angular velocity signal (ωz1). The first acceleration detection element (121) detects acceleration in a direction along the first detection axis to output a first acceleration signal (Ax1). The second acceleration detection element (122) detects acceleration in a direction along the second detection axis to output a second acceleration signal (Ay1). The third acceleration detection element (123) detects acceleration in a direction along the third detection axis to output a third acceleration signal (Az1). The first control unit (13; 13a) calculates a first orientation signal (Q1) based on the first angular velocity signal (ωx1), the second angular velocity signal (ωy1), the third angular velocity signal (ωz1), the first acceleration signal (Ax1), the second acceleration signal (Ay1), and the third acceleration signal (Az1). The first detection axis, the second detection axis, and the third detection axis are perpendicular to each other. The second inertial sensor (20; 20a; 20b) includes a fourth angular velocity detection element (114), a fifth angular velocity detection element (115), a sixth angular velocity detection element (116), a fourth acceleration detection element (124), a fifth acceleration detection element (125), a sixth acceleration detection element (126), and a second control unit (23; 23a). The fourth angular velocity detection element (114) detects angular velocity around a fourth detection axis to output a fourth angular velocity signal (ωx2). The fifth angular velocity detection element (115) detects angular velocity around a fifth detection axis to output a fifth angular velocity signal (ωy2). The sixth angular velocity detection element (116) detects angular velocity around a sixth detection axis to output a sixth angular velocity signal (ωz2). The fourth acceleration detection element (124) detects acceleration in a direction along the fourth detection axis to output a fourth acceleration signal (Ax2). The fifth acceleration detection element (125) detects acceleration in a direction along the fifth detection axis to output a fifth acceleration signal (Ay2). The sixth acceleration detection element (126) detects acceleration in a direction along the sixth detection axis to output a sixth acceleration signal (Az2). The second control unit (23; 23a) calculates a second orientation signal (Q2) based on the fourth angular velocity signal (ωx2), the fifth angular velocity signal (ωy2), the sixth angular velocity signal (ωz2), the fourth acceleration signal (Ax2), the fifth acceleration signal (Ay2), and the sixth acceleration signal (Az2). The fourth detection axis, the fifth detection axis, and the sixth detection axis are perpendicular to each other. The first control unit (13; 13a) calculates first detection axis information (D1) based on the first orientation signal (Q1) and the second orientation signal (Q2). The first detection axis information (D1) indicates a relationship between the first detection axis, the second detection axis, and the third detection axis and the fourth detection axis, the fifth detection axis, and the sixth detection axis. The first control unit (13; 13a) further generates a first reference signal (R2) in accordance with the first detection axis information (D1) and based on at least one signal selected from the group consisting of the fourth angular velocity signal (ωx2), the fifth angular velocity signal (ωy2), the sixth angular velocity signal (ωz2), the fourth acceleration signal (Ax2), the fifth acceleration signal (Ay2), and the sixth acceleration signal (Az2). The first control unit (13; 13a) further generates a first corrected signal (Sc1) by correcting, using the first reference signal (R2), at least one signal selected from the group consisting of the first angular velocity signal (ωx1), the second angular velocity signal (ωy1), the third angular velocity signal (ωz1), the first acceleration signal (Ax1), the second acceleration signal (Ay1), and the third acceleration signal (Az1). The first control unit (13; 13a) further outputs the first corrected signal (Sc1) to the external system (50).

In the control system (1; 1a; 1b) according to this aspect, the first inertial sensor (10; 10a; 10b) corrects, based on the fourth angular velocity signal (ωx2), the fifth angular velocity signal (ωy2), the sixth angular velocity signal (ωz2), the fourth acceleration signal (Ax2), the fifth acceleration signal (Ay2), and the sixth acceleration signal (Az2) which are provided by the second inertial sensor (20; 20a; 20b), at least one of the first angular velocity signal (ωx1), the second angular velocity signal (ωy1), the third angular velocity signal (ωz1), the first acceleration signal (Ax1), the second acceleration signal (Ay1), or the third acceleration signal (Az1). This allows the measurement accuracy of the first corrected signal (Sc1) provided by the first inertial sensor (10; 10a; 10b) to be improved based on the output of the second inertial sensor (20; 20a; 20b). In addition, the first inertial sensor (10; 10a; 10b) calculates first detection axis information (D1) based on the first orientation signal (Q1) and the second orientation signal (Q2). The first detection axis information (D1) indicates a relationship between the first detection axis, the second detection axis, and the third detection axis and the fourth detection axis, the fifth detection axis, and the sixth detection axis. Then, the first inertial sensor (10; 10a; 10b) further generates a first reference signal (R2) in accordance with the first detection axis information (D1) and based on the fourth angular velocity signal (ωx2), the fifth angular velocity signal (ωy2), the sixth angular velocity signal (ωz2), the fourth acceleration signal (Ax2), the fifth acceleration signal (Ay2), and the sixth acceleration signal (Az2). This allows correction to be made even if the fourth detection axis, the fifth detection axis, and the sixth detection axis are not aligned with the first detection axis, the second detection axis, and the third detection axis, respectively. Consequently, this enables improving the measurement accuracy of the first corrected signal (Sc1) provided by the first inertial sensor (10; 10a; 10b) without depending on the relation between the first inertial sensor (10; 10a; 10b) and the second inertial sensor (20; 20a; 20b).

In a control system (1; 1a; 1b) according to a second aspect, which may be implemented in conjunction with the first aspect, the first corrected signal (Sc1) includes a signal representing each of the angular velocity around the first detection axis, the angular velocity around the second detection axis, the angular velocity around the third detection axis, the acceleration along the first detection axis, the acceleration along the second detection axis, and the acceleration along the third detection axis. The first corrected signal (Sc1) includes at least one signal selected from the group consisting of the first angular velocity signal (ωx1), the second angular velocity signal (ωy1), the third angular velocity signal (ωz1), the first acceleration signal (Ax1), the second acceleration signal (Ay1), and the third acceleration signal (Az1).

In the control system (1; 1a; 1b) according to this aspect, the first corrected signal (Sc1) includes at least one signal selected from the group consisting of the first angular velocity signal (ωx1), the second angular velocity signal (ωy1), the third angular velocity signal (ωz1), the first acceleration signal (Ax1), the second acceleration signal (Ay1), and the third acceleration signal (Az1). In addition, the first corrected signal (Sc1) also includes a signal generated by correcting, using the first reference signal (R2), at least one signal selected from the group consisting of the first angular velocity signal (ωx1), the second angular velocity signal (ωy1), the third angular velocity signal (ωz1), the first acceleration signal (Ax1), the second acceleration signal (Ay1), and the third acceleration signal (Az1). Consequently, this enables selectively correcting any of the angular velocity around the first detection axis, the angular velocity around the second detection axis, the angular velocity around the third detection axis, the acceleration along the first detection axis, the acceleration along the second detection axis, or the acceleration along the third detection axis which may contribute to improving the measurement accuracy by being corrected using the first reference signal (R2).

In a control system (1; 1a; 1b) according to a third aspect, which may be implemented in conjunction with the first aspect, the first corrected signal (Sc1) includes a signal generated by correcting, using the first reference signal (R2), each of the first angular velocity signal (ωx1), the second angular velocity signal (ωy1), the third angular velocity signal (ωz1), the first acceleration signal (Ax1), the second acceleration signal (Ay1), and the third acceleration signal (Az1).

The control system (1; 1a; 1b) according to this aspect allows all of the angular velocity around the first detection axis, the angular velocity around the second detection axis, the angular velocity around the third detection axis, the acceleration along the first detection axis, the acceleration along the second detection axis, and the acceleration along the third detection axis to be corrected in the first corrected signal (Sc1) using the first reference signal (R2). This contributes to improving the measurement accuracy by correction with respect to all components of the first corrected signal (Sc1).

In a control system (1; 1a; 1b) according to a fourth aspect, which may be implemented in conjunction with any one of the first to third aspects, the first reference signal (R2) includes at least one component selected from the group consisting of a first angular velocity component (ωix1), a second angular velocity component (ωiy1), a third angular velocity component (ωiz1), a first acceleration component (Aix1), a second acceleration component (Aiy1), and a third acceleration component (Aiz1). The first angular velocity component (ωix1) represents the angular velocity around the first detection axis which is included in a combination of the fourth angular velocity signal (ωx2), the fifth angular velocity signal (ωy2), and the sixth angular velocity signal (ωz2). The second angular velocity component (ωiy1) represents the angular velocity around the second detection axis which is included in the combination of the fourth angular velocity signal (ωx2), the fifth angular velocity signal (ωy2), and the sixth angular velocity signal (ωz2). The third angular velocity component (ωiz1) represents the angular velocity around the third detection axis which is included in the combination of the fourth angular velocity signal (ωx2), the fifth angular velocity signal (ωy2), and the sixth angular velocity signal (ωz2). The first acceleration component (Aix1) represents the acceleration in the direction along the first detection axis which is included in a combination of the fourth acceleration signal (Ax2), the fifth acceleration signal (Ay2), and the sixth acceleration signal (Az2). The second acceleration component (Aiy1) represents the acceleration in the direction along the second detection axis which is included in the combination of the fourth acceleration signal (Ax2), the fifth acceleration signal (Ay2), and the sixth acceleration signal (Az2). The third acceleration component (Aiz1) represents the acceleration in the direction along the third detection axis which is included in the combination of the fourth acceleration signal (Ax2), the fifth acceleration signal (Ay2), and the sixth acceleration signal (Az2).

In the control system (1; 1a; 1b) according to this aspect, the first reference signal (R2) includes angular velocity around the x1 axis, angular velocity around the y1 axis, or angular velocity around the z1 axis based on the fourth angular velocity signal (ωx2), the fifth angular velocity signal (ωy2), and the sixth angular velocity signal (ωz2). Alternatively, the first reference signal (R2) includes acceleration along the x1 axis, acceleration along the y1 axis, or acceleration along the z1 axis based on the fourth acceleration signal (Ax2), the fifth acceleration signal (Ay2), and the sixth acceleration signal (Az2). This allows the first inertial sensor (10; 10a; 10b) to easily correct at least one signal selected from the group consisting of the first angular velocity signal (ωx1), the second angular velocity signal (ωy1), the third angular velocity signal (ωz1), the first acceleration signal (Ax1), the second acceleration signal (Ay1), and the third acceleration signal (Az1).

In a control system (1; 1a; 1b) according to a fifth aspect, which may be implemented in conjunction with the fourth aspect, the first corrected signal (Sc1) includes at least one signal selected from the group consisting of a first angular velocity correction signal (ωcx1), a second angular velocity correction signal (ωxy1), a third angular velocity correction signal (ωcz1), a first acceleration correction signal (Acx1), a second acceleration correction signal (Acy1), and a third acceleration correction signal (Acz1). The first angular velocity correction signal (ωcx1) is calculated based on the first angular velocity signal (ωx1) and the first angular velocity component (ωix1). The second angular velocity correction signal (ωcy1) is calculated based on the second angular velocity signal (ωy1) and the second angular velocity component (ωiy1). The third angular velocity correction signal (ωcz1) is calculated based on the third angular velocity signal (ωz1) and the third angular velocity component (ωiz1). The first acceleration correction signal (Acx1) is calculated based on the first acceleration signal (Ax1) and the first acceleration component (Aix1). The second acceleration correction signal (Acy1) is calculated based on the second acceleration signal (Ay1) and the second acceleration component (Aiy1). The third acceleration correction signal (Acz1) is calculated based on the third acceleration signal (Az1) and the third acceleration component (Aiz1).

In the control system (1; 1a; 1b) according to this aspect, the first control unit (13; 13a) of the first inertial sensor (10; 10a; 10b) corrects at least one of the first angular velocity signal (ωx1), the second angular velocity signal (ωy1), or the third angular velocity signal (ωz1) using the angular velocity component around its corresponding detection axis included in the first reference signal (R2). Alternatively, the first control unit (13; 13a) of the first inertial sensor (10; 10a; 10b) corrects at least one of the first acceleration signal (Ax1), the second acceleration signal (Ay1), or the third acceleration signal (Az1) using the acceleration component along its corresponding detection axis included in the first reference signal (R2). Consequently, this control system (1; 1a; 1b) may contribute to improving the measurement accuracy of the first corrected signal (Sc1) by a simple method.

In a control system (1; 1a; 1b) according to a sixth aspect, which may be implemented in conjunction with the third aspect, the first reference signal (R2) includes a first angular velocity component (ωix1), a second angular velocity component (ωiy1), a third angular velocity component (ωiz1), a first acceleration component (Aix1), a second acceleration component (Aiy1), and a third acceleration component (Aiz1). The first angular velocity component (ωix1) represents the angular velocity around the first detection axis which is included in a combination of the fourth angular velocity signal (ωx2), the fifth angular velocity signal (ωy2), and the sixth angular velocity signal (ωz2). The second angular velocity component (ωiy1) represents the angular velocity around the second detection axis which is included in the combination of the fourth angular velocity signal (ωx2), the fifth angular velocity signal (ωy2), and the sixth angular velocity signal (ωz2). The third angular velocity component (ωiz1) represents the angular velocity around the third detection axis which is included in the combination of the fourth angular velocity signal (ωx2), the fifth angular velocity signal (ωy2), and the sixth angular velocity signal (ωz2). The first acceleration component (Aix1) represents the acceleration in the direction along the first detection axis which is included in a combination of the fourth acceleration signal (Ax2), the fifth acceleration signal (Ay2), and the sixth acceleration signal (Az2). The second acceleration component (Aiy1) represents the acceleration in the direction along the second detection axis which is included in the combination of the fourth acceleration signal (Ax2), the fifth acceleration signal (Ay2), and the sixth acceleration signal (Az2). The third acceleration component (Aiz1) represents the acceleration in the direction along the third detection axis which is included in the combination of the fourth acceleration signal (Ax2), the fifth acceleration signal (Ay2), and the sixth acceleration signal (Az2). The first corrected signal (Sc1) includes a first angular velocity correction signal (ωcx1), a second angular velocity correction signal (ωcy1), a third angular velocity correction signal (ωcz1), a first acceleration correction signal (Acx1), a second acceleration correction signal (Acy1), and a third acceleration correction signal (Acz1). The first angular velocity correction signal (ωcx1) is a weighted average of the first angular velocity component (ωix1) and the first angular velocity signal (ωx1). The second angular velocity correction signal (ωcy1) is a weighted average of the second angular velocity component (ωiy1) and the second angular velocity signal (ωy1). The third angular velocity correction signal (ωcz1) is a weighted average of the third angular velocity component (ωiz1) and the third angular velocity signal (ωz1). The first acceleration correction signal (Acx1) is a weighted average of the first acceleration component (Aix1) and the first acceleration signal (Ax1). The second acceleration correction signal (Acy1) is a weighted average of the second acceleration component (Aiy1) and the second acceleration signal (Ay1). The third acceleration correction signal (Acz1) is a weighted average of the third acceleration component (Aiz1) and the third acceleration signal (Az1). A weighing coefficient for the first angular velocity signal (ωx1) is different from at least one weighing coefficient selected from the group consisting of: a weighing coefficient for the second angular velocity signal (ωy1); a weighing coefficient for the third angular velocity signal (ωz1); a weighing coefficient for the first acceleration signal (Ax1); a weighing coefficient for the second acceleration signal (Ay1); and a weighing coefficient for the third acceleration signal (Az1).

The control system (1; 1a; 1b) according to this aspect allows the first inertial sensor (10; 10a; 10b) to change the weighing coefficient for correction according to the detection axis direction of angular velocity and the detection axis direction of acceleration. Thus, the first inertial sensor (10; 10a; 10b) may make correction adaptively to the direction in which the first inertial sensor (10; 10a; 10b) and the second inertial sensor (20; 20a; 20b) are installed.

In a control system (1; 1a; 1b) according to a seventh aspect, which may be implemented in conjunction with any one of the first to sixth aspects, the first orientation signal (Q1) includes a first rotational angle (Qx1) around the first detection axis, a second rotational angle (Qy1) around the second detection axis, and a third rotational angle (Qz1) around the third detection axis. The first control unit (13; 13a) generates a first reference orientation signal (Qi2) in accordance with the first detection axis information (D1) and based on the second orientation signal (Q2). The first control unit (13; 13a) further generates a first orientation correction signal (Qc1) by correcting, using the first reference orientation signal (Qi2), at least one of the first rotational angle (Qx1), the second rotational angle (Qy1), or the third rotational angle (Qz1). The first control unit (13; 13a) further outputs the first orientation correction signal (Qc1) to the external system (50).

The control system (1; 1a; 1b) according to this aspect allows the first inertial sensor (10; 10a; 10b) to correct at least one component of the first orientation signal (Q1) in accordance with the second orientation signal (Q2) provided by the second inertial sensor (20; 20a; 20b). This enables improving the accuracy of the first orientation correction signal (Qc1) provided by the first inertial sensor (10; 10a; 10b) based on the output of the second inertial sensor (20; 20a; 20b).

In a control system (1; 1a; 1b) according to an eighth aspect, which may be implemented in conjunction with the seventh aspect, the first orientation correction signal (Qc1) includes a signal generated by correcting, using the first reference orientation signal (Qi2), each of the first rotational angle (Qx1), the second rotational angle (Qy1), and the third rotational angle (Qz1).

The control system (1; 1a; 1b) according to this aspect allows the first inertial sensor (10; 10a; 10b) to correct all components of the first orientation signal (Q1) based on the second orientation signal (Q2) provided by the second inertial sensor (20; 20a; 20b). This enables improving, based on the output of the second inertial sensor (20; 20a; 20b), the accuracy of the first orientation correction signal (Qc1) provided by the first inertial sensor (10; 10a; 10b).

In a control system (1; 1a; 1b) according to a ninth aspect, which may be implemented in conjunction with the seventh aspect, the first reference orientation signal (Qi2) includes a first angular component (Qix1), a second angular component (Qiy1), and a third angular component (Qiz1). The first angular component (Qix1) is included in the second orientation signal (Q2) and represents a rotational angle around the first detection axis. The second angular component (Qiy1) is also included in the second orientation signal (Q2) and represents a rotational angle around the second detection axis. The third angular component (Qiz1) is also included in the second orientation signal (Q2) and represents a rotational angle around the third detection axis.

The first orientation correction signal (Qc1) includes a first corrected rotational angle (Qcx1), a second corrected rotational angle (Qcy1), and a third corrected rotational angle (Qcz1). The first corrected rotational angle (Qcx1) is a weighted average of the first angular component (Qix1) and the first rotational angle (Qx1). The second corrected rotational angle (Qcy1) is a weighted average of the second angular component (Qiy1) and the second rotational angle (Qy1). The third corrected rotational angle (Qcz1) is a weighted average of the third angular component (Qiz1) and the third rotational angle (Qz1). A weighing coefficient for the first rotational angle (Qx1) is different from at least one of a weighing coefficient for the second rotational angle (Qy1) or a weighing coefficient for the third rotational angle (Qz1).

The control system (1; 1a; 1b) according to this aspect allows the first inertial sensor (10); 10a; 10b) to change the weighing coefficient for correcting the first orientation signal (Q1) according to the detection axis direction of angular velocity and the detection axis direction of acceleration. Thus, the first inertial sensor (10; 10a; 10b) may make correction adaptively to the direction in which the first inertial sensor (10; 10a; 10b) and the second inertial sensor (20; 20a; 20b) are installed.

In a control system (1; 1a; 1b) according to a tenth aspect, which may be implemented in conjunction with the first aspect, the first orientation signal (Q1) includes a first rotational angle (Qx1) around the first detection axis, a second rotational angle (Qy1) around the second detection axis, and a third rotational angle (Qz1) around the third detection axis. The first control unit (13; 13a) generates a first reference orientation signal (Qi2) in accordance with the first detection axis information (D1) and based on the second orientation signal (Q2). The first control unit (13; 13a) further generates a first orientation correction signal (Qc1) by correcting, using the first reference orientation signal (Qi2), the first rotational angle (Qx1), the second rotational angle (Qy1), and the third rotational angle (Qz1). The first control unit (13; 13a) further outputs the first orientation correction signal (Qc1) to the external system (50). The first reference signal (R2) includes a first angular velocity component (ωix1), a second angular velocity component (ωiy1), a third angular velocity component (ωiz1), a first acceleration component (Aix1), a second acceleration component (Aiy1), and a third acceleration component (Aiz1). The first angular velocity component (ωix1) represents the angular velocity around the first detection axis which is included in a combination of the fourth angular velocity signal (ωx2), the fifth angular velocity signal (ωy2), and the sixth angular velocity signal (ωz2). The second angular velocity component (ωiy1) represents the angular velocity around the second detection axis which is included in the combination of the fourth angular velocity signal (ωx2), the fifth angular velocity signal (ωy2), and the sixth angular velocity signal (ωz2). The third angular velocity component (ωiz1) represents the angular velocity around the third detection axis which is included in the combination of the fourth angular velocity signal (ωx2), the fifth angular velocity signal (ωy2), and the sixth angular velocity signal (ωz2). The first acceleration component (Aix1) represents the acceleration in the direction along the first detection axis which is included in a combination of the fourth acceleration signal (Ax2), the fifth acceleration signal (Ay2), and the sixth acceleration signal (Az2). The second acceleration component (Aiy1) represents the acceleration in the direction along the second detection axis which is included in the combination of the fourth acceleration signal (Ax2), the fifth acceleration signal (Ay2), and the sixth acceleration signal (Az2). The third acceleration component (Aiz1) represents the acceleration in the direction along the third detection axis which is included in the combination of the fourth acceleration signal (Ax2), the fifth acceleration signal (Ay2), and the sixth acceleration signal (Az2). The first reference orientation signal (Qi2) includes a first angular component (Qix1), a second angular component (Qiy1), and a third angular component (Qiz1). The first angular component (Qix1) is included in the second orientation signal (Q2) and represents a rotational angle around the first detection axis. The second angular component (Qiy1) is also included in the second orientation signal (Q2) and represents a rotational angle around the second detection axis. The third angular component (Qiz1) is also included in the second orientation signal (Q2) and represents a rotational angle around the third detection axis. The first corrected signal (Sc1) includes a first angular velocity correction signal (ωcx1), a second angular velocity correction signal (ωcy1), a third angular velocity correction signal (ωcz1), a first acceleration correction signal (Acx1), a second acceleration correction signal (Acy1), and a third acceleration correction signal (Acz1). The first angular velocity correction signal (ωcx1) is a weighted average of the first angular velocity component (ωix1) and the first angular velocity signal (ωx1). The second angular velocity correction signal (ωcy1) is a weighted average of the second angular velocity component (ωiy1) and the second angular velocity signal (ωy1). The third angular velocity correction signal (ωcz1) is a weighted average of the third angular velocity component (ωiz1) and the third angular velocity signal (ωz1). The first acceleration correction signal (Acx1) as a weighted average of the first acceleration component (Aix1) and the first acceleration signal (Ax1). The second acceleration correction signal (Acy1) is a weighted average of the second acceleration component (Aiy1) and the second acceleration signal (Ay1). The third acceleration correction signal (Acz1) is a weighted average of the third acceleration component (Aiz1) and the third acceleration signal (Az1). The first orientation correction signal (Qc1) includes a first corrected rotational angle (Qcx1), a second corrected rotational angle (Qcy1), and a third corrected rotational angle (Qcz1). The first corrected rotational angle (Qcx1) is a weighted average of the first angular component (Qix1) and the first rotational angle (Qx1). The second corrected rotational angle (Qcy1) is a weighted average of the second angular component (Qiy1) and the second rotational angle (Qy1). The third corrected rotational angle (Qcz1) is a weighted average of the third angular component (Qiz1) and the third rotational angle (Qz1). A weighing coefficient for the first angular velocity signal (ωx1) is different from at least one weighing coefficient selected from the group consisting of: a weighing coefficient for the second angular velocity signal (ωy1); a weighing coefficient for the third angular velocity signal (ωz1); a weighing coefficient for the first acceleration signal (Ax1); a weighing coefficient for the second acceleration signal (Ay1); a weighing coefficient for the third acceleration signal (Az1); a weighing coefficient for the first rotational angle (Qx1); a weighing coefficient for the second rotational angle (Qy1); and a weighing coefficient for the third rotational angle (Qz1).

The control system (1; 1a; 1b) according to this aspect allows the first inertial sensor (10); 10a; 10b) to change the weighing coefficient according to the detection axis direction of the angular velocity signal, the detection axis direction of the acceleration signal, and the detection axis direction of the orientation signal. Thus, the first inertial sensor (10; 10a; 10b) may make correction adaptively to the direction in which the first inertial sensor (10; 10a; 10b) and the second inertial sensor (20; 20a; 20b) are installed.

In a control system (1a; 1b) according to an eleventh aspect, which may be implemented in conjunction with any one of the first to tenth aspects, the second control unit (23a) calculates, based on the first orientation signal (Q1) and the second orientation signal (Q2), second detection axis information (D2) indicating a relationship between the fourth detection axis, the fifth detection axis, and the sixth detection axis and the first detection axis, the second detection axis, and the third detection axis. The second control unit (23a) further generates a second reference signal (R1) in accordance with the second detection axis information (D2) and based on the first angular velocity signal (ωx1), the second angular velocity signal (ωy1), the third angular velocity signal (ωz1), the first acceleration signal (Ax1), the second acceleration signal (Ay1), and the third acceleration signal (Az1). The second control unit (23a) further generates a second corrected signal (Sc2) by correcting, using the second reference signal (R1), at least one signal selected from the group consisting of the fourth angular velocity signal (ωx2), the fifth angular velocity signal (ωy2), the sixth angular velocity signal (ωz2), the fourth acceleration signal (Ax2), the fifth acceleration signal (Ay2), and the sixth acceleration signal (Az2). The second control unit (23a) further outputs the second corrected signal (Sc2) to the external system (50).

In the control system (1a; 1b) according to this aspect, the second inertial sensor (20a; 20b) corrects, based on at least one signal selected from the group consisting of the first angular velocity signal (ωx1), the second angular velocity signal (ωy1), the third angular velocity signal (ωz1), the first acceleration signal (Ax1), the second acceleration signal (Ay1), and the third acceleration signal (Az1) which are provided by the first inertial sensor (10a, 10b), at least one of the fourth angular velocity signal (ωx2), the fifth angular velocity signal (ωy2), the sixth angular velocity signal (ωz2), the fourth acceleration signal (Ax2), the fifth acceleration signal (Ay2), or the sixth acceleration signal (Az2). This allows the measurement accuracy of the second corrected signal (Sc2) provided by the second inertial sensor (20a; 20b) to be improved based on the output of the first inertial sensor (10a; 10b). In addition, the second inertial sensor (20a; 20b) calculates second detection axis information (D2) based on the second orientation signal (Q2) and the first orientation signal (Q1). The second detection axis information (D2) indicates a relationship between the fourth detection axis, the fifth detection axis, and the sixth detection axis and the first detection axis, the second detection axis, and the third detection axis. Then, the second inertial sensor (20a; 20b) further generates a second reference signal (R1) in accordance with the second detection axis information (D2) and based on the first angular velocity signal (ox1), the second angular velocity signal (ωy1), the third angular velocity signal (ωz1), the first acceleration signal (Ax1), the second acceleration signal (Ay1), and the third acceleration signal (Az1). This allows correction to be made even if the first detection axis, the second detection axis, and the third detection axis are not aligned with the fourth detection axis, the fifth detection axis, and the sixth detection axis, respectively. Consequently, this enables improving the measurement accuracy of the second corrected signal (Sc2) provided by the second inertial sensor (20a; 20b) without depending on the relation between the second inertial sensor (20a; 20b) and the first inertial sensor (10a; 10b).

In a control system (1a; 1b) according to a twelfth aspect, which may be implemented in conjunction with the eleventh aspect, the second corrected signal (Sc2) includes a signal representing each of the angular velocity around the fourth detection axis, the angular velocity around the fifth detection axis, the angular velocity around the sixth detection axis, the acceleration along the fourth detection axis, the acceleration along the fifth detection axis, and the acceleration along the sixth detection axis. The second corrected signal (Sc2) includes at least one signal selected from the group consisting of the fourth angular velocity signal (ωx2), the fifth angular velocity signal (ωy2), the sixth angular velocity signal (ωz2), the fourth acceleration signal (Ax2), the fifth acceleration signal (Ay2), and the sixth acceleration signal (Az2).

In the control system (1a; 1b) according to this aspect, the second corrected signal (Sc2) includes at least one signal selected from the group consisting of the fourth angular velocity signal (ox2), the fifth angular velocity signal (ωy2), the sixth angular velocity signal (ωz2), the fourth acceleration signal (Ax2), the fifth acceleration signal (Ay2), and the sixth acceleration signal (Az2). In addition, the second corrected signal (Sc2) also includes a signal generated by correcting, using the second reference signal (R1), at least one signal selected from the group consisting of the fourth angular velocity signal (ωx2), the fifth angular velocity signal (ωy2), the sixth angular velocity signal (ωz2), the fourth acceleration signal (Ax2), the fifth acceleration signal (Ay2), and the sixth acceleration signal (Az2). Consequently, this enables selectively correcting any of the angular velocity around the fourth detection axis, the angular velocity around the fifth detection axis, the angular velocity around the sixth detection axis, the acceleration along the fourth detection axis, the acceleration along the fifth detection axis, or the acceleration along the sixth detection axis which may contribute to improving the measurement accuracy by being corrected using the second reference signal (R1).

In a control system (1a; 1b) according to a thirteenth aspect, which may be implemented in conjunction with the eleventh aspect, the second corrected signal (Sc2) includes a signal generated by correcting, using the second reference signal (R1), each of the fourth angular velocity signal (ωx2), the fifth angular velocity signal (ωy2), the sixth angular velocity signal (ωz2), the fourth acceleration signal (Ax2), the fifth acceleration signal (Ay2), and the sixth acceleration signal (Az2).

The control system (1a; 1b) according to this aspect allows the angular velocity around the fourth detection axis, the angular velocity around the fifth detection axis, the angular velocity around the sixth detection axis, the acceleration along the fourth detection axis, the acceleration along the fifth detection axis, and the acceleration along the sixth detection axis to be all corrected in the second corrected signal (Sc2) using the second reference signal (R1). This contributes to improving the measurement accuracy by correction with respect to all components of the second corrected signal (Sc2).

In a control system (1a; 1b) according to a fourteenth aspect, which may be implemented in conjunction with any one of the eleventh to thirteenth aspects, the second reference signal (R1) includes at least one component selected from the group consisting of: a fourth angular velocity component (ωix2), a fifth angular velocity component (ωiy2), a sixth angular velocity component (ωiz2), a fourth acceleration component (Aix2), a fifth acceleration component (Aiy2), and a sixth acceleration component (Aiz2). The fourth angular velocity component (ωix2) represents the angular velocity around the fourth detection axis which is included in a combination of the first angular velocity signal (ωx1), the second angular velocity signal (ωy1), and the third angular velocity signal (ωz1). The fifth angular velocity component (ωiy2) represents the angular velocity around the fifth detection axis which is included in the combination of the first angular velocity signal (ωx1), the second angular velocity signal (ωy1), and the third angular velocity signal (ωz1). The sixth angular velocity component (ωiz2) represents the angular velocity around the sixth detection axis which is included in the combination of the first angular velocity signal (ox1), the second angular velocity signal (ωy1), and the third angular velocity signal (ωz1). The fourth acceleration component (Aix2) represents the acceleration in the direction along the fourth detection axis which is included in a combination of the first acceleration signal (Ax1), the second acceleration signal (Ay1), and the third acceleration signal (Az1). The fifth acceleration component (Aiy2) represents the acceleration in the direction along the fifth detection axis which is included in the combination of the first acceleration signal (Ax1), the second acceleration signal (Ay1), and the third acceleration signal (Az1). The sixth acceleration component (Aiz2) represents the acceleration in the direction along the sixth detection axis which is included in the combination of the first acceleration signal (Ax1), the second acceleration signal (Ay1), and the third acceleration signal (Az1).

In the control system (1a; 1b) according to this aspect, the second reference signal (R1) includes angular velocity around the x2 axis, angular velocity around the y2 axis, or angular velocity around the z2 axis based on the first angular velocity signal (ωx1), the second angular velocity signal (ωy1), and the third angular velocity signal (ωz1). Alternatively, the second reference signal (R1) includes acceleration along the x2 axis, acceleration along the y2 axis, or acceleration along the z2 axis based on the first acceleration signal (Ax1), the second acceleration signal (Ay1), and the third acceleration signal (Az1). This allows the second inertial sensor (20a; 20b) to easily correct at least one signal selected from the group consisting of the fourth angular velocity signal (ωx2), the fifth angular velocity signal (ωy2), the sixth angular velocity signal (ωz2), the fourth acceleration signal (Ax2), the fifth acceleration signal (Ay2), and the sixth acceleration signal (Az2).

In a control system (1a; 1b) according to a fifteenth aspect, which may be implemented in conjunction with the fourteenth aspect, the second corrected signal (Sc2) includes at least one signal selected from the group consisting of a fourth angular velocity correction signal (ωcx2), a fifth angular velocity correction signal (ωcy2), a sixth angular velocity correction signal (ωcz2), a fourth acceleration correction signal (Acx2), a fifth acceleration correction signal (Acy2), and a sixth acceleration correction signal (Acz2). The fourth angular velocity correction signal (ωcx2) is calculated based on the fourth angular velocity signal (ωx2) and the fourth angular velocity component (ωix2). The fifth angular velocity correction signal (ωcy2) is calculated based on the fifth angular velocity signal (ωy2) and the fifth angular velocity component (ωiy2). The sixth angular velocity correction signal (ωcz2) is calculated based on the sixth angular velocity signal (ωz2) and the sixth angular velocity component (ωiz2). The fourth acceleration correction signal (Acx2) is calculated based on the fourth acceleration signal (Ax2) and the fourth acceleration component (Aix2). The fifth acceleration correction signal (Acy2) is calculated based on the fifth acceleration signal (Ay2) and the fifth acceleration component (Aiy2). The sixth acceleration correction signal (Acz2) is calculated based on the sixth acceleration signal (Az2) and the sixth acceleration component (Aiz2).

In the control system (1a; 1b) according to this aspect, the second control unit (23a) of the second inertial sensor (20a; 20b) corrects at least one of the fourth angular velocity signal (ωx2), the fifth angular velocity signal (ωy2), or the sixth angular velocity signal (ωz2) using the angular velocity component around its corresponding detection axis included in the second reference signal (R1). Alternatively, the second control unit (23a) of the second inertial sensor (20a; 20b) corrects at least one of the fourth acceleration signal (Ax2), the fifth acceleration signal (Ay2), or the sixth acceleration signal (Az2) using the acceleration component along its corresponding detection axis included in the second reference signal (R1). Consequently, this control system (1a; 1b) may contribute to improving the measurement accuracy of the second corrected signal (Sc2) by a simple method.

In a control system (1a; 1b) according to a sixteenth aspect, which may be implemented in conjunction with the thirteenth aspect, the second reference signal (R1) includes a fourth angular velocity component (ωix2), a fifth angular velocity component (ωiy2), a sixth angular velocity component (ωiz2), a fourth acceleration component (Aix2), a fifth acceleration component (Aiy2), and a sixth acceleration component (Aiz2). The fourth angular velocity component (ωix2) represents the angular velocity around the fourth detection axis which is included in a combination of the first angular velocity signal (ωx1), the second angular velocity signal (ωy1), and the third angular velocity signal (ωz1). The fifth angular velocity component (ωiy2) represents the angular velocity around the fifth detection axis which is included in the combination of the first angular velocity signal (ωx1), the second angular velocity signal (ωy1), and the third angular velocity signal (ωz1). The sixth angular velocity component (ωiz2) represents the angular velocity around the sixth detection axis which is included in the combination of the first angular velocity signal (ωx1), the second angular velocity signal (ωy1), and the third angular velocity signal (ωz1). The fourth acceleration component (Aix2) represents the acceleration in the direction along the fourth detection axis which is included in a combination of the first acceleration signal (Ax1), the second acceleration signal (Ay1), and the third acceleration signal (Az1). The fifth acceleration component (Aiy2) represents the acceleration in the direction along the fifth detection axis which is included in the combination of the first acceleration signal (Ax1), the second acceleration signal (Ay1), and the third acceleration signal (Az1). The sixth acceleration component (Aiz2) represents the acceleration in the direction along the sixth detection axis which is included in the combination of the first acceleration signal (Ax1), the second acceleration signal (Ay1), and the third acceleration signal (Az1). The second corrected signal (Sc2) includes a fourth angular velocity correction signal (ωcx2), a fifth angular velocity correction signal (ωcy2), a sixth angular velocity correction signal (ωcz2), a fourth acceleration correction signal (Acx2), a fifth acceleration correction signal (Acy2), and a sixth acceleration correction signal (Acz2). The fourth angular velocity correction signal (ωcx2) is a weighted average of the fourth angular velocity component (ωix2) and the fourth angular velocity signal (ωx2). The fifth angular velocity correction signal (ωcy2) is a weighted average of the fifth angular velocity component (ωiy2) and the fifth angular velocity signal (ωy2). The sixth angular velocity correction signal (ωcz2) is a weighted average of the sixth angular velocity component (ωiz2) and the sixth angular velocity signal (ωz2). The fourth acceleration correction signal (Acx2) is a weighted average of the fourth acceleration component (Aix2) and the fourth acceleration signal (Ax2). The fifth acceleration correction signal (Acy2) is a weighted average of the fifth acceleration component (Aiy2) and the fifth acceleration signal (Ay2). The sixth acceleration correction signal (Acz2) is a weighted average of the sixth acceleration component (Aiz2) and the sixth acceleration signal (Az2). A weighing coefficient for the fourth angular velocity signal (ωx2) is different from at least one weighing coefficient selected from the group consisting of: a weighing coefficient for the fifth angular velocity signal (ωy2); a weighing coefficient for the sixth angular velocity signal (ωz2); a weighing coefficient for the fourth acceleration signal (Ax2); a weighing coefficient for the fifth acceleration signal (Ay2); and a weighing coefficient for the sixth acceleration signal (Az2).

The control system (1a; 1b) according to this aspect allows the second inertial sensor (20a; 20b) to change the weighing coefficient for correction according to the detection axis direction of angular velocity and the detection axis direction of acceleration. Thus, the second inertial sensor (20a; 20b) may make correction adaptively to the direction in which the second inertial sensor (20a; 20b) and the first inertial sensor (10a; 10b) are installed.

In a control system (1a; 1b) according to a seventeenth aspect, which may be implemented in conjunction with any one of the eleventh to sixteenth aspects, the second orientation signal (Q2) includes a fourth rotational angle (Qx2) around the fourth detection axis, a fifth rotational angle (Qy2) around the fifth detection axis, and a sixth rotational angle (Qz2) around the sixth detection axis. The second control unit (23a) generates a second reference orientation signal (Qi1) in accordance with the second detection axis information (D2) and based on the first orientation signal (Q1). The second control unit (23a) also generates a second orientation correction signal (Qc2) by correcting, using the second reference orientation signal (Qi1), at least one of the fourth rotational angle (Qx2), the fifth rotational angle (Qy2), or the sixth rotational angle (Q22). The second control unit (23a) further outputs the second orientation correction signal (Qc2) to the external system (50).

The control system (1a; 1b) according to this aspect allows the second inertial sensor (20a; 20b) to correct at least one component of the second orientation signal (Q2) in accordance with the first orientation signal (Q1) provided by the first inertial sensor (10a; 10b). This enables improving, based on the output of the first inertial sensor (10a; 10b), the accuracy of the second orientation correction signal (Qc2) provided by the second inertial sensor (20a; 20b).

In a control system (1a; 1b) according to an eighteenth aspect, which may be implemented in conjunction with the seventeenth aspect, the second orientation correction signal (Qc2) includes a signal generated by correcting, using the second reference orientation signal (Qi1), each of the fourth rotational angle (Qx2), the fifth rotational angle (Qy2), and the sixth rotational angle (Qz2).

The control system (1a; 1b) according to this aspect allows the second inertial sensor (20a; 20b) to correct all components of the second orientation signal (Q2) based on the first orientation signal (Q1) provided by the first inertial sensor (10a; 10b). This enables improving, based on the output of the first inertial sensor (10a; 10b), the accuracy of the second orientation correction signal (Qc2) provided by the second inertial sensor (20a; 20b).

In a control system (1a; 1b) according to a nineteenth aspect, which may be implemented in conjunction with the seventeenth aspect, the second reference orientation signal (Qi1) includes a fourth angular component (Qix2) representing a rotational angle around the fourth detection axis, a fifth angular component (Qiy2) representing a rotational angle around the fifth detection axis, and a sixth angular component (Qiz2) representing a rotational angle around the sixth detection axis. The fourth angular component (Qix2), the fifth angular component (Qiy2), and the sixth angular component (Qiz2) are all included in the first orientation signal (Q1). The second orientation correction signal (Qc2) includes a fourth corrected rotational angle (Qcx2), a fifth corrected rotational angle (Qcy2), and a sixth corrected rotational angle (Qcz2). The fourth corrected rotational angle (Qcx2) is a weighted average of the fourth angular component (Qix2) and the fourth rotational angle (Qx2). The fifth corrected rotational angle (Qcy2) is a weighted average of the fifth angular component (Qiy2) and the fifth rotational angle (Qy2). The sixth corrected rotational angle (Qcz2) is a weighted average of the sixth angular component (Qiz2) and the sixth rotational angle (Q22). A weighing coefficient for the fourth rotational angle (Qx2) is different from at least one of a weighing coefficient for the fifth rotational angle (Qy2) or a weighing coefficient for the sixth rotational angle (Qz2).

The control system (1a; 1b) according to this aspect allows the second inertial sensor (20a; 20b) to change the weighing coefficient for correcting the second orientation signal (Q2) according to the detection axis direction of angular velocity and the detection axis direction of acceleration. Thus, the second inertial sensor (20a; 20b) may make correction adaptively to the direction in which the second inertial sensor (20a; 20b) and the first inertial sensor (10a; 10b) are installed.

In a control system (1a; 1b) according to a twentieth aspect, which may be implemented in conjunction with the eleventh aspect, the second orientation signal (Q2) includes a fourth rotational angle (Qx2) around the fourth detection axis, a fifth rotational angle (Qy2) around the fifth detection axis, and a sixth rotational angle (Q22) around the sixth detection axis. The second control unit (23a) generates a second reference orientation signal (Qi1) in accordance with the second detection axis information (D2) and based on the first orientation signal (Q1). The second control unit (23a) also generates a second orientation correction signal (Qc2) by correcting, using the second reference orientation signal (Qi1), the fourth rotational angle (Qx2), the fifth rotational angle (Qy2), and the sixth rotational angle (Qz2). The second control unit (23a) further outputs the second orientation correction signal (Qc2) to the external system (50). The second reference signal (R1) includes a fourth angular velocity component (ωix2), a fifth angular velocity component (ωiy2), a sixth angular velocity component (ωiz2), a fourth acceleration component (Aix2), a fifth acceleration component (Aiy2), and a sixth acceleration component (Aiz2). The fourth angular velocity component (ωix2) represents the angular velocity around the fourth detection axis which is included in a combination of the first angular velocity signal (ωx1), the second angular velocity signal (ωy1), and the third angular velocity signal (ωz1). The fifth angular velocity component (ωiy2) represents the angular velocity around the fifth detection axis which is included in the combination of the first angular velocity signal (ωx1), the second angular velocity signal (ωy1), and the third angular velocity signal (ωz1). The sixth angular velocity component (ωiz2) represents the angular velocity around the sixth detection axis which is included in the combination of the first angular velocity signal (ωx1), the second angular velocity signal (ωy1), and the third angular velocity signal (ωz1). The fourth acceleration component (Aix2) represents the acceleration in the direction along the fourth detection axis which is included in a combination of the first acceleration signal (Ax1), the second acceleration signal (Ay1), and the third acceleration signal (Az1). The fifth acceleration component (Aiy2) represents the acceleration in the direction along the fifth detection axis which is included in the combination of the first acceleration signal (Ax1), the second acceleration signal (Ay1), and the third acceleration signal (Az1). The sixth acceleration component (Aiz2) represents the acceleration in the direction along the sixth detection axis which is included in the combination of the first acceleration signal (Ax1), the second acceleration signal (Ay1), and the third acceleration signal (Az1). The second reference orientation signal (Qi1) includes a fourth angular component (Qix2) representing a rotational angle around the fourth detection axis, a fifth angular component (Qiy2) representing a rotational angle around the fifth detection axis, and a sixth angular component (Qiz2) representing a rotational angle around the sixth detection axis. The fourth angular component (Qix2), the fifth angular component (Qiy2), and the sixth angular component (Qiz2) are all included in the first orientation signal (Q1). The second corrected signal (Sc2) includes a fourth angular velocity correction signal (ωcx2), a fifth angular velocity correction signal (ωcy2), a sixth angular velocity correction signal (ωcz2), a fourth acceleration correction signal (Acx2), a fifth acceleration correction signal (Acy2), and a sixth acceleration correction signal (Acz2). The fourth angular velocity correction signal (ωcx2) is a weighted average of the fourth angular velocity component (ωix2) and the fourth angular velocity signal (ωx2). The fifth angular velocity correction signal (ωcy2) is a weighted average of the fifth angular velocity component (ωiy2) and the fifth angular velocity signal (ωy2). The sixth angular velocity correction signal (ωcz2) is a weighted average of the sixth angular velocity component (ωiz2) and the sixth angular velocity signal (ωz2). The fourth acceleration correction signal (Acx2) is a weighted average of the fourth acceleration component (Aix2) and the fourth acceleration signal (Ax2). The fifth acceleration correction signal (Acy2) is a weighted average of the fifth acceleration component (Aiy2) and the fifth acceleration signal (Ay2). The sixth acceleration correction signal (Acz2) is a weighted average of the sixth acceleration component (Aiz2) and the sixth acceleration signal (Az2). The second orientation correction signal (Qc2) includes a fourth corrected rotational angle (Qcx2), a fifth corrected rotational angle (Qcy2), and a sixth corrected rotational angle (Qcz2). The fourth corrected rotational angle (Qcx2) is a weighted average of the fourth angular component (Qix2) and the fourth rotational angle (Qx2). The fifth corrected rotational angle (Qcy2) is a weighted average of the fifth angular component (Qiy2) and the fifth rotational angle (Qy2). The sixth corrected rotational angle (Qcz2) is a weighted average of the sixth angular component (Qiz2) and the sixth rotational angle (Q22). A weighing coefficient for the fourth angular velocity signal (ωx2) is different from at least one weighing coefficient selected from the group consisting of: a weighing coefficient for the fifth angular velocity signal (ωy2); a weighing coefficient for the sixth angular velocity signal (ωz2); a weighing coefficient for the fourth acceleration signal (Ax2); a weighing coefficient for the fifth acceleration signal (Ay2); a weighing coefficient for the sixth acceleration signal (Az2); a weighing coefficient for the fourth rotational angle (Qx2); a weighing coefficient for the fifth rotational angle (Qy2); and a weighing coefficient for the sixth rotational angle (Qz2).

The control system (1a; 1b) according to this aspect allows the second inertial sensor (20a; 20b) to change the weighing coefficient according to the detection axis direction of the angular velocity signal, the detection axis direction of the acceleration signal, and the detection axis direction of the orientation signal. Thus, the second inertial sensor (20a; 20b) may make correction adaptively to the direction in which the second inertial sensor (20a; 20b) and the first inertial sensor (10a; 10b) are installed.

An inertial sensor (10; 10a; 10b) according to a twenty-first aspect is disposed in a moving part (61). The inertial sensor (10; 10a; 10b) includes a first angular velocity detection element (111), a second angular velocity detection element (112), a third angular velocity detection element (113), a first acceleration detection element (121), a second acceleration detection element (122), a third acceleration detection element (123), and a control unit (13; 13a). The first angular velocity detection element (111) detects angular velocity around a first detection axis to output a first angular velocity signal (ωx1). The second angular velocity detection element (112) detects angular velocity around a second detection axis to output a second angular velocity signal (ωy1). The third angular velocity detection element (113) detects angular velocity around a third detection axis to output a third angular velocity signal (ωz1). The first acceleration detection element (121) detects acceleration in a direction along the first detection axis to output a first acceleration signal (Ax1). The second acceleration detection element (122) detects acceleration in a direction along the second detection axis to output a second acceleration signal (Ay1). The third acceleration detection element (123) detects acceleration in a direction along the third detection axis to output a third acceleration signal (Az1). The control unit (13; 13a) calculates a first orientation signal (Q1) based on the first angular velocity signal (ωx1), the second angular velocity signal (ωy1), the third angular velocity signal (ωz1), the first acceleration signal (Ax1), the second acceleration signal (Ay1), and the third acceleration signal (Az1). The first detection axis, the second detection axis, and the third detection axis are perpendicular to each other. The control unit (13; 13a) acquires, from a second inertial sensor (20; 20a; 20b), a fourth angular velocity signal (ωx2), a fifth angular velocity signal (ωy2), a sixth angular velocity signal (ωz2), a fourth acceleration signal (Ax2), a fifth acceleration signal (Ay2), a sixth acceleration signal (Az2), and a second orientation signal (Q2). The second inertial sensor (20; 20a; 20b) is different from a first inertial sensor (10; 10a; 10b) serving as the inertial sensor. The second inertial sensor (20; 20a; 20b) is disposed in a second moving part (62) which is ready to be actuated with respect to a first moving part (61) serving as the moving part. The fourth angular velocity signal (ωx2) represents angular velocity around a fourth detection axis. The fifth angular velocity signal (ωy2) represents angular velocity around a fifth detection axis perpendicular to the fourth detection axis. The sixth angular velocity signal (ωz2) represents angular velocity around a sixth detection axis perpendicular to the fourth detection axis and the fifth detection axis. The fourth acceleration signal (Ax2) represents acceleration in a direction along the fourth detection axis. The fifth acceleration signal (Ay2) represents acceleration in a direction along the fifth detection axis. The sixth acceleration signal (Az2) represents acceleration in a direction along the sixth detection axis. The second orientation signal (Q2) represents an orientation of the second inertial sensor (20; 20a; 20b). The control unit (13; 13a) further calculates, based on the first orientation signal (Q1) and the second orientation signal (Q2), detection axis information (D1). The detection axis information (D1) indicates a relationship between the first detection axis, the second detection axis, and the third detection axis and the fourth detection axis, the fifth detection axis, and the sixth detection axis. The control unit (13; 13a) further generates a reference signal (R2) in accordance with the detection axis information (D1) and based on at least one signal selected from the group consisting of the fourth angular velocity signal (ωx2), the fifth angular velocity signal (ωy2), the sixth angular velocity signal (ωz2), the fourth acceleration signal (Ax2), the fifth acceleration signal (Ay2), and the sixth acceleration signal (Az2). The control unit (13; 13a) further generates a corrected signal (Sc1) by correcting, using the reference signal (R2), at least one signal selected from the group consisting of the first angular velocity signal (ωx1), the second angular velocity signal (ωy1), the third angular velocity signal (ωz1), the first acceleration signal (Ax1), the second acceleration signal (Ay1), and the third acceleration signal (Az1). The control unit (13; 13a) further outputs the corrected signal (Sc1).

The inertial sensor (10; 10a; 10b) according to this aspect corrects, based on the fourth angular velocity signal (ωx2), the fifth angular velocity signal (ωy2), the sixth angular velocity signal (ωz2), the fourth acceleration signal (Ax2), the fifth acceleration signal (Ay2), and the sixth acceleration signal (Az2) which are provided by the second inertial sensor (20; 20a; 20b), at least one of the first angular velocity signal (ωx1), the second angular velocity signal (ωy1), the third angular velocity signal (ωz1), the first acceleration signal (Ax1), the second acceleration signal (Ay1), or the third acceleration signal (Az1). This allows the measurement accuracy of the corrected signal (Sc1) provided by the first inertial sensor (10; 10a; 10b) to be improved based on the output of the second inertial sensor (20; 20a; 20b). In addition, the inertial sensor (10; 10a; 10b) calculates detection axis information (D1) based on the first orientation signal (Q1) and the second orientation signal (Q2). The detection axis information (D1) indicates a relationship between the first detection axis, the second detection axis, and the third detection axis and the fourth detection axis, the fifth detection axis, and the sixth detection axis. Then, the inertial sensor (10; 10a; 10b) further generates a reference signal (R2) in accordance with the detection axis information (D1) and based on the fourth angular velocity signal (ωx2), the fifth angular velocity signal (ωy2), the sixth angular velocity signal (ωz2), the fourth acceleration signal (Ax2), the fifth acceleration signal (Ay2), and the sixth acceleration signal (Az2). This allows correction to be made even if the fourth detection axis, the fifth detection axis, and the sixth detection axis are not aligned with the first detection axis, the second detection axis, and the third detection axis, respectively. Consequently, this enables improving the measurement accuracy of the corrected signal (Sc1) provided by the inertial sensor (10; 10a; 10b) without depending on the relation between the first inertial sensor (10; 10a; 10b) and the second inertial sensor (20; 20a; 20b).

### REFERENCE SIGNS LIST

1, 1a, 1b Control System
10, 10a, 10b First Sensor (First Inertial Sensor, Inertial Sensor)
20, 20a, 20b Second Sensor (Second Inertial Sensor)
30 First Signal Path
40 Second Signal Path
50 External System
61 First Moving Part (Moving Part)
62 Second Moving Part
13, 13a Control Unit (First Control Unit)
23, 23a Control Unit (Second Control Unit)
111 x1-Axis Angular Velocity Detection Element (First Angular Velocity Detection Element)
112 y1-Axis Angular Velocity Detection Element (Second Angular Velocity Detection Element)
113 z1-Axis Angular Velocity Detection Element (Third Angular Velocity Detection Element)
114 x2-Axis Angular Velocity Detection Element (Fourth Angular Velocity Detection Element)
115 y2-Axis Angular Velocity Detection Element (Fifth Angular Velocity Detection Element)
116 z2-Axis Angular Velocity Detection Element (Sixth Angular Velocity Detection Element)
121 x1-Axis Acceleration Detection Element (First Acceleration Detection Element)
122 y1-Axis Acceleration Detection Element (Second Acceleration Detection Element)
123 z1-Axis Acceleration Detection Element (Third Acceleration Detection Element)
124 x2-Axis Acceleration Detection Element (Fourth Acceleration Detection Element)
125 y2-Axis Acceleration Detection Element (Fifth Acceleration Detection Element)
126 z2-Axis Acceleration Detection Element (Sixth Acceleration Detection Element)
ωx1 x1-Axis Angular Velocity Signal (First Angular Velocity Signal)
ωy1 y1-Axis Angular Velocity Signal (Second Angular Velocity Signal)
ωz1 z1-Axis Angular Velocity Signal (Third Angular Velocity Signal)
ωx2 x2-Axis Angular Velocity Signal (Fourth Angular Velocity Signal)
ωy2 y2-Axis Angular Velocity Signal (Fifth Angular Velocity Signal)
ωz2 z2-Axis Angular Velocity Signal (Sixth Angular Velocity Signal)
Ax1 x1-Axis Acceleration Signal (First Acceleration Signal)
Ay1 y1-Axis Acceleration Signal (Second Acceleration Signal)
Az1 z1-Axis Acceleration Signal (Third Acceleration Signal)
Ax2 x2-Axis Acceleration Signal (Fourth Acceleration Signal)
Ay2 y2-Axis Acceleration Signal (Fifth Acceleration Signal)
Az2 z2-Axis Acceleration Signal (Sixth Acceleration Signal)
Q1 Orientation Signal (First Orientation Signal)
Q2 Orientation Signal (Second Orientation Signal)
Qx1 Roll (First Rotational Angle)
Qy1 Pitch (Second Rotational Angle)
Qz1 Yaw (Third Rotational Angle)
Qx2 Roll (Fourth Rotational Angle)
Qy2 Pitch (Fifth Rotational Angle)
Qz2 Yaw (Sixth Rotational Angle)
D1 Detection Axis Information (First Detection Axis Information)
D2 Detection Axis Information (Second Detection Axis Information)
R2 Reference Signal (First Reference Signal)
R1 Reference Signal (Second Reference Signal)
ωix1 x1-Axis Angular Velocity Component (First Angular Velocity Component)
ωiy1 y1-Axis Angular Velocity Component (Second Angular Velocity Component)
ωiz1 z1-Axis Angular Velocity Component (Third Angular Velocity Component)
ωix2 x2-Axis Angular Velocity Component (Fourth Angular Velocity Component)
ωiy2 y2-Axis Angular Velocity Component (Fifth Angular Velocity Component)
ωiz2 z2-Axis Angular Velocity Component (Sixth Angular Velocity Component)
Aix1 x1-Axis Acceleration Component (First Acceleration Component)
Aiy1 y1-Axis Acceleration Component (Second Acceleration Component)
Aiz1 z1-Axis Acceleration Component (Third Acceleration Component)
Aix2 x2-Axis Acceleration Component (Fourth Acceleration Component)
Aiy2 y2-Axis Acceleration Component (Fifth Acceleration Component)
Aiz2 z2-Axis Acceleration Component (Sixth Acceleration Component)
Sc1 Corrected Signal (First Corrected Signal)
Sc2 Corrected Signal (Second Corrected Signal)
ωcx1 x1-Axis Angular Velocity Correction Signal (First Angular Velocity Correction Signal)
ωcy1 y1-Axis Angular Velocity Correction Signal (Second Angular Velocity Correction Signal)
ωcz1 z1-Axis Angular Velocity Correction Signal (Third Angular Velocity Correction Signal)
ωcx2 x2-Axis Angular Velocity Correction Signal (Fourth Angular Velocity Correction Signal)
ωcy2 y2-Axis Angular Velocity Correction Signal (Fifth Angular Velocity Correction Signal)
ωcz2 z2-Axis Angular Velocity Correction Signal (Sixth Angular Velocity Correction Signal)
Acx1 x1-Axis Acceleration Correction Signal (First Acceleration Correction Signal)
Acy1 y1-Axis Acceleration Correction Signal (Second Acceleration Correction Signal)
Acz1 z1-Axis Acceleration Correction Signal (Third Acceleration Correction Signal)
Acx2 x2-Axis Acceleration Correction Signal (Fourth Acceleration Correction Signal)
Acy2 y2-Axis Acceleration Correction Signal (Fifth Acceleration Correction Signal)
Acz2 z2-Axis Acceleration Correction Signal (Sixth Acceleration Correction Signal)
Qi2 Reference Orientation Signal (First Reference Orientation Signal)
Qi1 Reference Orientation Signal (Second Reference Orientation Signal)
Qix1 Roll Component (First Angular Component)
Qiy1 Pitch Component (Second Angular Component)
Qiz1 Yaw Component (Third Angular Component)
Qix2 Roll Component (Fourth Angular Component)
Qiy2 Pitch Component (Fifth Angular Component)
Qiz2 Yaw Component (Sixth Angular Component)
Qc1 Corrected Orientation Signal (First Orientation Correction Signal)
Qc2 Corrected Orientation Signal (Second Orientation Correction Signal)
Qcx1 Corrected Roll (First Corrected Rotational Angle)
Qcy1 Corrected Pitch (Second Corrected Rotational Angle)
Qcz1 Corrected Yaw (Third Corrected Rotational Angle)
Qcx2 Corrected Roll (Fourth Corrected Rotational Angle)
Qcy2 Corrected Pitch (Fifth Corrected Rotational Angle)
Qcz2 Corrected Yaw (Sixth Corrected Rotational Angle)

1. A control system comprising:
a first inertial sensor disposed in a first moving part;
a second inertial sensor disposed in a second moving part, the second moving part being configured to be actuated with respect to the first moving part;
a first signal path connecting the first inertial sensor to an external system; and
a second signal path connecting the second inertial sensor to the first inertial sensor,
the first inertial sensor including:
a first angular velocity detection element configured to detect angular velocity around a first detection axis to output a first angular velocity signal;
a second angular velocity detection element configured to detect angular velocity around a second detection axis to output a second angular velocity signal;
a third angular velocity detection element configured to detect angular velocity around a third detection axis to output a third angular velocity signal;
a first acceleration detection element configured to detect acceleration in a direction along the first detection axis to output a first acceleration signal;
a second acceleration detection element configured to detect acceleration in a direction along the second detection axis to output a second acceleration signal;
a third acceleration detection element configured to detect acceleration in a direction along the third detection axis to output a third acceleration signal; and
a first control unit configured to calculate a first orientation signal based on the first angular velocity signal, the second angular velocity signal, the third angular velocity signal, the first acceleration signal, the second acceleration signal, and the third acceleration signal,
the first detection axis, the second detection axis, and the third detection axis being perpendicular to each other,
the second inertial sensor including:
a fourth angular velocity detection element configured to detect angular velocity around a fourth detection axis to output a fourth angular velocity signal;
a fifth angular velocity detection element configured to detect angular velocity around a fifth detection axis to output a fifth angular velocity signal;
a sixth angular velocity detection element configured to detect angular velocity around a sixth detection axis to output a sixth angular velocity signal;
a fourth acceleration detection element configured to detect acceleration in a direction along the fourth detection axis to output a fourth acceleration signal;
a fifth acceleration detection element configured to detect acceleration in a direction along the fifth detection axis to output a fifth acceleration signal;
a sixth acceleration detection element configured to detect acceleration in a direction along the sixth detection axis to output a sixth acceleration signal; and
a second control unit configured to calculate a second orientation signal based on the fourth angular velocity signal, the fifth angular velocity signal, the sixth angular velocity signal, the fourth acceleration signal, the fifth acceleration signal, and the sixth acceleration signal,
the fourth detection axis, the fifth detection axis, and the sixth detection axis being perpendicular to each other,
the first control unit being configured to:
calculate, based on the first orientation signal and the second orientation signal, first detection axis information indicating a relationship between the first detection axis, the second detection axis, and the third detection axis and the fourth detection axis, the fifth detection axis, and the sixth detection axis;
generate a first reference signal in accordance with the first detection axis information and based on at least one signal selected from the group consisting of the fourth angular velocity signal, the fifth angular velocity signal, the sixth angular velocity signal, the fourth acceleration signal, the fifth acceleration signal, and the sixth acceleration signal;
generate a first corrected signal by correcting, using the first reference signal, at least one signal selected from the group consisting of the first angular velocity signal, the second angular velocity signal, the third angular velocity signal, the first acceleration signal, the second acceleration signal, and the third acceleration signal; and
output the first corrected signal to the external system.

2. The control system of claim 1, wherein
the first corrected signal includes a signal representing each of the angular velocity around the first detection axis, the angular velocity around the second detection axis, the angular velocity around the third detection axis, the acceleration along the first detection axis, the acceleration along the second detection axis, and the acceleration along the third detection axis, and
the first corrected signal includes at least one signal selected from the group consisting of the first angular velocity signal, the second angular velocity signal, the third angular velocity signal, the first acceleration signal, the second acceleration signal, and the third acceleration signal.

3. The control system of claim 1, wherein
the first corrected signal includes a signal generated by correcting, using the first reference signal, each of the first angular velocity signal, the second angular velocity signal, the third angular velocity signal, the first acceleration signal, the second acceleration signal, and the third acceleration signal.

4. The control system of claim 1, wherein
the first reference signal includes at least one component selected from the group consisting of:
a first angular velocity component representing the angular velocity around the first detection axis which is included in a combination of the fourth angular velocity signal, the fifth angular velocity signal, and the sixth angular velocity signal;
a second angular velocity component representing the angular velocity around the second detection axis which is included in the combination of the fourth angular velocity signal, the fifth angular velocity signal, and the sixth angular velocity signal;
a third angular velocity component representing the angular velocity around the third detection axis which is included in the combination of the fourth angular velocity signal, the fifth angular velocity signal, and the sixth angular velocity signal;
a first acceleration component representing the acceleration in the direction along the first detection axis which is included in a combination of the fourth acceleration signal, the fifth acceleration signal, and the sixth acceleration signal;
a second acceleration component representing the acceleration in the direction along the second detection axis which is included in the combination of the fourth acceleration signal, the fifth acceleration signal, and the sixth acceleration signal; and
a third acceleration component representing the acceleration in the direction along the third detection axis which is included in the combination of the fourth acceleration signal, the fifth acceleration signal, and the sixth acceleration signal.

5. The control system of claim 4, wherein
the first corrected signal includes at least one signal selected from the group consisting of:
a first angular velocity correction signal calculated based on the first angular velocity signal and the first angular velocity component;
a second angular velocity correction signal calculated based on the second angular velocity signal and the second angular velocity component;
a third angular velocity correction signal calculated based on the third angular velocity signal and the third angular velocity component;
a first acceleration correction signal calculated based on the first acceleration signal and the first acceleration component;
a second acceleration correction signal calculated based on the second acceleration signal and the second acceleration component; and
a third acceleration correction signal calculated based on the third acceleration signal and the third acceleration component.

6. The control system of claim 3, wherein
the first reference signal includes:
a first angular velocity component representing the angular velocity around the first detection axis which is included in a combination of the fourth angular velocity signal, the fifth angular velocity signal, and the sixth angular velocity signal;
a second angular velocity component representing the angular velocity around the second detection axis which is included in the combination of the fourth angular velocity signal, the fifth angular velocity signal, and the sixth angular velocity signal;
a third angular velocity component representing the angular velocity around the third detection axis which is included in the combination of the fourth angular velocity signal, the fifth angular velocity signal, and the sixth angular velocity signal;
a first acceleration component representing the acceleration in the direction along the first detection axis which is included in a combination of the fourth acceleration signal, the fifth acceleration signal, and the sixth acceleration signal;
a second acceleration component representing the acceleration in the direction along the second detection axis which is included in the combination of the fourth acceleration signal, the fifth acceleration signal, and the sixth acceleration signal; and
a third acceleration component representing the acceleration in the direction along the third detection axis which is included in the combination of the fourth acceleration signal, the fifth acceleration signal, and the sixth acceleration signal,
the first corrected signal includes:
a first angular velocity correction signal as a weighted average of the first angular velocity component and the first angular velocity signal;
a second angular velocity correction signal as a weighted average of the second angular velocity component and the second angular velocity signal;
a third angular velocity correction signal as a weighted average of the third angular velocity component and the third angular velocity signal;
a first acceleration correction signal as a weighted average of the first acceleration component and the first acceleration signal;
a second acceleration correction signal as a weighted average of the second acceleration component and the second acceleration signal; and
a third acceleration correction signal as a weighted average of the third acceleration component and the third acceleration signal,
a weighing coefficient for the first angular velocity signal is different from at least one weighing coefficient selected from the group consisting of: a weighing coefficient for the second angular velocity signal; a weighing coefficient for the third angular velocity signal; a weighing coefficient for the first acceleration signal; a weighing coefficient for the second acceleration signal; and a weighing coefficient for the third acceleration signal.

7. The control system of claim 1, wherein
the first orientation signal includes a first rotational angle around the first detection axis, a second rotational angle around the second detection axis, and a third rotational angle around the third detection axis, and
the first control unit is configured to:
generate a first reference orientation signal in accordance with the first detection axis information and based on the second orientation signal;
generate a first orientation correction signal by correcting, using the first reference orientation signal, at least one of the first rotational angle, the second rotational angle, or the third rotational angle; and
output the first orientation correction signal to the external system.

8. The control system of claim 7, wherein
the first orientation correction signal includes a signal generated by correcting, using the first reference orientation signal, each of the first rotational angle, the second rotational angle, and the third rotational angle.

9. The control system of claim 7, wherein
the first reference orientation signal includes a first angular component representing a rotational angle around the first detection axis, a second angular component representing a rotational angle around the second detection axis, and a third angular component representing a rotational angle around the third detection axis, the first angular component, the second angular component, and the third angular component being all included in the second orientation signal,
the first orientation correction signal includes:
a first corrected rotational angle as a weighted average of the first angular component and the first rotational angle;
a second corrected rotational angle as a weighted average of the second angular component and the second rotational angle; and
a third corrected rotational angle as a weighted average of the third angular component and the third rotational angle, and
a weighing coefficient for the first rotational angle is different from at least one of a weighing coefficient for the second rotational angle or a weighing coefficient for the third rotational angle.

10. The control system of claim 1, wherein
the first orientation signal includes a first rotational angle around the first detection axis, a second rotational angle around the second detection axis, and a third rotational angle around the third detection axis,
the first control unit is configured to:
generate a first reference orientation signal in accordance with the first detection axis information and based on the second orientation signal;
generate a first orientation correction signal by correcting, using the first reference orientation signal, the first rotational angle, the second rotational angle, and the third rotational angle; and
output the first orientation correction signal to the external system,
the first reference signal includes:
a first angular velocity component representing the angular velocity around the first detection axis which is included in a combination of the fourth angular velocity signal, the fifth angular velocity signal, and the sixth angular velocity signal;
a second angular velocity component representing the angular velocity around the second detection axis which is included in the combination of the fourth angular velocity signal, the fifth angular velocity signal, and the sixth angular velocity signal;
a third angular velocity component representing the angular velocity around the third detection axis which is included in the combination of the fourth angular velocity signal, the fifth angular velocity signal, and the sixth angular velocity signal;
a first acceleration component representing the acceleration in the direction along the first detection axis which is included in a combination of the fourth acceleration signal, the fifth acceleration signal, and the sixth acceleration signal;
a second acceleration component representing the acceleration in the direction along the second detection axis which is included in the combination of the fourth acceleration signal, the fifth acceleration signal, and the sixth acceleration signal; and
a third acceleration component representing the acceleration in the direction along the third detection axis which is included in the combination of the fourth acceleration signal, the fifth acceleration signal, and the sixth acceleration signal,
the first reference orientation signal includes a first angular component representing a rotational angle around the first detection axis, a second angular component representing a rotational angle around the second detection axis, and a third angular component representing a rotational angle around the third detection axis, the first angular component, the second angular component, and the third angular component being all included in the second orientation signal,
the first corrected signal includes:
a first angular velocity correction signal as a weighted average of the first angular velocity component and the first angular velocity signal;
a second angular velocity correction signal as a weighted average of the second angular velocity component and the second angular velocity signal;
a third angular velocity correction signal as a weighted average of the third angular velocity component and the third angular velocity signal;
a first acceleration correction signal as a weighted average of the first acceleration component and the first acceleration signal;
a second acceleration correction signal as a weighted average of the second acceleration component and the second acceleration signal; and
a third acceleration correction signal as a weighted average of the third acceleration component and the third acceleration signal,
the first orientation correction signal includes:
a first corrected rotational angle as a weighted average of the first angular component and the first rotational angle;
a second corrected rotational angle as a weighted average of the second angular component and the second rotational angle; and
a third corrected rotational angle as a weighted average of the third angular component and the third rotational angle, and
a weighing coefficient for the first angular velocity signal is different from at least one weighing coefficient selected from the group consisting of: a weighing coefficient for the second angular velocity signal; a weighing coefficient for the third angular velocity signal; a weighing coefficient for the first acceleration signal; a weighing coefficient for the second acceleration signal; a weighing coefficient for the third acceleration signal; a weighing coefficient for the first rotational angle; a weighing coefficient for the second rotational angle; and a weighing coefficient for the third rotational angle.

11. The control system of claim 1, wherein
the second control unit is configured to:
calculate, based on the first orientation signal and the second orientation signal, second detection axis information indicating a relationship between the fourth detection axis, the fifth detection axis, and the sixth detection axis and the first detection axis, the second detection axis, and the third detection axis;
generate a second reference signal in accordance with the second detection axis information and based on the first angular velocity signal, the second angular velocity signal, the third angular velocity signal, the first acceleration signal, the second acceleration signal, and the third acceleration signal;
generate a second corrected signal by correcting, using the second reference signal, at least one signal selected from the group consisting of the fourth angular velocity signal, the fifth angular velocity signal, the sixth angular velocity signal, the fourth acceleration signal, the fifth acceleration signal, and the sixth acceleration signal; and
output the second corrected signal to the external system.

12. The control system of claim 11, wherein
the second corrected signal includes a signal representing each of the angular velocity around the fourth detection axis, the angular velocity around the fifth detection axis, the angular velocity around the sixth detection axis, the acceleration along the fourth detection axis, the acceleration along the fifth detection axis, and the acceleration along the sixth detection axis, and
the second corrected signal includes at least one signal selected from the group consisting of the fourth angular velocity signal, the fifth angular velocity signal, the sixth angular velocity signal, the fourth acceleration signal, the fifth acceleration signal, and the sixth acceleration signal.

13. The control system of claim 11, wherein
the second corrected signal includes a signal generated by correcting, using the second reference signal, each of the fourth angular velocity signal, the fifth angular velocity signal, the sixth angular velocity signal, the fourth acceleration signal, the fifth acceleration signal, and the sixth acceleration signal.

14. The control system of claim 11, wherein
the second reference signal includes at least one component selected from the group consisting of:
a fourth angular velocity component representing the angular velocity around the fourth detection axis which is included in a combination of the first angular velocity signal, the second angular velocity signal, and the third angular velocity signal;
a fifth angular velocity component representing the angular velocity around the fifth detection axis which is included in the combination of the first angular velocity signal, the second angular velocity signal, and the third angular velocity signal;
a sixth angular velocity component representing the angular velocity around the sixth detection axis which is included in the combination of the first angular velocity signal, the second angular velocity signal, and the third angular velocity signal;
a fourth acceleration component representing the acceleration in the direction along the fourth detection axis which is included in a combination of the first acceleration signal, the second acceleration signal, and the third acceleration signal;
a fifth acceleration component representing the acceleration in the direction along the fifth detection axis which is included in the combination of the first acceleration signal, the second acceleration signal, and the third acceleration signal; and
a sixth acceleration component representing the acceleration in the direction along the sixth detection axis which is included in the combination of the first acceleration signal, the second acceleration signal, and the third acceleration signal.

15. The control system of claim 14, wherein
the second corrected signal includes at least one signal selected from the group consisting of:
a fourth angular velocity correction signal calculated based on the fourth angular velocity signal and the fourth angular velocity component;
a fifth angular velocity correction signal calculated based on the fifth angular velocity signal and the fifth angular velocity component;
a sixth angular velocity correction signal calculated based on the sixth angular velocity signal and the sixth angular velocity component;
a fourth acceleration correction signal calculated based on the fourth acceleration signal and the fourth acceleration component;
a fifth acceleration correction signal calculated based on the fifth acceleration signal and the fifth acceleration component; and
a sixth acceleration correction signal calculated based on the sixth acceleration signal and the sixth acceleration component.

16. The control system of claim 13, wherein
the second reference signal includes:
a fourth angular velocity component representing the angular velocity around the fourth detection axis which is included in a combination of the first angular velocity signal, the second angular velocity signal, and the third angular velocity signal;
a fifth angular velocity component representing the angular velocity around the fifth detection axis which is included in the combination of the first angular velocity signal, the second angular velocity signal, and the third angular velocity signal;
a sixth angular velocity component representing the angular velocity around the sixth detection axis which is included in the combination of the first angular velocity signal, the second angular velocity signal, and the third angular velocity signal;
a fourth acceleration component representing the acceleration in the direction along the fourth detection axis which is included in a combination of the first acceleration signal, the second acceleration signal, and the third acceleration signal;
a fifth acceleration component representing the acceleration in the direction along the fifth detection axis which is included in the combination of the first acceleration signal, the second acceleration signal, and the third acceleration signal; and
a sixth acceleration component representing the acceleration in the direction along the sixth detection axis which is included in the combination of the first acceleration signal, the second acceleration signal, and the third acceleration signal,
the second corrected signal includes:
a fourth angular velocity correction signal as a weighted average of the fourth angular velocity component and the fourth angular velocity signal;
a fifth angular velocity correction signal as a weighted average of the fifth angular velocity component and the fifth angular velocity signal;
a sixth angular velocity correction signal as a weighted average of the sixth angular velocity component and the sixth angular velocity signal;
a fourth acceleration correction signal as a weighted average of the fourth acceleration component and the fourth acceleration signal;
a fifth acceleration correction signal as a weighted average of the fifth acceleration component and the fifth acceleration signal; and
a sixth acceleration correction signal as a weighted average of the sixth acceleration component and the sixth acceleration signal, and
a weighing coefficient for the fourth angular velocity signal is different from at least one weighing coefficient selected from the group consisting of: a weighing coefficient for the fifth angular velocity signal; a weighing coefficient for the sixth angular velocity signal; a weighing coefficient for the fourth acceleration signal; a weighing coefficient for the fifth acceleration signal; and a weighing coefficient for the sixth acceleration signal.

17. The control system of claim 11, wherein
the second orientation signal includes a fourth rotational angle around the fourth detection axis, a fifth rotational angle around the fifth detection axis, and a sixth rotational angle around the sixth detection axis, and
the second control unit is configured to:
generate a second reference orientation signal in accordance with the second detection axis information and based on the first orientation signal;
generate a second orientation correction signal by correcting, using the second reference orientation signal, at least one of the fourth rotational angle, the fifth rotational angle, or the sixth rotational angle; and
output the second orientation correction signal to the external system.

18. The control system of claim 17, wherein
the second orientation correction signal includes a signal generated by correcting, using the second reference orientation signal, each of the fourth rotational angle, the fifth rotational angle, and the sixth rotational angle.

19. The control system of claim 17, wherein
the second reference orientation signal includes a fourth angular component representing a rotational angle around the fourth detection axis, a fifth angular component representing a rotational angle around the fifth detection axis, and a sixth angular component representing a rotational angle around the sixth detection axis, the fourth angular component, the fifth angular component, and the sixth angular component being all included in the first orientation signal,
the second orientation correction signal includes:
a fourth corrected rotational angle as a weighted average of the fourth angular component and the fourth rotational angle;
a fifth corrected rotational angle as a weighted average of the fifth angular component and the fifth rotational angle; and
a sixth corrected rotational angle as a weighted average of the sixth angular component and the sixth rotational angle, and
a weighing coefficient for the fourth rotational angle is different from at least one of a weighing coefficient for the fifth rotational angle or a weighing coefficient for the sixth rotational angle.

20. The control system of claim 11, wherein
the second orientation signal includes a fourth rotational angle around the fourth detection axis, a fifth rotational angle around the fifth detection axis, and a sixth rotational angle around the sixth detection axis,
the second control unit is configured to:
generate a second reference orientation signal in accordance with the second detection axis information and based on the first orientation signal;
generate a second orientation correction signal by correcting, using the second reference orientation signal, the fourth rotational angle, the fifth rotational angle, and the sixth rotational angle; and
output the second orientation correction signal to the external system,
the second reference signal includes:
a fourth angular velocity component representing the angular velocity around the fourth detection axis which is included in a combination of the first angular velocity signal, the second angular velocity signal, and the third angular velocity signal;
a fifth angular velocity component representing the angular velocity around the fifth detection axis which is included in the combination of the first angular velocity signal, the second angular velocity signal, and the third angular velocity signal;
a sixth angular velocity component representing the angular velocity around the sixth detection axis which is included in the combination of the first angular velocity signal, the second angular velocity signal, and the third angular velocity signal;
a fourth acceleration component representing the acceleration in the direction along the fourth detection axis which is included in a combination of the first acceleration signal, the second acceleration signal, and the third acceleration signal;
a fifth acceleration component representing the acceleration in the direction along the fifth detection axis which is included in the combination of the first acceleration signal, the second acceleration signal, and the third acceleration signal; and
a sixth acceleration component representing the acceleration in the direction along the sixth detection axis which is included in the combination of the first acceleration signal, the second acceleration signal, and the third acceleration signal,
the second reference orientation signal includes a fourth angular component representing a rotational angle around the fourth detection axis, a fifth angular component representing a rotational angle around the fifth detection axis, and a sixth angular component representing a rotational angle around the sixth detection axis, the fourth angular component, the fifth angular component, and the sixth angular component being all included in the first orientation signal,
the second corrected signal includes:
a fourth angular velocity correction signal as a weighted average of the fourth angular velocity component and the fourth angular velocity signal;
a fifth angular velocity correction signal as a weighted average of the fifth angular velocity component and the fifth angular velocity signal;
a sixth angular velocity correction signal as a weighted average of the sixth angular velocity component and the sixth angular velocity signal;
a fourth acceleration correction signal as a weighted average of the fourth acceleration component and the fourth acceleration signal;
a fifth acceleration correction signal as a weighted average of the fifth acceleration component and the fifth acceleration signal; and
a sixth acceleration correction signal as a weighted average of the sixth acceleration component and the sixth acceleration signal,
the second orientation correction signal includes:
a fourth corrected rotational angle as a weighted average of the fourth angular component and the fourth rotational angle;
a fifth corrected rotational angle as a weighted average of the fifth angular component and the fifth rotational angle; and
a sixth corrected rotational angle as a weighted average of the sixth angular component and the sixth rotational angle, and
a weighing coefficient for the fourth angular velocity signal is different from at least one weighing coefficient selected from the group consisting of: a weighing coefficient for the fifth angular velocity signal; a weighing coefficient for the sixth angular velocity signal; a weighing coefficient for the fourth acceleration signal; a weighing coefficient for the fifth acceleration signal; a weighing coefficient for the sixth acceleration signal; a weighing coefficient for the fourth rotational angle; a weighing coefficient for the fifth rotational angle; and a weighing coefficient for the sixth rotational angle.

21. An inertial sensor disposed in a moving part, the inertial sensor comprising:
a first angular velocity detection element configured to detect angular velocity around a first detection axis to output a first angular velocity signal;
a second angular velocity detection element configured to detect angular velocity around a second detection axis to output a second angular velocity signal;
a third angular velocity detection element configured to detect angular velocity around a third detection axis to output a third angular velocity signal;
a first acceleration detection element configured to detect acceleration in a direction along the first detection axis to output a first acceleration signal;
a second acceleration detection element configured to detect acceleration in a direction along the second detection axis to output a second acceleration signal;
a third acceleration detection element configured to detect acceleration in a direction along the third detection axis to output a third acceleration signal; and
a control unit configured to calculate a first orientation signal based on the first angular velocity signal, the second angular velocity signal, the third angular velocity signal, the first acceleration signal, the second acceleration signal, and the third acceleration signal,
the first detection axis, the second detection axis, and the third detection axis being perpendicular to each other, and
the control unit being configured to:
acquire, from a second inertial sensor which is different from a first inertial sensor serving as the inertial sensor and which is arranged in a second moving part configured to be actuated with respect to a first moving part serving as the moving part, a fourth angular velocity signal representing angular velocity around a fourth detection axis; a fifth angular velocity signal representing angular velocity around a fifth detection axis perpendicular to the fourth detection axis; a sixth angular velocity signal representing angular velocity around a sixth detection axis perpendicular to the fourth detection axis and the fifth detection axis; a fourth acceleration signal representing acceleration in a direction along the fourth detection axis; a fifth acceleration signal representing acceleration in a direction along the fifth detection axis; a sixth acceleration signal representing acceleration in a direction along the sixth detection axis; and a second orientation signal representing an orientation of the second inertial sensor,
calculate, based on the first orientation signal and the second orientation signal, detection axis information indicating a relationship between the first detection axis, the second detection axis, and the third detection axis and the fourth detection axis, the fifth detection axis, and the sixth detection axis;
generate a reference signal in accordance with the detection axis information and based on at least one signal selected from the group consisting of the fourth angular velocity signal, the fifth angular velocity signal, the sixth angular velocity signal, the fourth acceleration signal, the fifth acceleration signal, and the sixth acceleration signal;
generate a corrected signal by correcting, using the reference signal, at least one signal selected from the group consisting of the first angular velocity signal, the second angular velocity signal, the third angular velocity signal, the first acceleration signal, the second acceleration signal, and the third acceleration signal; and
output the corrected signal.
